(19) United States
(12) Patent Application Publication
(10) Pub. No.: US 2008/0062357 A1
(43) Pub. Date: Mar. 13, 2008

(54) CYCLIC OLEFIN RESIN FILM, POLARIZING PLATE AND LIQUID CRYSTAL DISPLAY DEVICE

(75) Inventor: Masaya Suzuki, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/852,626

(22) Filed: Sep. 10, 2007

(30) Foreign Application Priority Data
Sep. 11, 2006 (JP) 2006-245958

(51) Int. Cl. C08K 5/51; C08K 5/16; C08K 5/55; G02B 5/30; G02F 1/1335

(52) U.S. Cl. 349/96; 359/500; 524/147; 524/154; 524/183; 524/186; 524/570

(57) ABSTRACT

A cyclic olefin resin film, includes: a cyclic olefin resin; and at least one organic compound capable of reducing Rth(λ) in an amount of 0.01 to 30 mass % based on a solid content of the cyclic olefin resin, wherein Rth(λ) is expressed in nm and represents a value of a retardation in a direction of film thickness at a wavelength of λ nm.

### BACKGROUND OF THE INVENTION

1. Field of the Invention

The present invention relates to a cyclic olefin resin film and additives for use in the cyclic olefin resin film, and further to a polarizing plate or a liquid crystal display device in which the cyclic olefin resin film is included.

2. Description of the Related Art

In general a polarizing plate is made by lamination of protective films constituted predominantly of cellulose triacetate on both sides of a polarizer prepared through orientational adsorption of iodine or a dichromatic dye to polyvinyl alcohol. Cellulose triacetate features high degrees of stiffness, flame-retarding capability and optical isotropy (low retardation), so it has been widely used as a material for the polarizing plate protective films.

A liquid crystal display device contains as its components a polarizing plate and a liquid crystal cell. In a TN-mode TFT liquid crystal display device currently ranking as the dominant liquid crystal display device, as disclosed in JP-A-8-50206, high display quality is contributed by an optically-compensatory sheet sandwiched between a polarizing plate and a liquid crystal cell.

However, cellulose acetate can absorb and permeate much moisture, so it has a problem of being apt to cause changes in optically compensating properties and degrade polarizer quality. In addition, the cellulose acetate film in a TN-mode liquid crystal display device suffers stress and generates heat during the passage of time after the power is turned on; as a result, wrinkles are formed around the perimeter of the panel and thereby light leaks are caused on all sides of the screen. When used in a VA-mode liquid crystal display device, cellulose acetate film causes a problem that its resilience different from that of a film laminated thereon causes warpage during the passage of time after the power is turned on, resulting in light leaks from the four corners of the screen.

On the other hand, cyclic olefin films can provide improvements in hygroscopicity and moisture permeability which are drawbacks of cellulose acetate film, so they have been receiving attention as films of the type which suffer slight changes in optical characteristics under variations in environmental conditions including temperature and humidity, and their formation by hot melting or from solutions has been developed for uses in polarizing plates and liquid crystal display devices. For instance, the optical films formed from polymers produced by ring-opening polymerization of specified cyclic olefins are disclosed in JP-A-2005-43740, and the optical films formed from addition polymers of cyclic olefins are disclosed in JP-A-2002-114827. Furthermore, developments of retardation films reduced in dependence of optical characteristics on temperature and humidity are disclosed in JP-A-2003-212927, JP-A-2004-126026 and Brochure on WO 2004/049011.

### SUMMARY OF THE INVENTION

For various functional films, such as polarizing plate protective films, retardation films and viewing-angle widening films used in liquid crystal display devices, or antireflective films used in plasma displays, there is strong demand on improvements in qualities including tint and contrast by individual sophisticated controls of optical characteristics of each intended film, specifically in-plane retardation (Re) and retardation in thickness direction (Rth).

Although it is known that retardation of a cyclic olefin resin film can be controlled by stretching the film and utilizing an increase in film's principal refractive index in the stretch direction, the control of retardation through the stretching is not a method by which Re and Rth can be controlled independently of each other.

An object of the invention is to provide a cyclic olefin resin film which excels in hygroscopicity and moisture permeability, causes slight changes in optical characteristics under variations in temperature and humidity and has independently controlled Re and Rth. Another object of the invention is to provide excellent polarizing plate and liquid crystal display devices each using such an outstanding cyclic olefin resin film.

As a result of our intensive studies, it has now been found that retardation of a cyclic olefin resin film can be controlled by incorporating at least one of the compounds represented by formulae (1) to (15) shown below into the cyclic olefin resin. By combining this finding with the retardation control through stretching, it becomes possible to obtain a cyclic olefin resin film whose Re and Rth are adjusted to desired values through mutually independent controls. Furthermore, control of addition amounts of the foregoing compounds can give high freedom to the stretch ratio and stretch formula selections in making a cyclic olefin resin film with desired Re and Rth. More specifically, stretch for forming a cyclic olefin resin film highly uniform in its in-plane direction has now been found to be compatible with controls of optical characteristics, thus achieving the invention. To our further surprise, it has also been found that those compounds can raise the elasticity modulus of a cyclic olefin resin film and thereby can have effect of reducing the so-called pucker/wrinkle occurrence during the film transport.

Aspects of the invention include novel cyclic olefin resin films having compositions as described below, and by these films the objects of the invention are attained.

(1) A cyclic olefin resin film, which comprises:

a cyclic olefin resin; and

at least one organic compound capable of reducing Rth(λ) in an amount of 0.01 to 30 mass % based on a solid content of the cyclic olefin resin,

wherein Rth(λ) is expressed in nm and represents a value of a retardation in a direction of film thickness at a wavelength of λ nm.

(2) A cyclic olefin resin film, which comprises:

a cyclic olefin resin; and

at least one organic compound capable of reducing both Rth(λ) and Re(λ) in an amount of 0.01 to 30 mass % based on a solid content of the cyclic olefin resin, wherein Rth(λ) is expressed in nm and represents a value of a retardation in a direction of film thickness at a wavelength of λ nm; and

### Re(λ) is expressed in nm and represents a value of an in-plane retardation at a wavelength of λ nm.

(3) The cyclic olefin resin film as described in (1) or (2) above, which comprises at least one compound represented by formula (1) as the organic compound capable of reducing Rth(λ) or the organic compound capable of reducing both Rth(λ) and Re(λ) in an amount of 0.01 to 30 mass % based on a solid content of the cyclic olefin resin:

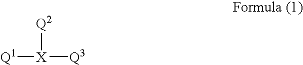

wherein Q¹, Q² and Q³ each independently represents a 5- or 6-membered ring; and

X represents B, C—R, N, P or P═O, in which R represents a hydrogen atom or a substituent.

(4) The cyclic olefin resin film as described in (3) above,

wherein the compound represented by formula (1) is a compound represented by formula (2):

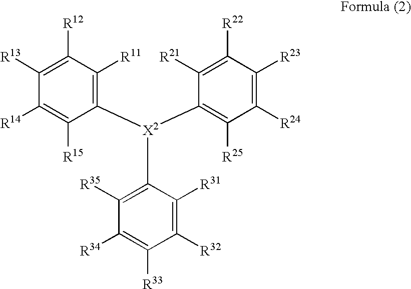

wherein X² represents B, C—R or N, in which R represents a hydrogen atom or a substituent; and

R¹¹, R¹², R¹³, R¹⁴, R¹⁵, R²¹, R²², R²³, R²⁴, R²⁵, R³¹, R³², R³³, R³⁴ and R³⁵ each independently represents a hydrogen atom or a substituent, and one group selected from the group consisting of R¹¹, R¹², R¹³, R¹⁴ and R¹⁵ and one group selected from the group consisting of R²¹, R²², R²³, R²⁴ and R²⁵ may be bound together via a single bond or a divalent linkage group.

(5) The cyclic olefin resin film as described in (1) or (2) above, which comprises at least one compound represented by formula (3) in an amount of 0.01 to 20 mass % based on a solid content of the cyclic olefin resin:

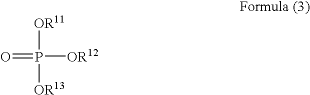

wherein R¹¹, R¹² and R¹³ each independently represents a 1-20C aliphatic group or a 5- or 6-membered hydrocarbon or heterocyclic ring, in which the ring may be a monocyclic ring or form a fused ring together with another ring.

(6) The cyclic olefin resin film as described in (1) or (2) above, which comprises at least one compound represented by formula (4) in an amount of 0.01 to 20 mass % based on a solid content of the cyclic olefin resin:

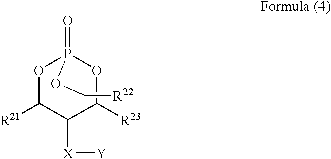

wherein R²¹, R²² and R²³ each independently represents a hydrogen atom or an alkyl group;

X represents a divalent linkage group formed of one or more groups selected from the group consisting of a single bond, —O—, —CO—, —NR²⁴—, an alkylene group and an arylene group, in which R²⁴ represents a hydrogen atom, an alkyl group, an aryl group or an aralkyl groups; and

Y represents a hydrogen atom, an alkyl group, an aryl group or an aralkyl group.

(7) The cyclic olefin resin film as described in (1) or (2) above, which comprises at least one compound represented by any of formulae (5) to (15) in an amount of 0.01 to 20 mass % based on a solid content of the cyclic olefin resin:

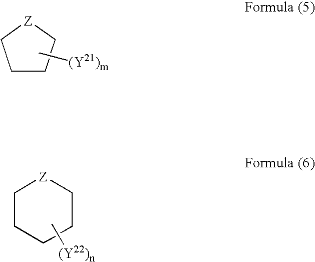

wherein Z represents a carbon atom, an oxygen atom, a sulfur atom or —NR²⁵—, in which R²⁵ represents a hydrogen atom or an alkyl group;

Y²¹ and Y²² each independently represents a 1-20C ester, alkoxycarbonyl, amido or carbamoyl group;

m represents an integer of 1 to 5; and

n represents an integer of 1 to 6:

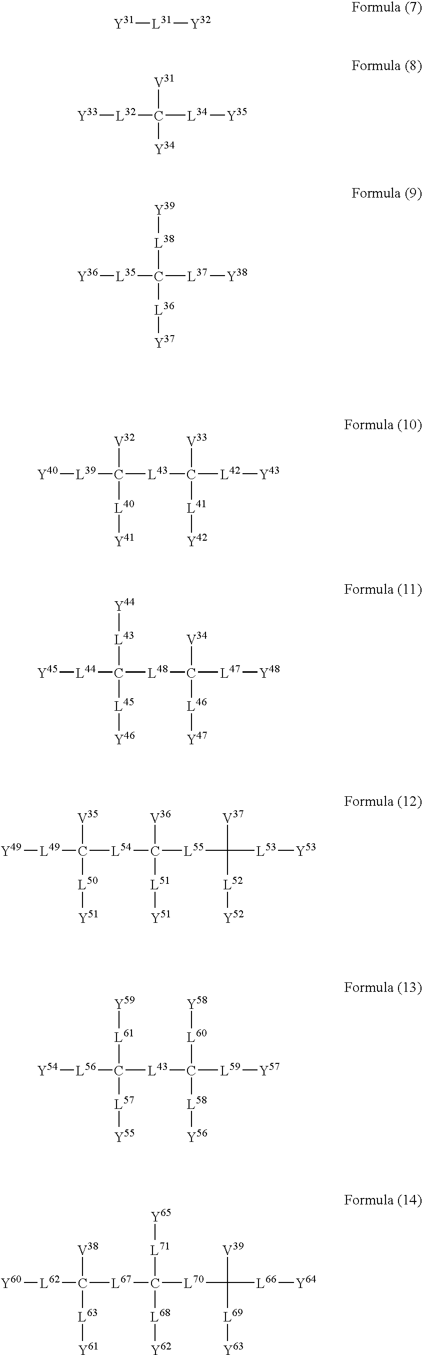

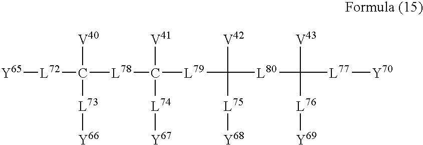

wherein Y³¹ to Y⁷⁰ each independently represents a 1-20C ester group, a 1-20C alkoxycarbonyl group, a 1-20C amido group, a 1-20C carbamoyl group or a hydroxyl group;

V³¹ to V⁴³ each independently represents a hydrogen atom or a 1-20C aliphatic group; and

L³¹ to L⁸⁰ each independently represents a divalent saturated linkage group containing 0 to 40 atoms, inclusive of 0 to 20 carbon atoms, in which when the number of atoms contained in a linkage group represented by any of L³¹ to L⁸⁰ is 0, groups on both sides of the linkage group forms a single bond by binding directly.

(8) The cyclic olefin resin film as described in any of (1) to (4) above,

wherein the cyclic olefin resin comprises at least one cyclic olefin resin selected from the group consisting of [A-1], [A-2] and [A-3],

wherein [A-1] stands for an addition copolymer comprising at least one kind of a repeating unit represented by formula (16) and at least one kind of a repeating unit represented by formula (17),

[A-2] stands for an addition homo- or copolymer comprising at least one kind of a repeating unit represented by formula (17), and

[A-3] stands for an open-circular homo- or copolymer comprising at least one kind of a repeating unit represented by formula (18):

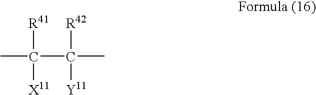

wherein R⁴¹ and R⁴² each independently represents a hydrogen atom or a 1-10C hydrocarbon group; and

X¹¹ and Y¹¹ each independently represents a hydrogen atom, a 1-10C hydrocarbon group, a halogen atom, a 1-10C halogenated hydrocarbon group, —(CH₂)ₙCOOR⁵¹, —(CH₂)ₙOCOR⁵², —(CH₂)ₙNCO, —(CH₂)ₙNO₂, —(CH₂)ₙCN, —(CH2)ₙCONR⁵³R⁵⁴, —(CH₂)ₙNR⁵³R⁵⁴, —CH₂)ₙOZ or —(CH₂)ₙW, or a combination of X¹¹ and Y¹¹ represents (—CO)₂O or (—CO)₂NR⁵⁵, in which R⁵¹, R⁵², R⁵³, R⁵⁴ and R⁵⁵ each independently represents a hydrogen atom or a 1-20C hydrocarbon group; Z represents a hydrocarbon group or a halogenated hydrocarbon group; W represents —SiR⁵⁶ₚD₃₋ₚ, in which R⁵⁶ represents a 1-10C hydrocarbon group, D represents a halogen atom, —OCOR⁵⁶ or —OR⁵⁶, and p represents an integer of 0 to 3; and n represents an integer of 0 to 10:

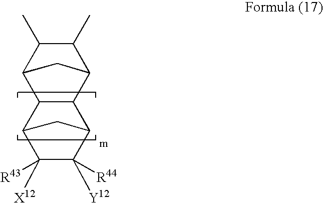

wherein m represents an integer of 0 to 4;

R⁴³ and R⁴⁴ each independently represents a hydrogen atom or a 1-10C hydrocarbon group;

X¹² and Y¹² each independently represents a hydrogen atom, a 1-10C hydrocarbon group, a halogen atom, a 1-10C halogenated hydrocarbon group, —(CH₂)ₙCOOR⁵¹, —(CH₂)ₙOCOR⁵², —(CH₂)ₙNCO, —(CH₂)ₙNO₂, —(CH₂)ₙCN, —(CH2)ₙCONR⁵³R⁵⁴, —(CH₂)ₙNR⁵³R⁵⁴, —(CH₂)ₙOZ or —(CH₂)ₙW, or a combination of X¹² and Y¹² represents (—CO)₂O or (—CO)₂NR⁵⁵, in which R⁵¹, R⁵², R⁵³, R⁵⁴ and R⁵⁵ each independently represents a hydrogen atom or a 1-20C hydrocarbon group; Z represents a hydrocarbon group or a halogenated hydrocarbon group; W represents —SiR⁵⁶ₚD₃₋ₚ, in which R⁵⁶ represents a 1-10C hydrocarbon group, D represents a halogen atom, —OCOR⁵⁶ or —OR⁵⁶, and p represents an integer of 0 to 3; and n represents an integer of 0 to 10; and

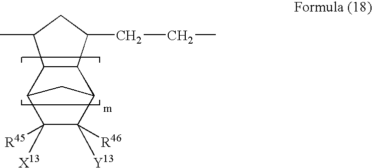

wherein m represents an integer of 0 to 4;

R⁴⁵ and R⁴⁶ each independently represents a hydrogen atom or a 1-10C hydrocarbon group;

X¹³ and Y¹³ each independently represents a hydrogen atom, a 1-10C hydrocarbon group, a halogen atom, a 1-10C halogenated hydrocarbon group, —(CH₂)ₙCOOR⁵¹, —(CH₂)ₙOCOR⁵², —(CH₂)ₙNCO, —(CH₂)ₙNO₂, —(CH₂)ₙCN, —(CN2)ₙCONR⁵³R⁵⁴, —(CH₂)_{NR}⁵³R⁵⁴, —(CH₂)ₙOZ or —(CH₂)ₙW, or a combination of X¹³ and Y¹³ represents (—CO)₂O or (—CO)₂NR⁵⁵, in which R⁵¹, R⁵², R⁵³, R⁵⁴ and R⁵⁵ each independently represents a hydrogen atom or a 1-20C hydrocarbon group; Z represents a hydrocarbon group or a halogenated hydrocarbon group; W represents —SiR⁵⁶ₚD₃₋ₚ, in which R⁵⁶ represents a 1-10C hydrocarbon group, D represents a halogen atom, —OCOR⁵⁶ or —OR⁵⁶, and p represents an integer of 0 to 3; and n represents an integer of 0 to 10.

(9) The cyclic olefin resin film as described in any of (1) to (8) above, which has in-plane slow axes whose directions average within ±2.0 degrees with respect to a width direction of the film and have a standard deviation within 0.8.

(10) A polarizing plate, which comprises:

a polarizer; and

two protective films disposed on both sides of the polarizer,

wherein at least one of the two protective films is the cyclic olefin resin film as described in any of (1) to (9) above.

(11) A liquid crystal display device, which comprises at least one of the cyclic olefin resin film as described in any of (1) to (9) above and the polarizing plate as described in (10) above.

(12) A liquid crystal display device, which comprises:

a liquid crystal cell; and

a pair of polarizing plates disposed on both sides of the liquid crystal cell,

wherein the pair of polarizing plates comprises the polarizing plate as described in (10) above, and the liquid crystal display device is of IPS-mode, OCB-mode, TN-mode or VA-mode.

(13) A VA-mode liquid crystal display device, which comprises the polarizing plate as described in (10) above on a side of backlight.

### DETAILED DESCRIPTION OF THE INVENTION

Detailed description of the invention is given below.

### (Compounds for Controlling Optical Characteristics)

In the first place, compounds that can produce effects the invention aims for and can control the optical characteristics featuring in the invention are described. Although any compounds can be used in the invention as far as they can control either or both of optical characteristics relating to Re and Rth, compounds represented by formula (1) in particular are preferred because they can noticeably contribute to achievement of the effect of the invention. Therefore, detailed description of compounds represented by formula (1) is given to begin with.

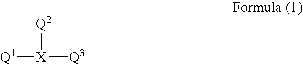

In the above formula, Q¹, Q² and Q³ each independently represents a 5- or 6-membered ring, wherein the ring may be a hydrocarbon ring or a heterocyclic ring and further may be a monocyclic ring or a fused ring formed together with another ring. X represents B, C—R (wherein R represents a hydrogen atom or a substituent), N, P or P═O.

The hydrocarbon ring is preferably a substituted or unsubstituted cyclohexane ring, a substituted or unsubstituted cyclopentane ring, or an aromatic hydrocarbon ring, far preferably an aromatic hydrocarbon ring.

The heterocyclic ring is preferably a 5- or 6-membered ring containing at least one hetero atom chosen from an oxygen atom, a nitrogen atom or a sulfur atom, far preferably an aromatic heterocyclic ring containing at least one hetero atom chosen from an oxygen atom, a nitrogen atom or a sulfur atom.

Each of Q¹, Q² and Q³ is preferably an aromatic hydrocarbon ring or an aromatic heterocyclic ring.

The aromatic hydrocarbon ring is preferably a 6-30C monocyclic or bicyclic aromatic hydrocarbon ring (with examples including a benzene ring and a naphthalene ring), far preferably a 6-20C aromatic hydrocarbon ring, further preferably a 6-12C aromatic hydrocarbon ring, especially preferably a benzene ring.

The aromatic heterocyclic ring is preferably an aromatic heterocyclic ring containing an oxygen atom, a nitrogen atom or a sulfur atom. Examples of such a heterocyclic ring include furan, pyrrole, thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole and tetraazaindene rings. Of these aromatic heterocyclic rings, a pyridine ring, a triazine ring and a quinoline ring are preferred over the others.

Each of Q¹, Q² and Q³ is preferably an aromatic hydrocarbon ring, especially preferably a benzene ring.

Each of Q¹, Q² and Q³ may have a substituent, and examples of such a substituent include Substituents T recited hereinafter.

X represents B, C—R (wherein R represents a hydrogen atom or a substituent), N, P or P═O, preferably B, C—R (wherein R is preferably an aryl group, a substituted or unsubstituted amino group, an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a hydroxyl group, a mercapto group, a halogen atom (e.g., a fluorine, chlorine, bromine or iodine atom) or a carboxyl group, far preferably an aryl group, an alkoxy group, an aryloxy group, a hydroxyl group or a halogen atom, further preferably an alkoxy group or a hydroxyl group, especially preferably a hydroxyl group) or N, far preferably C—R or N, especially preferably C—R.

Of the compounds represented by formula (1), compounds represented by the following formula (2) are preferred over the others.

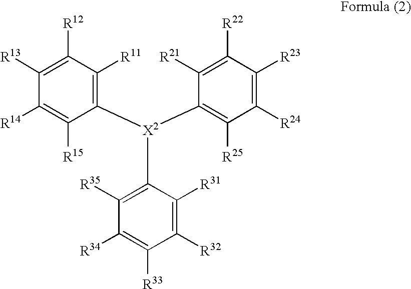

In the above formula, X² represents B, C—R (wherein R represents a hydrogen atom or a substituent), N, P or P═O. R¹¹, R¹², R¹³, R¹⁴, R¹⁵, R²¹, R²², R²³, R²⁴, R²⁵, R³¹, R³², R³³, R34 and R³⁵ each represent a hydrogen atom or a substituent independently. One group chosen from R¹¹, R¹², R¹³, R¹⁴ or R¹⁵ and one group chosen from R²¹, R²², R²³, R²⁴ or R²⁵ may combine via a single bond or a divalent linkage group (e.g., a 1-10C alkylene group) to form a ring structure.

X² is preferably B, C—R (wherein R is preferably an aryl group, a substituted or unsubstituted amino group, an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a hydroxyl group, a mercapto group, a halogen atom (e.g., a fluorine atom, a chlorine atom, a bromine atom, an iodine atom) or a carboxyl group, far preferably an aryl group, an alkoxy group, an aryloxy group, a hydroxyl group or a halogen atom, further preferably an alkoxy group or a hydroxyl group, especially preferably a hydroxyl group), N or P═O, far preferably C—R or N, especially preferably C—R.

R¹¹, R¹², R¹³, R¹⁴, R¹⁵, R²¹, R²², R²³, R²⁴, R²⁵, R³¹, R³², R³³, R³⁴ and R³⁵ each independently represents a hydrogen atom or a substituent, and suitable examples of the substituent include Substituents T recited hereinafter. R¹¹, R¹², R¹³, R¹⁴, R¹⁵, R²¹, R²², R²³, R²⁴, R²⁵, R³¹, R³², R³³, R³⁴ and R³⁵ are independent of one another, and each of them is preferably an alkyl group, an alkenyl group, an alkynyl group, an aryl group, a substituted or unsubstituted amino group, an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a sulfonyl group, a sulfinyl group, an ureido group, a phosphamido group, a hydroxyl group, a mercapto group, a halogen atom (e.g., a fluorine atom, a chlorine atom, a bromine atom, an iodine atom), a cyano group, a sulfo group, a carboxyl group, a nitro group, a hydroxamic acid group, a sulfino group, a hydrazino group, an imino group, a heterocyclyl group (preferably containing 1 to 30 carbon atoms, far preferably containing 1 to 12 carbon atoms, and a nitrogen an oxygen atom or a sulfur atom as a hetero atom, with examples including imidazolyl, pyridyl, quinolyl, furyl, piperidyl, morpholino, benzoxazolyl, benzimidazolyl and benzothiazolyl) or a silyl group, far preferably an alkyl group, an aryl group, a substituted or unsubstituted amino group, an alkoxy group or an aryloxy group, further preferably an alkyl group, an aryl group or an alkoxy group. These substituents may further be substituted. When two or more substituents are present, they may be the same or different. Where possible, the substituents may combine with each other to form a ring. Examples of substituents in such a case include Substituents T recited below.

Explanations of Substituents T are given below. Examples of Substituents T include alkyl groups (preferably 1-20C, far preferably 1-12C, especially preferably 1-8C, alkyl groups, such as methyl, ethyl, isopropyl, tert-butyl, n-octyl, n-decyl, n-hexadecyl, cyclopropyl, cyclopentyl and cyclohexyl groups), alkenyl groups (preferably 2-20C, far preferably 2-12C, especially preferably 2-8C alkenyl groups, such as vinyl, allyl, 2-butenyl and 3-pentenyl groups), alkynyl groups (preferably 2-20C, far preferably 2-12C, especially preferably 2-8C, alkynyl groups, such as propargyl and 3-pentynyl groups), aryl groups (preferably 6-30C, far preferably 6-20C, especially preferably 6-12C, aryl groups, such as phenyl, p-methylphenyl and naphthyl groups), substituted or unsubstituted amino groups (preferably 0-20C, far preferably 0-10C, especially preferably 0-6C, amino groups, such as amino, methylamino, dimethylamino, diethylamino and dibenzylamino groups), alkoxy groups (preferably 1-20C, far preferably 1-12C, especially preferably 1-8C, alkoxy groups, such as methoxy, ethoxy and butoxy groups), aryloxy groups (preferably 6-20C, far preferably 6-16C, especially preferably 6-12C, aryloxy groups, such as phenyloxy and 2-naphthyloxy groups), acyl groups (preferably 1-20C, far preferably 1-16C, especially preferably 1-12C, acyl groups, such as acetyl, benzoyl, formyl and pivaloyl groups), alkoxycarbonyl groups (preferably 2-20C, far preferably 2-16C, especially preferably 2-12C, alkoxycarbonyl groups, such as methoxycarbonyl and ethoxycarbonyl groups), aryloxycarbonyl groups (preferably 7-20C, far preferably 7-16C, especially preferably 7-10, aryloxycarbonyl groups, such as a phenyloxycarbonyl group), acyloxy groups (preferably 2-20C, far preferably 2-16C, especially preferably 2-10C, acyloxy groups, such as acetoxy and benzoyloxy groups), acylamino groups (preferably 2-20C, far preferably 2-16C, especially preferably 2-10C, acylamino groups, such as acetylamino and benzoylamino groups), alkoxycarbonylamnino groups (preferably 2-20C, far preferably 2-16C, especially preferably 2-12C, alkoxycarbonylamino groups, such as a methoxycarbonylamino group), aryloxycarbonylamino groups (preferably 7-20C, far preferably 7-16C, especially preferably 7-12C, aryloxycarbonylamino groups, such as a phenyloxycarbonylamino group), sulfonylamino groups (preferably 1-20C, far preferably 1-16C, especially preferably 1-12C, sulfonylamino groups, such as methanesulfonylamino and benzenesulfonylamino groups), sulfamoyl groups (preferably 0-20C, far preferably 0-16C, especially preferably 0-12C, sulfamoyl groups, such as sulfamoyl, methylsulfamoyl, dimethylsulfamoyl and phenylsulfamoyl groups), carbamoyl groups (preferably 1-20C, far preferably 1-16C, especially preferably 1-12C, carbamoyl groups, such as carbamoyl, methylcarbamoyl, diethylcarbamoyl and phenylcarbamoyl groups), alkylthio groups (preferably 1-20C, far preferably 1-16C, especially preferably 1-12C, alkylthio groups, such as methylthio and ethylthio groups), arylthio groups (preferably 6-20C, far preferably 6-16C, especially preferably 6-12C, arylthio groups, such as a phenylthio group), sulfonyl groups (preferably 1-20C, far preferably 1-16C, especially preferably 1-12C, sulfonyl groups, such as mesyl and tosyl groups), sulfinyl groups (preferably 1-20C, far preferably 1-16C, especially preferably 1-12C, sulfinyl groups, such as methanesulfinyl and benzenesulfinyl groups), ureido groups (preferably 1-20C, far preferably 1-16C, especially preferably 1-12C, ureido groups, such as ureido, methylureido and phenylureido groups), phosphamido groups (preferably 1-20C, far preferably 1-16C, especially preferably 1-12C, phosphamido groups, such as diethylphosphamido and phenylphosphamido groups), a hydroxyl group, a mercapto group, halogen atoms (such as fluorine, chlorine, bromine and iodine atoms), a cyano group, a sulfo group, a carboxyl group, a nitro group, a hydroxamic acid group, a sulfino group, a hydrazino group, an imino group, heterocyclyl groups (each containing preferably 1-30, far preferably 1-12, carbon atoms and at least one hetero atom chosen from a nitrogen atom, an oxygen atom or a sulfur atom, such as imidazolyl, pyridyl, quinolyl, furyl, piperidyl, morpholino, benzoxazolyl, benzimidazolyl and benzothiazolyl groups), and silyl groups (preferably 3-40C, far preferably 3-30C, especially preferably 3-24C, silyl groups, such as trimethylsilyl and triphenylsilyl groups). These groups each may further be substituted. When two or more substituents are attached to those groups each, they may be the same or different. Where possible, they may link together to form a ring.

A compound having two X²s per molecule, which is formed by one group selected from the class consisting of R¹¹, R¹², R¹³, R¹⁴, R¹⁵, R²¹, R²², R²³, R²⁴, R²⁵, R³¹, R³², R³³, R³⁴ and R³⁵ in a compound represented by formula (2) and one group selected from the class consisting of R¹¹, R¹², R¹³, R¹⁴, R¹⁵, R²¹, R²², R²³, R²⁴, R²⁵, R³¹, R³², R³³, R³⁴ and R³⁵ in another compound represented by formula (2) being bound together by a single bond or a divalent linkage group (e.g., a 1-10C alkylene group), can be also be used in the invention.

In addition, a structure shown by the following formula (19) may be chosen for a substituent that each of R¹¹, R¹², R¹³, R¹⁴, R¹⁵, R²¹, R²², R²³, R²⁴, R²⁵, R³¹, R³², R³³, R³⁴ and R³⁵ in formula (2) can have.

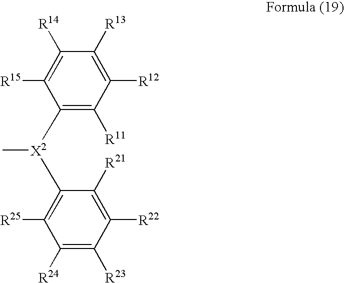

In the above formula, X² represents B, C—R (wherein R represents a hydrogen atom or a substituent), or N. R¹¹, R¹², R¹³, R¹⁴, R¹⁵, R^{21 , R}²², R²³, R²⁴, R²⁵ each independently represents a hydrogen atom or a substituent.

When R¹¹, R¹², R¹³, R¹⁴, R¹⁵, R²¹, R²², R²³, R²⁴ and R²⁵ represent substituents, the substituents have the same meanings as those represented by R¹¹, R¹², R¹³, R¹⁴, R¹⁵, R²¹, R²², R²³, R²⁴ and R²⁵ in formula (2).

Compounds represented by formula (1) or (2) in the invention may be used alone, or two or more of them may be used together in arbitrary proportions. In both the case of single use and the case of combined use, compounds represented by formula (1) or (2) in the invention are added in a total amount of preferably from 0.01 to 30 mass %, far preferably from 0. 1 to 25 mass %, further preferably from 0.5 to 22 mass %, especially preferably from 1.0 to 20 mass %, based on the cyclic olefin resin used in combination therewith. (In this specification, mass ratio is equal to weight ratio.) The compounds represented by formula (1) are illustrated in detail with examples shown below, but the invention should not be construed as being limited to these examples in any way.

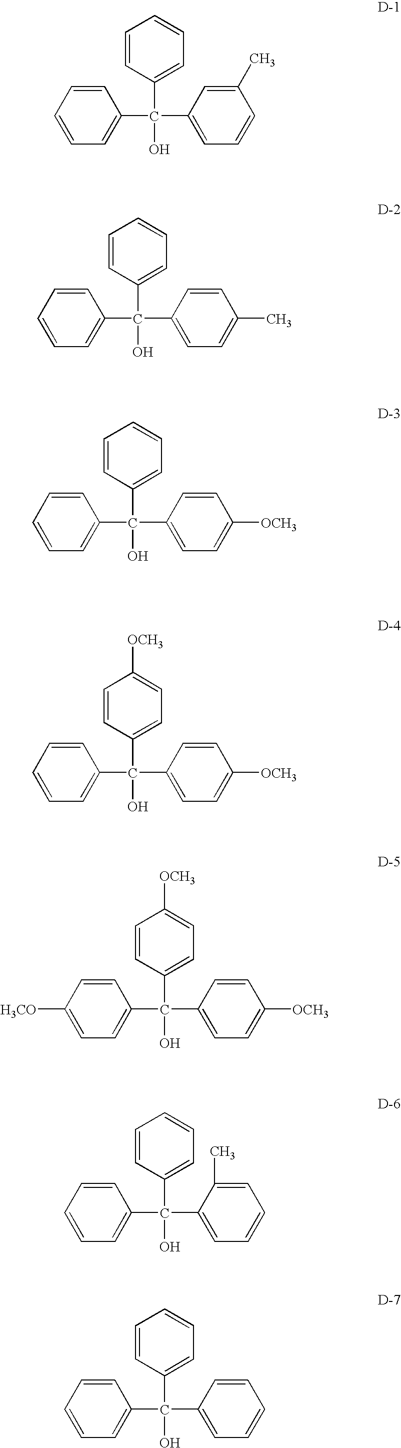

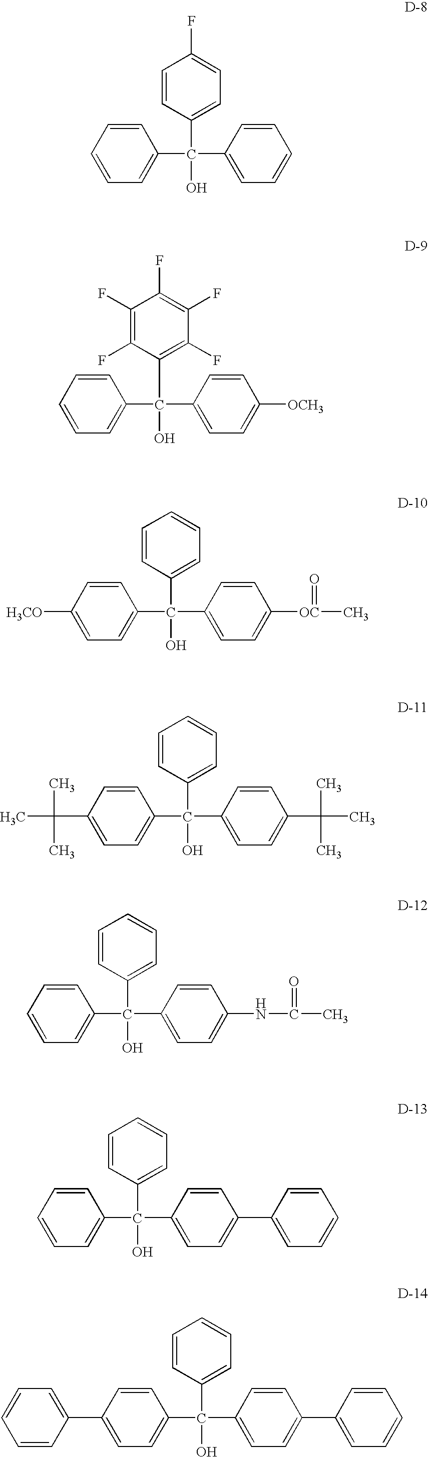

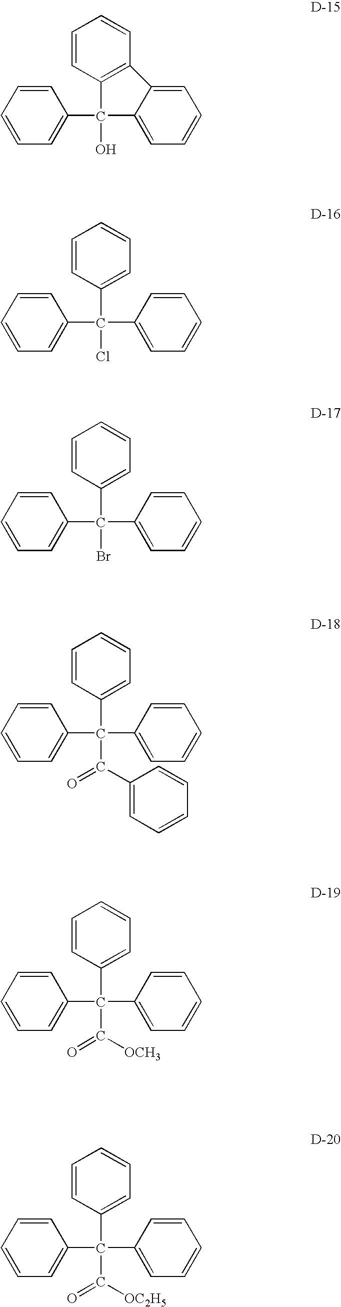

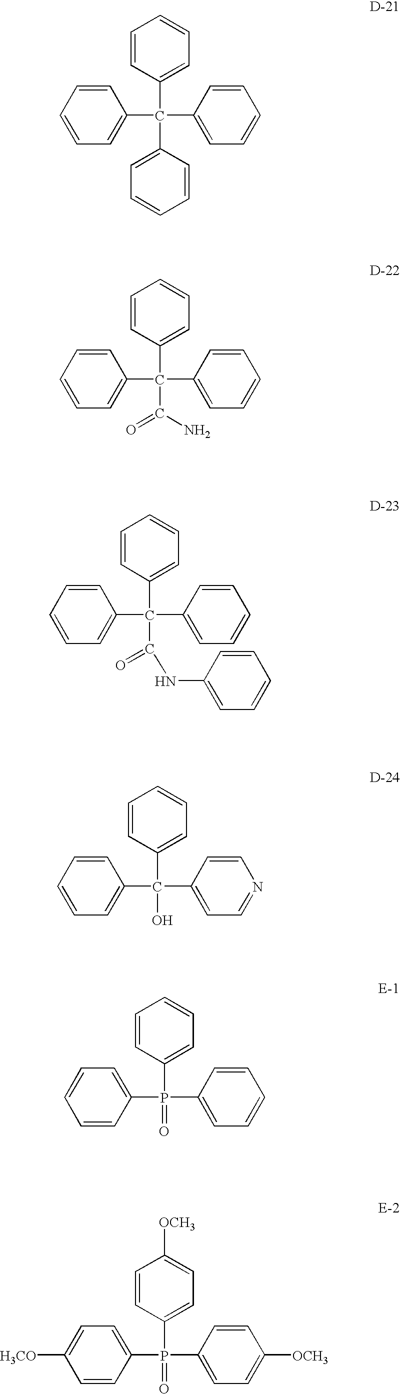

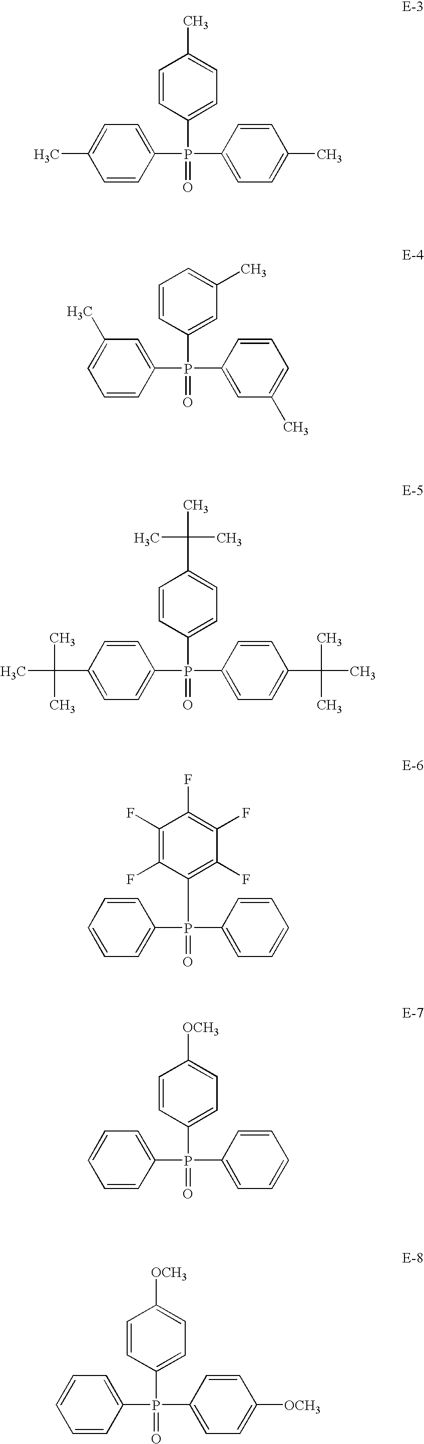

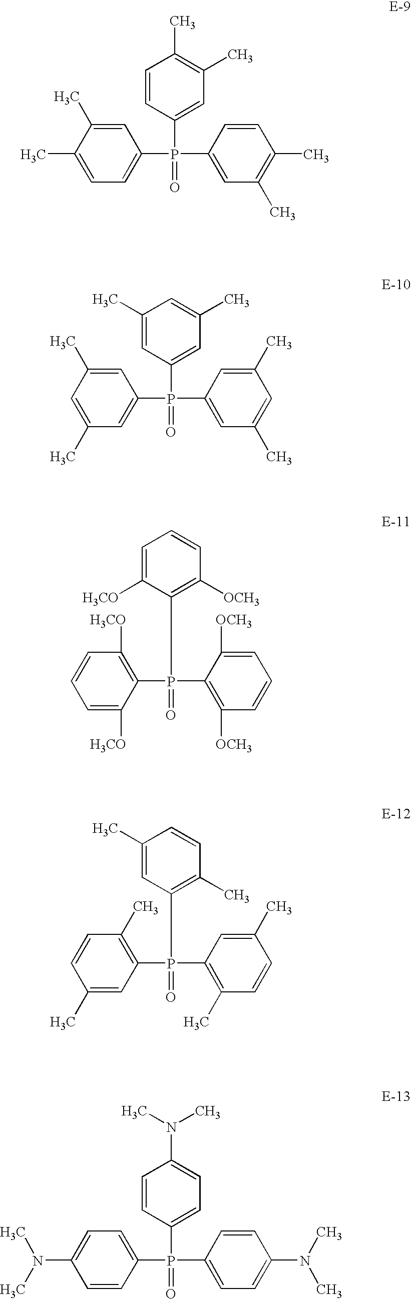

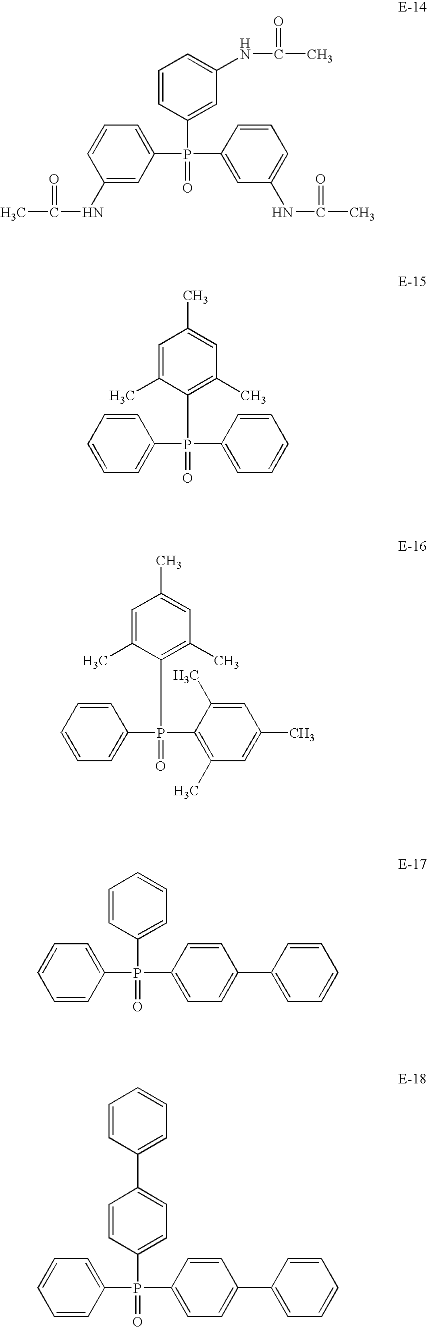

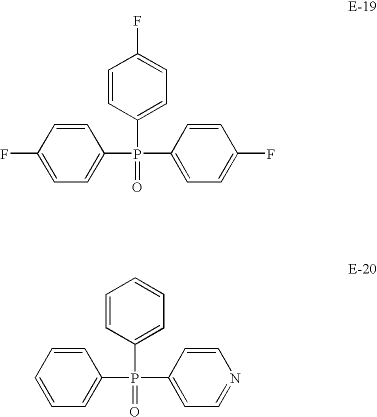

In the next place, compounds represented by formula (3) in the invention are described in detail.

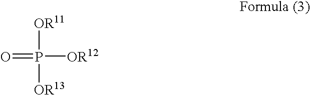

In formula (3), R¹¹, R¹² and R¹³ each independently represents a 1-20C aliphatic group or a 5- to 6-membered ring. The ring may be a hydrocarbon ring or a heterocyclic ring, and besides, it may be monocyclic, or together with another ring it may form a fused ring.

Detailed explanations of R¹¹, R¹² and R¹³ are given below. When R¹¹, R¹² and R¹³ are aliphatic groups, they are preferably 1-20C, far preferably 1-16C, especially preferably 1-12C, aliphatic groups. These aliphatic groups are preferably aliphatic hydrocarbon groups, far preferably alkyl groups (including linear, branched and cyclic alkyl groups), alkenyl groups or alkynyl groups. Examples of such alkyl groups include methyl, ethyl, n-propyl, isopropyl, n-butyl, isobutyl, sec-butyl, t-butyl, n-pentyl, t-amyl, n-hexyl, n-octyl, decyl, dodecyl, eicosyl, 2-ethylhexyl, cyclopentyl, cyclohexyl, cycloheptyl, 2,6-dimethylcyclohexyl, 4-t-butylcyclohexyl, 1-adamantyl, 2-adamantyl and bicyclo[2.2.2]octane-3-yl, examples of those alkenyl groups include vinyl, allyl, pulenyl, geranyl, oleyl, 2-cyclopentene-1-yl and 2-cyclohexene-1-yl, and examples of those alkynyl groups include ethynyl and propargyl.

The aliphatic groups represented by R¹¹, R¹² and R¹³ may have substituents, and examples of such substituents include halogen atoms (e.g., fluorine, chlorine, bromine, iodine), alkyl groups (having linear, branched and cyclic structures, inclusive of bicycloalkyl groups and an active methine group), alkenyl groups, alkynyl groups, aryl groups, heterocyclic groups (irrespective of substitution site), acyl groups, alkoxycarbonyl groups, aryloxycarbonyl groups, heterocyclyloxycarbonyl groups, carbamoyl groups, N-acylcarbamoyl groups, N-sulfonylcarbamoyl groups, N-carbamoylcarbamoyl groups, N-sulfamoylcarbamoyl groups, carbazoyl groups, a carboxyl group and salts thereof, oxalyl groups, oxamoyl groups, a cyano group, a carbonimidoyl group, a formyl group, a hydroxyl group, alkoxy groups (including groups containing ethyleneoxy group units or propyleneoxy group units), aryloxy groups, heterocyclyloxy groups, acyloxy groups, (alkoxy or aryloxy)carbonyloxy groups, a sulfonyloxy group, an amino group, (alkyl, aryl or heterocyclyl)amino groups, acylamino groups, sulfonamido groups, an ureido group, a thioureido group, an imido group, (alkoxy or aryloxy)carbonylamino groups, a sulfamoylamino group, a semicarbazido group, an ammonio group, an oxamoylamino group, N-(alkyl or aryl)sulfonylurido groups, N-acylureido groups, N-acylsulfamoylamino groups, heterocyclic groups containing quaternary nitrogen atoms (e.g., a pyridinio group, an imidazolio group, a quinolinio group, isoquinolinio group), an isocyano group, an imino group, (alkyl or aryl)sulfonyl groups, (alkyl or aryl)sulfinyl groups, a sulfo group and salts thereof, a sulfamoyl group, N-acylsulfamoyl groups, an N-sulfonylsulfamloyl group and salts thereof, a phosphino group, a phosphinyl group, a phosphinyloxy group, a phosphinylamino group and a silyl group.

Any two or more of these groups may further be bound together to from a compound substituent, and examples of such a compound substituent include an ethoxyethoxyethyl group, a hydroxyethoxyethyl group and an ethoxycarbonylethyl group. In addition, R¹¹, R¹² and R¹³ may have phosphoric ester groups as their respective substituents, so the compounds of formula (3) can contain more than one phosphoric ester group per molecule.

When R¹¹, R¹² and R¹³ are 5- or 6-membered rings, the rings are preferably aromatic hydrocarbon rings or aromatic heterocyclic rings.

The aromatic hydrocarbon rings are preferably 6-30C monocyclic or bicyclic aromatic hydrocarbon rings (such as benzene and naphthalene rings), far preferably 6-20C aromatic hydrocarbon rings, further preferably 6-12C aromatic hydrocarbon rings, especially preferably benzene rings.

The aromatic heterocyclic rings are preferably oxygen-, nitrogen- or sulfur-containing aromatic heterocyclic rings. Examples of such aromatic heterocyclic rings include various rings, such as furan, pyrrole, thiophene, imidazole, pyrazole, pyridine, pyridazine, triazole, triazine, indole, indazole, purine, thiazoline, thiazole, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole and tetraazaindene. Of these rings, pyridine, triazine and quinoline rings are preferred over the others.

R¹¹, R¹² and R¹³ are far preferably aromatic hydrocarbon rings, especially preferably benzene rings.

The compounds represented by formula (3) are illustrated in detail with examples shown below, but the invention should not be construed as being limited to these examples in any way.

| compound | R¹¹ | R¹² | R¹³ |
|---|---|---|---|
| C-1 | CH₃ | C₂H₅ | C₂H₅ |
| C-2 | C₂H₅ | C₂H₅ | C₂H₅ |
| C-3 | C₃H₇ | C₃H₇ | C₃H₇ |
| C-4 | i-C₃H₇ | i-C₃H₇ | i-C₃H₇ |
| C-5 | C₄H₉ | C₄H₉ | C₄H₉ |
| C-6 | i-C₄H₉ | i-C₄H₉ | i-C₄H₉ |
| C-7 | s-C₄H₉ | s-C₄H₉ | s-C₄H₉ |
| C-8 | t-C₄H₉ | t-C₄H₉ | t-C₄H₉ |
| C-9 | C₅H₁₁ | C₅H₁₁ | C₅H₁₁ |
| C-10 | CH₂C(CH₃)₃ | CH₂C(CH₃)₃ | CH₂C(CH₃)₃ |
| C-11 | c-C₅H₉ | c-C₅H₉ | c-C₅H₉ |
| C-12 | 1-etyhlpropyl | 1-etyhlpropyl | 1-etyhlpropyl |
| C-13 | C₆H₁₃ | C₆H₁₃ | C₆H₁₃ |
| C-14 | c-C₆H₁₁ | c-C₆H₁₁ | c-C₆H₁₁ |
| C-15 | C₇H₁₅ | C₇H₁₅ | C₇H₁₅ |
| C-16 | 4-metyhlcyclohexyl | 4-metyhlcyclohexyl | 4-metyhlcyclohexyl |
| C-17 | 4-t-butylcyclohexyl | 4-t-butylcyclohexyl | 4-t-butylcyclohexyl |
| C-18 | C₈H₁₇ | C₈H₁₇ | C₈H₁₇ |
| C-19 | 2-ethylhexyl | 2-ethylhexyl | 2-ethylhexyl |
| C-20 | 3-methylbutyl | 3-methylbutyl | 3-methylbutyl |
| C-21 | 1,3-dimethylbutyl | 1,3-dimethylbutyl | 1,3-dimethylbutyl |
| C-22 | 1-isopropyl-2-methylpropyl | 1-isopropyl-2-methylpropyl | 1-isopropyl-2-methylpropyl |
| C-23 | 2-ethylbutyl | 2-ethylbutyl | 2-ethylbutyl |
| C-24 | 3,5,5-trimethylhexyl | 3,5,5-trimethylhexyl | 3,5,5-trimethylhexyl |
| C-25 | cyclohexylmethyl | cyclohexylmethyl | cyclohexylmethyl |
| C-26 | CH₃ | CH₃ | 2-ethylhexyl |
| C-27 | CH₃ | CH₃ | 1-adamantyl |
| C-28 | CH₃ | CH₃ | C₁₂H₂₅ |
| C-29 | C₂H₅ | C₂H₅ | 2-ethylhexyl |
| C-30 | C₂H₅ | C₂H₅ | 1-adamantyl |
| C-31 | C₂H₅ | C₂H₅ | C₁₂H₂₅ |
| C-32 | C₄H₉ | C₄H₉ | cyclohexyl |
| C-33 | C₄H₉ | C₄H₉ | C₆H₁₃ |
| C-34 | C₄H₉ | C₄H₉ | C₈H₁₇ |
| C-35 | C₄H₉ | C₄H₉ | 2-ethylhexyl |
| C-36 | C₄H₉ | C₄H₉ | C₁₀H₂₁ |
| C-37 | C₄H₉ | C₄H₉ | C₁₂H₂₅ |
| C-38 | C₄H₉ | C₄H₉ | 1-adamantyl |
| C-39 | C₄H₉ | C₄H₉ | C₁₆H₃₃ |
| C-40 | C₄H₉ | C₄H₉ | dicyclopentadietnyl |
| C-41 | C₆H₁₃ | C₆H₁₃ | C₁₄H₂₉ |
| C-42 | C₆H₁₃ | C₆H₁₃ | C₈H₁₇ |
| C-43 | C₆H₁₃ | C₆H₁₃ | 2-ethylhexyl |
| C-44 | C₆H₁₃ | C₆H₁₃ | C₁₀H₂₁ |
| C-45 | C₆H₁₃ | C₆H₁₃ | C₁₂H₂₅ |
| C-46 | C₆H₁₃ | C₆H₁₃ | 1-adamantyl |
| C-47 | 4-chlorobutyl | 4-chlorobutyl | 4-chlorobutyl |
| C-48 | 4-chlorohexyl | 4-chlorohexyl | 4-chlorohexyl |
| C-49 | 4-bromobutyl | 4-bromobutyl | 4-bromobutyl |
| C-50 | 4-bromohexyl | 4-bromohexyl | 4-bromohexyl |
| C-51 | (CH₂)₂OCH₂CH₃ | (CH₂)₂OCH₂CH₃ | (CH₂)₂OCH₂CH₃ |
| C-52 | C₈H₁₇ | C₈H₁₇ | (CH₂)₂O(CH₂)₂OCH₂CH₃ |
| C-53 | C₆H₁₃ | C₆H₁₃ | (CH₂)₂O(CH₂)₂OCH₂CH₃ |
| C-54 | C₄H₉ | C₄H₉ | (CH₂)₂O(CH₂)₂OCH₂CH₃ |
| C-55 | C₄H₉ | C₄H₉ | (CH₂)₂O(CH₂)₂OCH₂OH |
| C-56 | C₆H₁₃ | C₆H₁₃ | (CH₂)₂O(CH₂)₂OCH₂OH |
| C-57 | C₈H₁₇ | C₈H₁₇ | (CH₂)₂O(CH₂)₂OCH₂OH |
| C-58 | C₄H₉ | (CH₂)₂O(CH₂)₂OCH₂OH | (CH₂)₂O(CH₂)₂OCH₂OH |
| C-59 | C₄H₉ | C₄H₉ | CH₂CH═CH₂ |
| C-60 | C₄H₉ | CH₂CH═CH₂ | CH₂CH═CH₂ |
| C-61 | (CH₂)₂CO₂CH₂CH₃ | (CH₂)₂CO₂CH₂CH₃ | (CH₂)₂CO₂CH₂CH₃ |
| C-62 | (CH₂)₂CO₂(CH₂)₃CH₃ | (CH₂)₂CO₂(CH₂)₃CH₃ | (CH₂)₂CO₂(CH₂)₃CH₃ |
| C-63 | (CH₂)₂CONH(CH₂)₃CH₃ | (CH₂)₂CONH(CH₂)₃CH₃ | (CH₂)₂CONH(CH₂)₃CH₃ |
| C-64 | C₄H₉ | C₄H₉ | (CH₂)₂OP═O(OC₄H₉)₂ |
| C-65 | C₄H₉ | C₄H₉ | (CH₂)₃OP═O(OC₄H₉)₂ |
| C-66 | C₄H₉ | C₄H₉ | (CH₂)₂OP═O(OC₄H₉)₂ |
| C-67 | C₄H₉ | C₄H₉ | (CH₂)₂O(CH₂)₂OP═O(OC₄H₉)₂ |
| C-68 | C₆H₁₃ | C₆H₁₃ | (CH₂)₂O(CH₂)₂OP═O(OC₄H₉)₂ |
| C-69 | C₆H₁₃ | C₆H₁₃ | (CH₂)₄OP═O(OC₄H₉)₂ |
| C-70 | c-C₆H₁₃ | c-C₆H₁₃ | (CH₂)₂O(CH₂)₂OP═O(OC₄H₉)₂ |
| C-71 | C₆H₁₂Cl | C₆H₁₂Cl | (CH₂)₂O(CH₂)₂OP═O(OC₄H₉)₂ |
| C-72 | C₄H₈Cl | C₄H₈Cl | (CH₂)₂O(CH₂)₂OP═O(OC₄H₉)₂ |
| C-73 | C₄H₈Cl | C₄H₈Cl | (CH₂)₂O(CH₂)₂OP═O(OC₄H₈Cl)₂ |
| C-74 | C₄H₉ | C₄H₉ | 2-tetrahydrofuranyl |
| C-75 | C₄H₉ | 2-tetrahydrofuranyl | 2-tetrahydrofuranyl |
| C-76 | 2-tetrahydrofuranyl | 2-tetrahydrofuranyl | 2-tetrahydrofuranyl |

Then, compounds represented by formula (4) in the invention are described in detail.

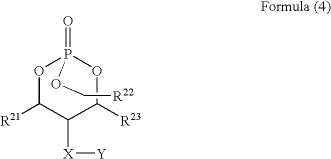

In the above formula, R²¹, R²² and R²³ are independent of each other, and each of them is preferably a hydrogen atom or a 1-5C alkyl group (e.g., methyl, ethyl, propyl, isopropyl, butyl, amyl). Herein, it is particularly preferred that at least one or more of R²¹, R²² and R²³ are 1-3C alkyl groups (e.g., methyl, ethyl, propyl, isopropyl). X is preferably a divalent linkage group formed of one or more groups selected from a single bond, —O—, —CO—, alkylene groups (containing preferably 1 to 6 carbon atoms, far preferably 1 to 3 carbon atoms, such as methylene, ethylene and propylene) or arylene groups (containing preferably 6 to 24 carbon atoms, far preferably 6 to 12 carbon atoms, such as phenylene, biphenylene and naphthylene), especially preferably a divalent linkage group formed of one or more groups selected from —O—, alkylene groups or arylene groups. Y is preferably a hydrogen atom, an alkyl group (containing preferably 2 to 25 carbon atom, far preferably 2 to 20 carbon atoms, such as ethyl, isopropyl, t-butyl, hexyl, 2-ethylhexyl, t-octyl, dodecyl, cyclohexyl, dichlorohexyl or adamantyl), an aryl group (containing preferably 6 to 24 carbon atoms, far preferably 6 to 18 carbon atoms, such as phenyl, biphenyl, terphenyl or naphthyl), or an aralkyl group (containing preferably 7 to 30 carbon atoms, far preferably 7 to 20 carbon atoms, such as benzyl, cresyl, t-butylphenyl, diphenylmethyl or triphenylmethyl), especially preferably an alkyl group, an aryl group or an aralkyl group. As to the combined group —X—Y, the total number of carbon atoms therein is preferably from 0 to 40, far preferably from 1 to 30, especially preferably from 1 to 25.

The compounds represented by formula (4) are illustrated in detail with examples shown below, but the invention should not be construed as being limited to these examples in any way.

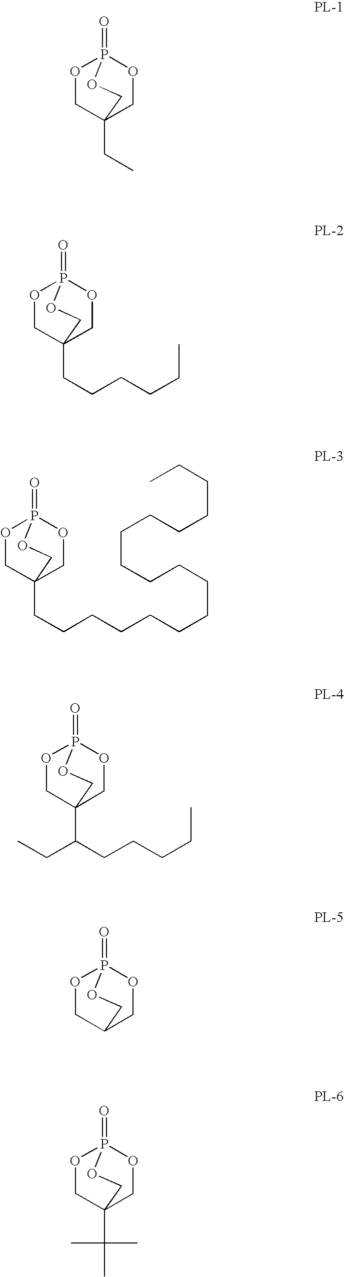

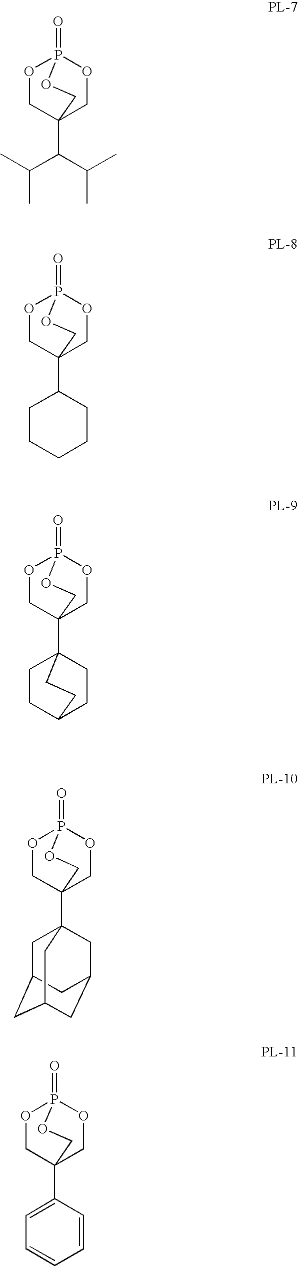

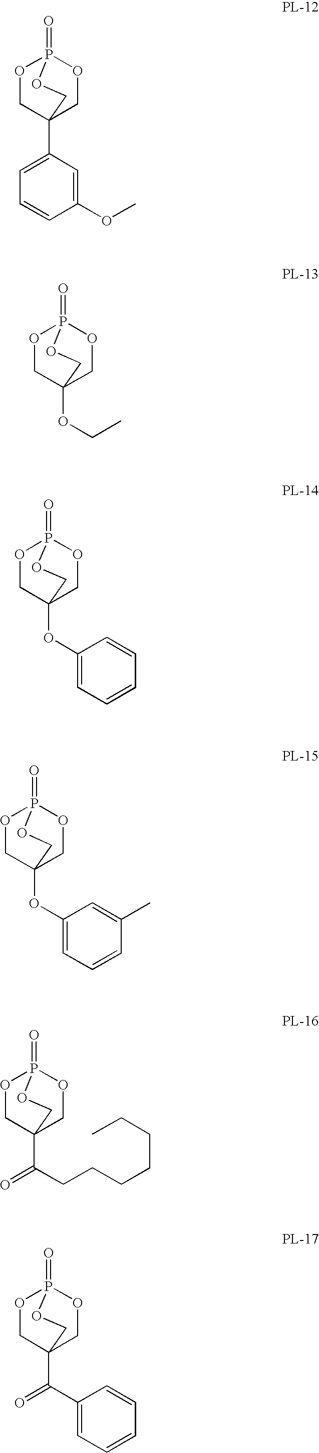

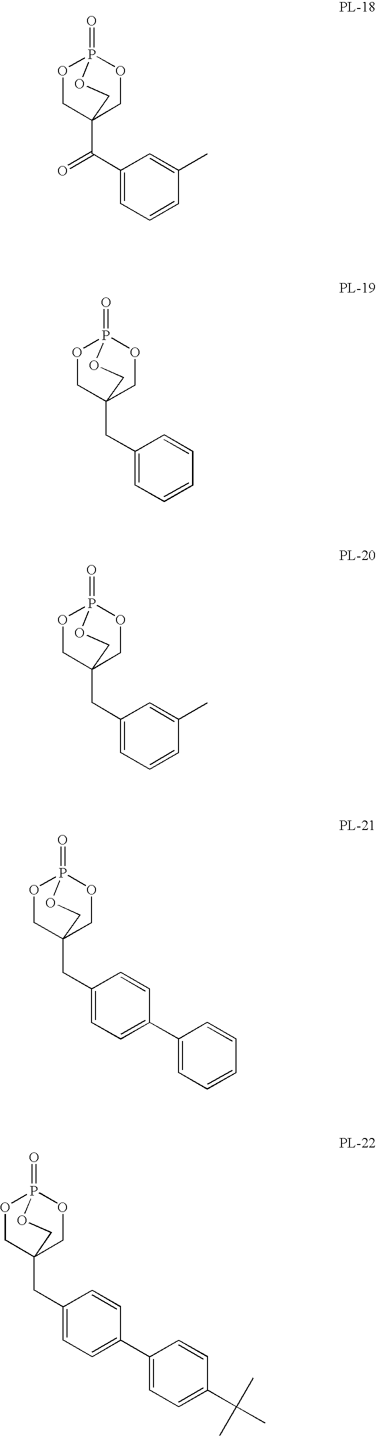

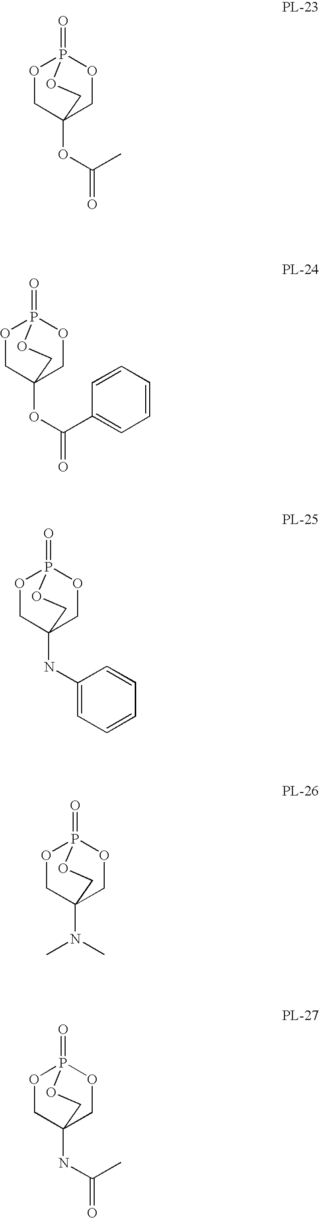

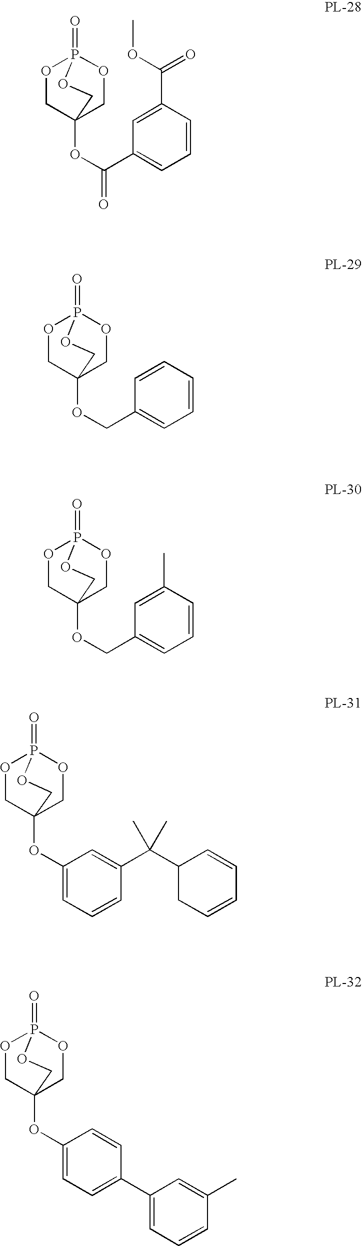

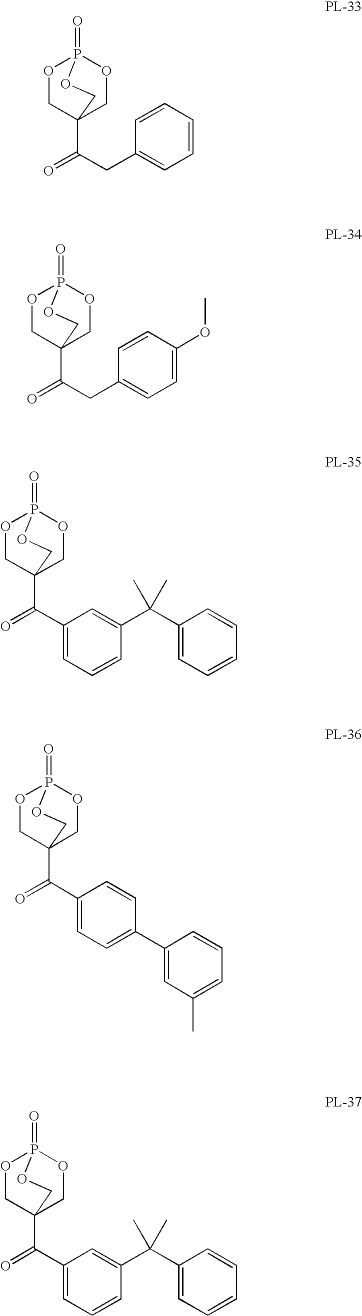

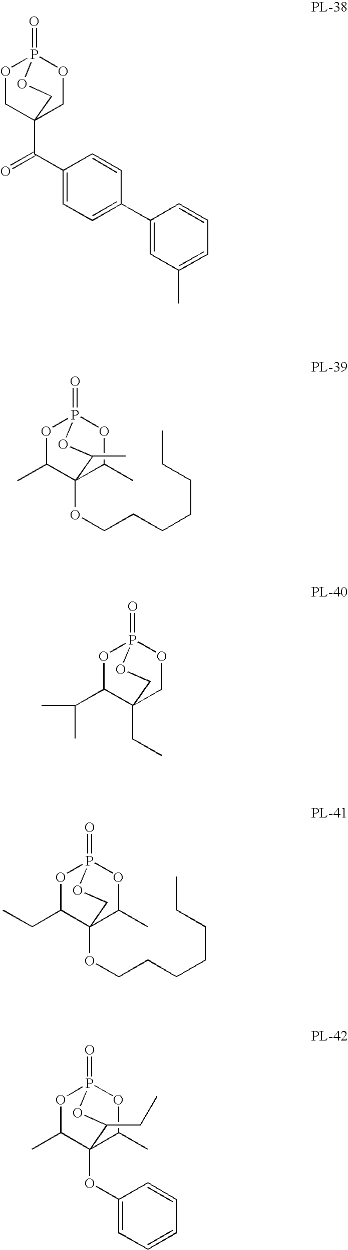

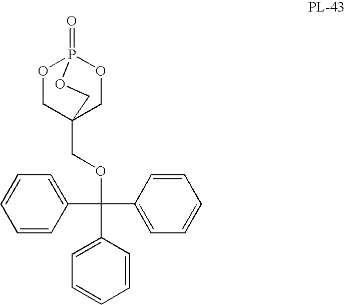

Compounds represented by formula (3) or (4) in the invention may be used alone, or two or more of them may be used together in arbitrary proportions. In both the case of single use and the case of combined use, compounds represented by formula (3) or (4) in the invention are added in a total amount of preferably from 0.01 to 20 mass %, far preferably from 0.1 to 18 mass %, further preferably from 1.0 to 15 mass %, based on the cyclic olefin resin used in combination therewith.

Subsequently, compounds represented by formula (5) or (6) are described in detail.

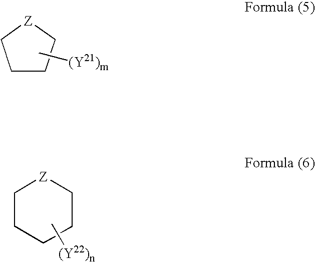

In formulae (5) and (6) each, Z represents a carbon atom, an oxygen atom, a sulfur atom or —NR²⁵—, and R²⁵ represents a hydrogen atom or an alkyl group. The 5- or 6-membered ring in which Z is contained as a ring member may have one or more substituents, and two or more substituents may combine with each other to form a ring. Examples of the 5- or 6-membered ring containing Z as a ring member include tetrahydrofuran, tetrahydropyran, tetrahydrothiophene, thian, pyrrolidine, piperidine, indoline, chroman, isochroman, tetrahydro-2-furanone, tetrahydro-2-pyrone, 4-butanelactam and 6-hexanolactam.

In the 5- or 6-membered rings each containing Z as a ring member are also included lactone and lactam structures, namely cyclic ester and amide structures which each have an oxo group on the carbon atom adjacent to Z. Examples of such cyclic ester and amide structures include 2-pyrrolidone, 2-piperidone, 5-pentanolide and 6-hexanolide.

R²⁵ represents a hydrogen atom or an alkyl group containing preferably 1 to 20, far preferably 1 to 16, especially preferably 1 to 12, carbon atoms (including linear, branched and cyclic alkyl groups). Examples of the alkyl group represented by R²⁵ include methyl, ethyl, n-propyl, isopropyl, n-butyl, isobutyl, sec-butyl, t-butyl, n-pentyl, t-amyl, n-hexyl, n-octyl, decyl, dodecyl, eicosyl, 2-ethylhexyl, cyclopentyl, cyclohexyl, cycloheptyl, 2,6-dimethylcyclohexyl, 4-t-butylcyclohexyl, cyclopentyl, 1-adamantyl, 2-adamantyl and bicyclo[2.2.2]octane-3-yl. Such an alkyl group represented by R²⁵ may further have a substituent. Examples of such a substituent include the groups the foregoing R¹¹ to R¹³ may have as substituents.

Y²¹ and Y²² are independent of each other, and each of them represents an ester group, an alkoxycarbonyl group, an amido group or a carbamoyl group. The ester group contains preferably 1 to 20 carbon atoms, far preferably 1 to 16 carbon atoms, especially preferably 1 to 12 carbon atoms, and examples thereof include acetoxy, ethylcarbonyloxy, propylcarbonyloxy, n-butylcarbonyloxy, iso-butylcarbonyloxy, t-butylcarbonyloxy, sec-butylcarbonyloxy, n-pentylcarbonyloxy, t-amylcarbonyloxy, n-hexylcarbonyloxy, cyclohexylcarbonyloxy, 1-ethylpentylcarbonyloxy, n-heptylcarbonyloxy, n-nonylcarbonyloxy, n-undecylcarbonyloxy, benzylcarbonyloxy, 1-naphthalenecarbonyloxy, 2-naphthalenecarbonyloxy and 1-adamantanecarbonyloxy. The alkoxycarbonyl group contains preferably 1 to 20 carbon atoms, far preferably 1 to 16 carbon atoms, especially preferably 1 to 12 carbon atoms, and examples thereof include methoxycarbonyl, ethoxycarbonyl, n-propyloxycarbonyl, isopropyloxycarbonyl, n-butoxycarbonyl, t-butoxycarbonyl, iso-butyloxycarbonyl, sec-butyloxycarbonyl, n-pentyloxycarbonyl, t-amyloxycarbonyl, n-hexyloxycarbonyl, cyclohexyloxycarbonyl, 2-ethylhexyloxycarbonyl, 1-ethylpropyloxycarbonyl, n-octyloxycarbonyl, 3,7-dimethyl-3-octyloxycarbonyl, 3,5,5-trimethylhexyloxycarbonyl, 4-t-butylcyclohexyloxycarbonyl, 2,4-dimethylpentyl-3-oxycarbonyl, 1-adamantaneoxycarbonyl, 2-adamantaneoxycarbonyl, dicyclopentadienyloxycarbonyl, n-decyloxycarbonyl, n-dodecyloxycarbonyl, n-tetradecyloxycarbonyl and n-hexadecyloxycarbonyl.

The amido group contains preferably 1 to 20 carbon atoms, far preferably 1 to 16 carbon atoms, especially preferably 1 to 12 carbon atoms, and examples thereof include acetamido, ethylcarboxamido, n-propylcarboxamido, isopropylcarboxamido, n-butylcarboxamido, t-butylcarboxamido, iso-butylcarboxamido, sec-butylcarboxamido, n-pentylcarboxamido, t-amylcarboxamido, n-hexylcarboxamido, cyclohexylcarboxamido, 1-ethylpentylcarboxamido, 1-ethylpropylcarboxamido, n-heptylcarboxamido, n-octylcarboxamido, 1-adamantanecarboxamido, 2-adamantanecarboxamido, n-nonylcarboxamido, n-dodecylcarboxamido, n-pentanecarboxamido and n-hexadecylcarboxamido.

The carbamoyl group contains preferably 1 to 20 carbon atoms, far preferably 1 to 16 carbon atoms, especially preferably 1 to 12 carbon atoms, and examples thereof include methylcarbamoyl, dimethylcarbamoyl, ethylcarbamoyl, diethylcarbamoyl, n-propylcarbamoyl, isopropylcarbamoyl, n-butylcarbamoyl, t-butylcarbamoyl, iso-butylcarbamoyl, sec-butylcarbamoyl, n-pentylcarbamoyl, t-amylcarbamoyl, n-hexylcarbamoyl, cyclohexylcarbamoyl, 2-ethylhexylcarbamoyl, 2-ethylbutylcarbamoyl, t-octylcarbamoyl, n-heptylcarbamoyl, n-octylcarbamoyl, 1-adamantanecarbamoyl, 2-adamantanecarbamoyl, n-decylcarbamoyl, n-dodecylcarbamoyl, n-tetradecylcarbamoyl and n-hexadecylcarbamoyl. Y²¹s may combine with each other to form a ring. Likewise, Y²²s may combine with each other to form a ring. Y²¹ and Y²² each may further have a substituent. Examples of such a substituent include the groups the foregoing R¹¹ to R¹³ may have as substituents.

Subsequently, compounds represented by formulae (7) to (15) are described in detail.

In formulae (7) to (15), Y³¹ to Y⁷⁰ are independent of each other, and each of them represent an ester group, an alkoxycarbonyl group, an amido group, a carbamoyl group or a hydroxyl group. The ester group contains preferably 1 to 20 carbon atoms, far preferably 1 to 16 carbon atoms, especially preferably 1 to 12 carbon atoms, and examples thereof include acetoxy, ethylcarbonyloxy, propylcarbonyloxy, n-butylcarbonyloxy, iso-butylcarbonyloxy, t-butylcarbonyloxy, sec-butylcarbonyloxy, n-pentylcarbonyloxy, t-amylcarbonyloxy, n-hexylcarbonyloxy, cyclohexylcarbonyloxy, 1-ethylpentylcarbonyloxy, n-heptylcarbonyloxy, n-nonylcarbonyloxy, n-undecylcarbonyloxy, benzylcarbonyloxy, 1-naphthalenecarbonyloxy, 2-naphthalenecarbonyloxy and 1-adamantanecarbonyloxy. The alkoxycarbonyl group contains preferably 1 to 20 carbon atoms, far preferably 1 to 16 carbon atoms, especially preferably 1 to 12 carbon atoms, and examples thereof include methoxycarbonyl, ethoxycarbonyl, n-propyloxycarbonyl, isopropyloxycarbonyl, n-butoxycarbonyl, t-butoxycarbonyl, iso-butyloxycarbonyl, sec-butyoloxycarbonyl, n-pentyloxycarbonyl, t-amyloxycarbonyl, n-hexyloxycarbonyl, cyclohexyloxycarbonyl, 2-ethylhexyloxycarbonyl, 1-ethylpropyloxycarbonyl, n-octyloxycarbonyl, 3,7-dimethyl-3-octyloxycarbonyl, 3,5,5-trimethylhexyloxycarbonyl, 4-t-butylcyclohexyloxycarbonyl, 2,4-dimethylpentyl-3-oxycarbonyl, 1-adamantaneoxycarbonyl, 2-adamantaneoxycarbonyl, dicyclopentadienyloxycarbonyl, n-decyloxycarbonyl, n-dodecyloxycarbonyl, n-tetradecyloxycarbonyl and n-hexadecyloxycarbonyl.

The amido group contains preferably 1 to 20 carbon atoms, far preferably 1 to 16 carbon atoms, especially preferably 1 to 12 carbon atoms, and examples thereof include acetamido, ethylcarboxamido, n-propylcarboxamido, isopropylcarboxamido, n-butylcarboxamido, t-butylcarboxamido, iso-butylcarboxamido, sec-butylcarboxamido, n-pentylcarboxamido, t-amylcarboxamido, n-hexylcarboxamido, cyclohexylcarboxamido, 1-ethylpentylcarboxamido, 1-ethylpropylcarboxamido, n-heptylcarboxamido, n-octylcarboxamido, 1-adamantanecarboxamido, 2-adamantanecarboxamido, n-nonylcarboxamido, n-dodecylcarboxamido, n-pentanecarboxamido and n-hexadecylcarboxamido. The carbamoyl group contains preferably 1 to 20 carbon atoms, far preferably 1 to 16 carbon atoms, especially preferably 1 to 12 carbon atoms, and examples thereof include methylcarbamoyl, dimethylcarbamoyl, ethylcarbamoyl, diethylcarbamoyl, n-propylcarbamoyl, isopropylcarbamoyl, n-butylcarbamoyl, t-butylcarbamoyl, iso-butylcarbamoyl, sec-butylcarbamoyl, n-pentylcarbamoyl, t-amylcarbamoyl, n-hexylcarbamoyl, cyclohexylcarbamoyl, 2-ethylhexylcarbamoyl, 2-ethylbutylcarbamoyl, t-octylcarbamoyl, n-heptylcarbamoyl, n-octylcarbamoyl, 1-adamantanecarbamoyl, 2-adamantanecarbamoyl, n-decylcarbamoyl, n-dodecylcarbamoyl, n-tetradecylcarbamoyl and n-hexadecylcarbamoyl.

Y³¹ to Y⁷⁰ each may further have a substituent, and examples of such a substituent include the groups the foregoing R¹¹ to R¹³ may have as substituents.

V³¹ to V⁴³ are independent of each other, and each of them represents a hydrogen atom or an aliphatic group containing preferably 1 to 20 carbon atoms, far preferably 1 to 16 carbon atoms, especially preferably 1 to 12 carbon atoms. Herein, the aliphatic group is preferably an aliphatic hydrocarbon group, far preferably an alkyl group (including linear, branched and cyclic ones), an alkenyl group or an alkynyl group. Examples of such an alkyl group include methyl, ethyl, n-propyl, isopropyl, n-butyl, isobutyl, sec-butyl, t-butyl, n-pentyl, t-amyl, n-hexyl, n-octyl, decyl, dodecyl, eicosyl, 2-ethylhexyl, cyclopentyl, cyclohexyl, cycloheptyl, 2,6-dimethylcyclohexyl, 4-t-butylcyclohexyl, cyclopentyl, 1-adamantyl, 2-adamantyl and bicyclo[2.2.2]octane-3-yl. Examples of such an alkenyl group include vinyl, allyl, pulenyl, geranyl, oleyl, 2-cyclopentene-1-yl and 2-cyclohexene-1-yl, and examples of such an alkynyl group include ethynyl and propargyl. V³¹ to V⁴³ each may further have a substituent, and examples of such a substituent include the groups the foregoing R¹¹ to R¹³ may have as substituents.

L³¹ to L⁸⁰ each represent a divalent saturated linkage group containing 0 to 40 atoms, inclusive of 0 to 20 carbon atoms, independently. Herein, the case where the number of atoms contained in a linkage group represented by any of L³¹ to L⁸⁰ is 0 means that a single bond is formed by direct binding between groups on both sides of the linkage group. Suitable examples of L³¹ to L⁷⁷ each include alkylene groups (e.g., methylene, ethylene, propylene, trimethylene, tetramethylene, pentamethylene, hexamethylene, methylethylene, ethylethylene), divalent cyclic groups (e.g., cis-1,4-cyclohexylene, trans-1,4-cyclohexylene, 1,3-cyclopentylidene), ether, thioether, ester, amido, sulfone, sulfoxide, sulfide, sulfonamide, ureylene and thioureylene. These divalent groups may combine with each other to form divalent compound groups, and examples of such compound groups include —(CH₂)₂O(CH₂)₂—, —(CH₂)₂O(CH₂)₂O(CH₂)—, —(CH₂)₂S(CH₂)₂— and —(CH₂)₂O₂C(CH₂)₂—. L³¹ to L⁸⁰ may further have a substituent, and examples of such a substituent include the groups the foregoing R¹¹ to R¹³ may have as substituents.

Suitable examples of compounds formed from combinations of Y³¹ to Y⁷⁰, V³¹ to V⁴³ and L³¹ to L⁸⁰ in formulae (7) to (15) include citric acid esters (e.g., triethyl O-acetylcitrate, tributyl O-acetylcitrate, acetyltriethyl citrate, acetyltributyl citrate, O-acetylcitric acid tri(ethyloxycarbonylmethylene) ester), oleic acid esters (e.g., ethyl oleate, butyl oleate, 2-ethylhexyl oleate, phenyl oleate, cyclohexyl oleate, octyl oleate), recinoleic acid esters (e.g., methylacetyl recinoleate), sebacic acid esters (e.g., dibutyl sebacate), carboxylic acid esters of glycerin (e.g., triacetin, tributyrin), glycolic acid esters (e.g., butylphthalylbutyl glycolate, ethylphthalylethyl glycolate, methylphthalylethyl glycolate, methylphthalylmethyl glycolate, propylphthalylpropyl glycolate, octylphthalyloctyl glycolate), carboxylic acid esters of pentaerythritol (e.g., pentaerythritol tetraacetate, pentaerythritol tetrabutyrate), carboxylic acid esters of dipentaerythritol (e.g., dipentaerythritol hexaacetate, dipentaerythritol hexabutyrate, dipentaerythritol tetraacetate), carboxylic acid esters of trimethylolpropane (e.g., trimethylolpropane triacetate, trimethylolpropane diacetate monopropionate, trimethylolpropane tripropionate, trimethylolpropane tributyrate, trimethylolpropane tripivaloate, trimethylolpropane tri(t-butylacetate), trimethylolpropane di(2-ethylhexanate), trimethylolpropane tetra(2-ethylhexanate), trimethylolpropane diacetate monooctanate, trimethylolpropane trioctanate, trimethylolpropane tri(cyclohexanecarboxylate)), the glycerol esters disclosed in JP-A-11-246704, the diglycerol esters disclosed in JP-A-2000-63560, the citric acid esters disclosed in JP-A-11-92574, pyrrolidonecarboxylic acid esters (e.g., methyl 2-pyrrolidone-5-carboxylate, ethyl 2-pyrrolidone-5-carboxylate, butyl 2-pyrrolidone-5-carboxylate, 2-ethylhexyl 2-pyrrolidone-5-carboxylate), cyclohexanedicarboxylic acid esters (e.g., dibutyl cis-1,2-cyclohexanedicarboxylate, dibutyl trans-1,2-cyclohexanedicarboxylate, dibutyl cis-1,4-cyclohexanedicarboxylate, dibutyl trans-1,4-cyclohexanediccarboxylate), and xylitol carboxylic acid esters (e.g., xylitol pentaacetate, xylitol tetraacetate, xylitol pentapropionate).

Detailed explanations of compounds represented by formulae (5) to (15) are given below with examples, but the invention should not be construed as being limited to these examples in any way.

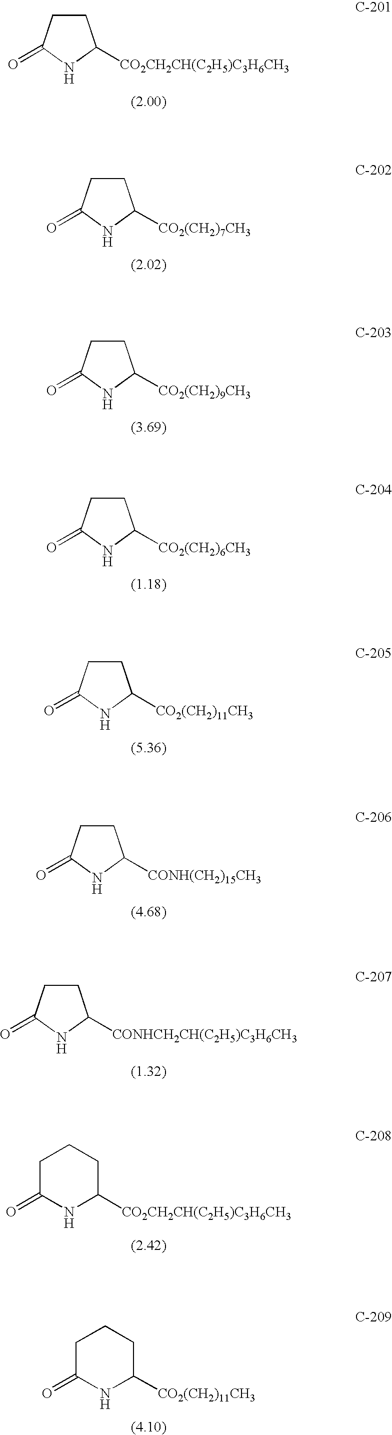

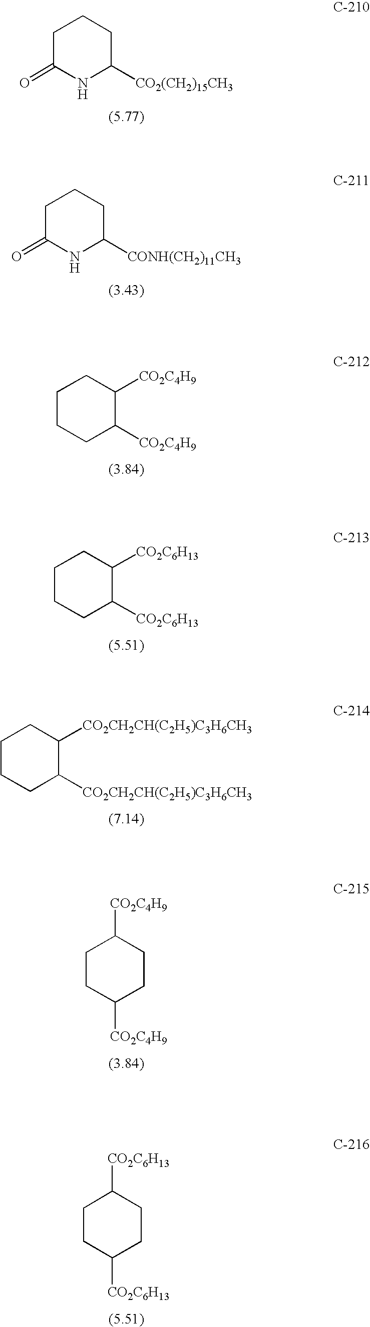

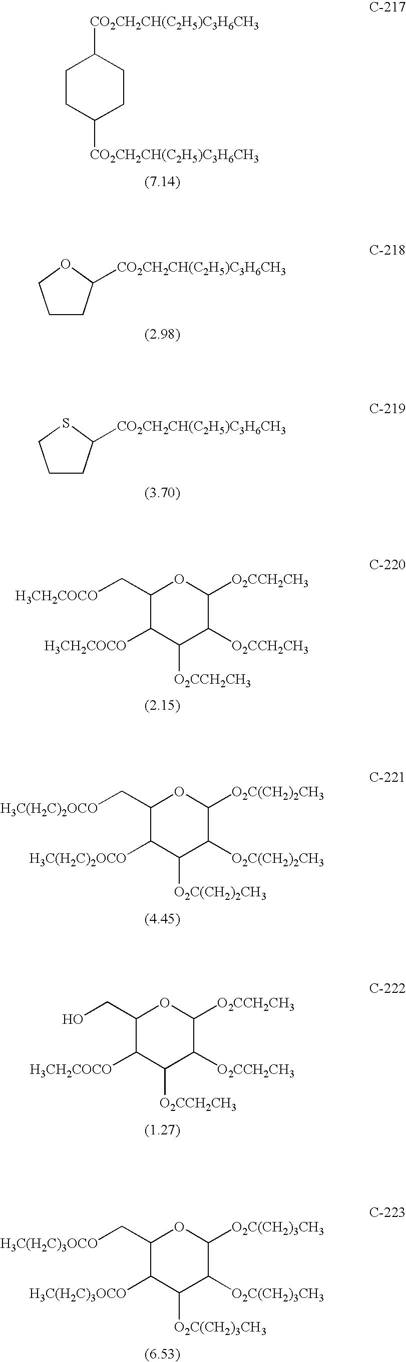

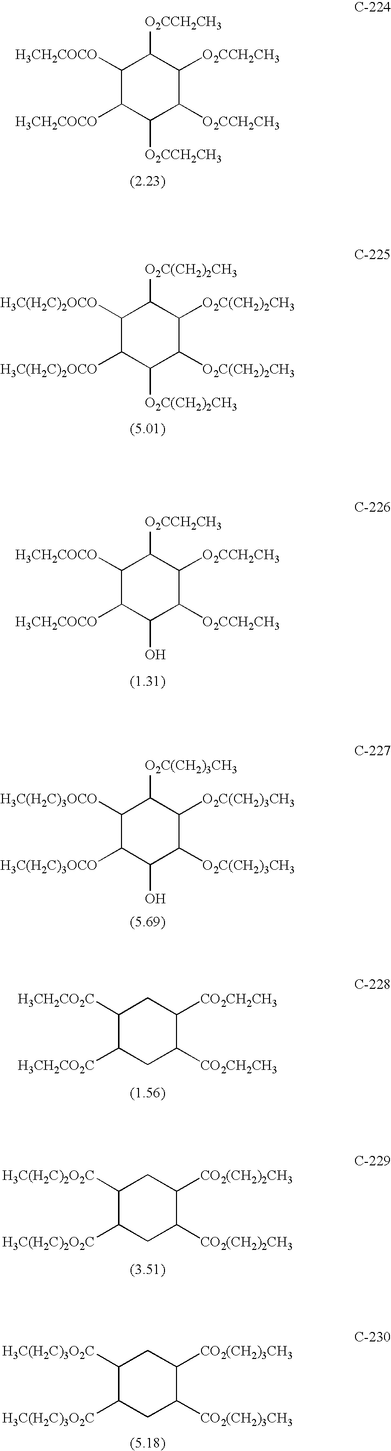

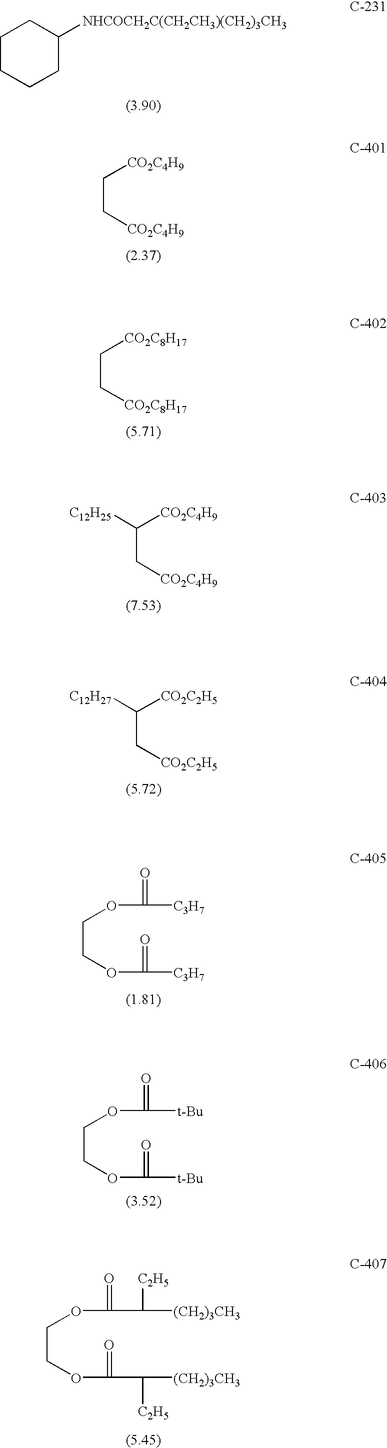

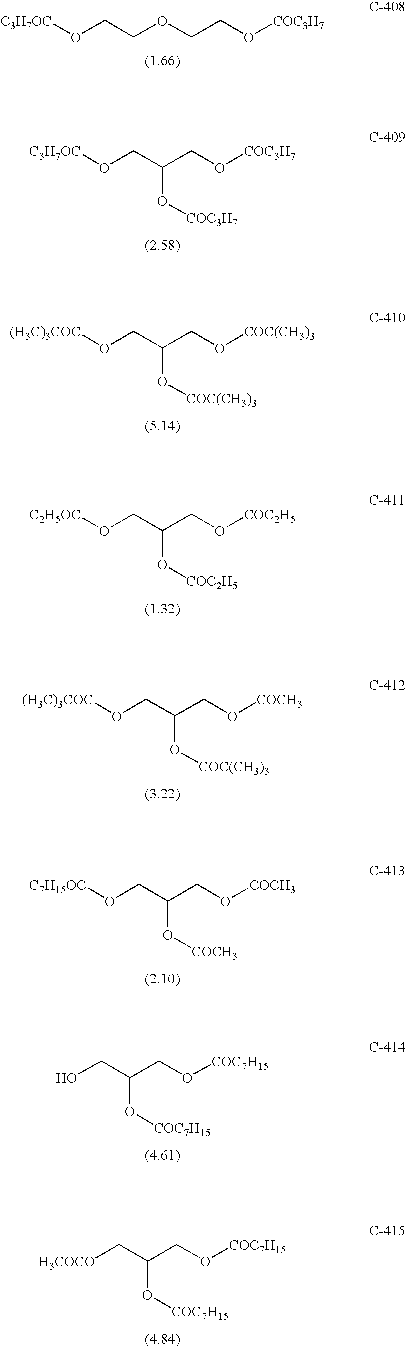

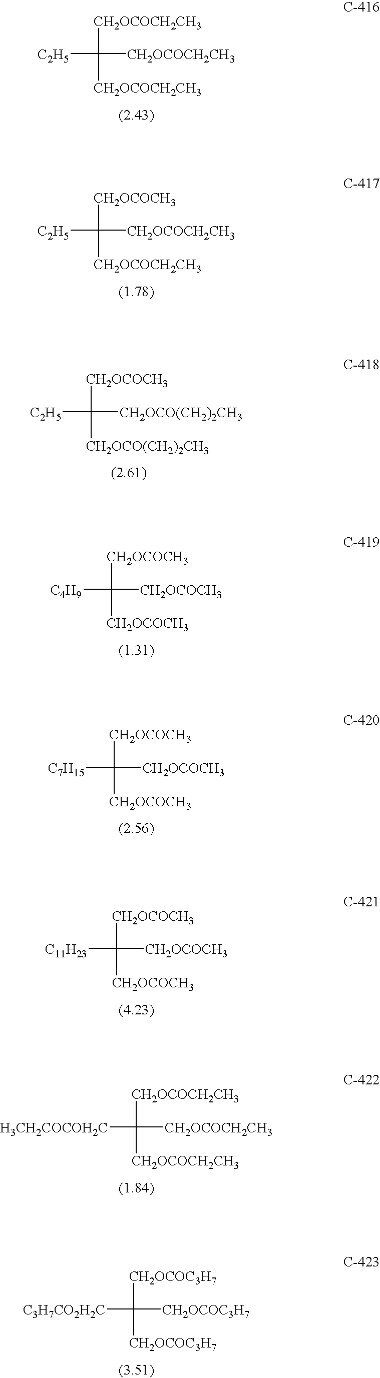

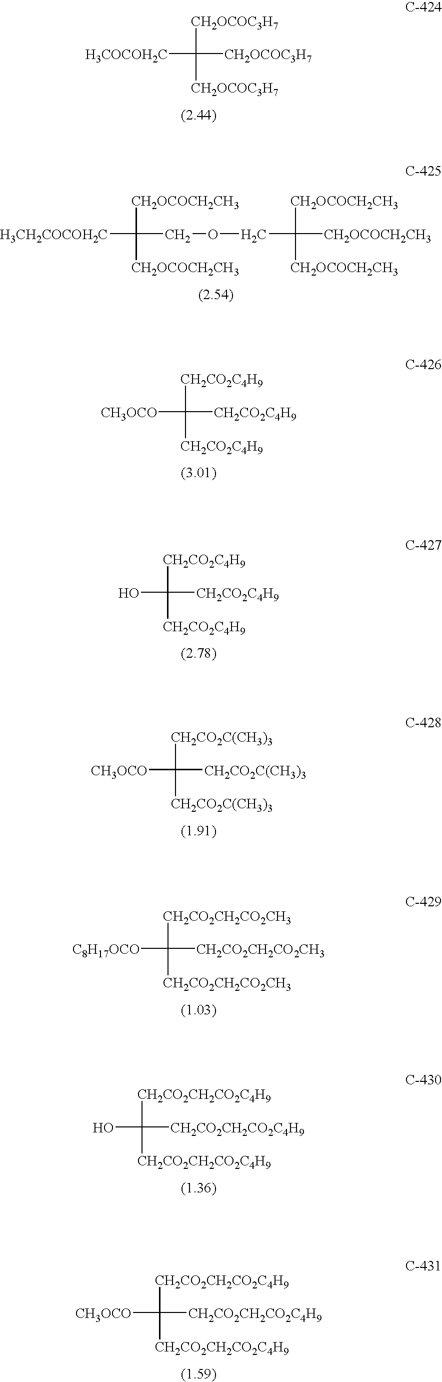

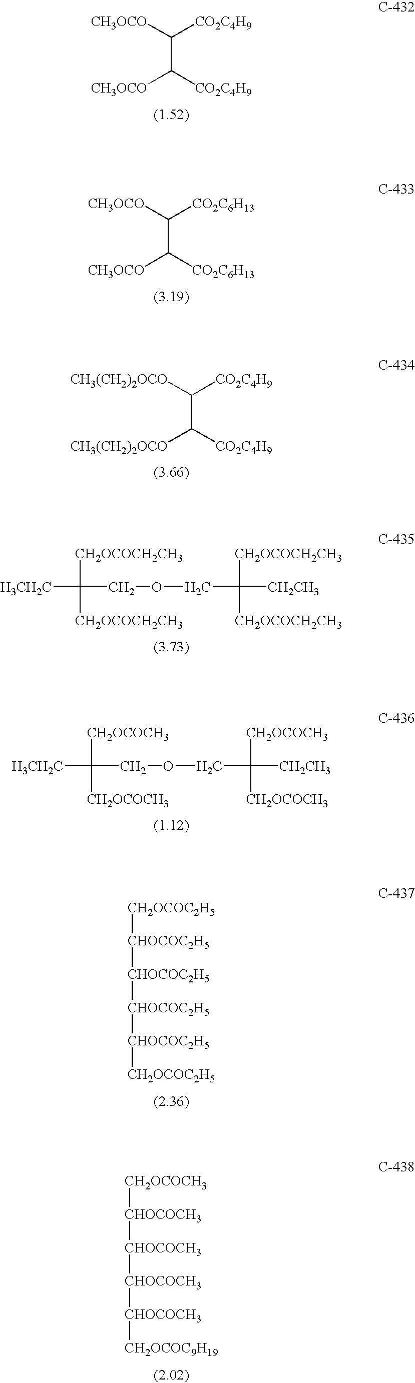

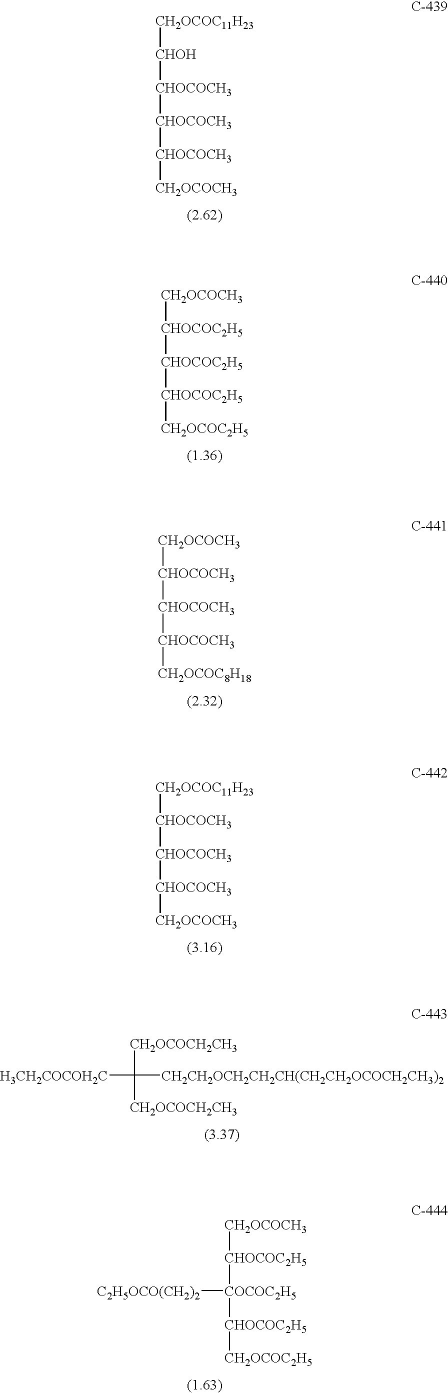

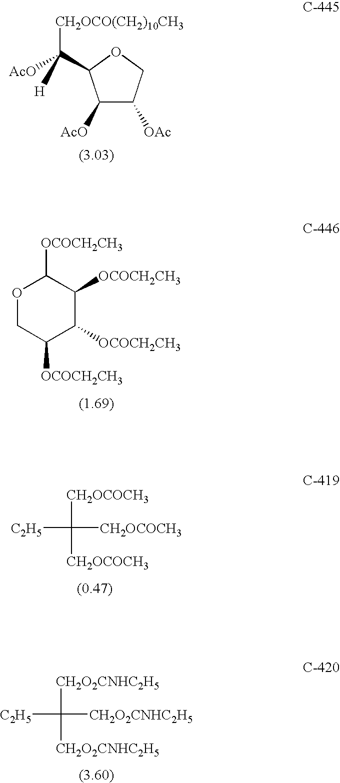

Compounds represented by formulae (5) to (15) in the invention may be used alone, or two or more of them may be used together in arbitrary proportions. In both the case of single use and the case of combined use, compounds represented by formulae (5) to (15) in the invention are added in a total amount of preferably from 0.01 to 20 mass %, far preferably from 0.1 to 18 mass %, further preferably from 1.0 to 15 mass %, based on the cyclic olefin resin used in combination therewith.

### (Cyclic Olefin Resin)

Cyclic olefin resins usable for the cyclic olefin resin film of the invention signify polymer resins having cyclic olefin structures. Examples of polymer resins having cyclic olefin structures include (1) norbornene polymers, (2) monocyclic cyclic olefin polymers, (3) cyclic conjugated diene polymers, (4) vinyl cycloaliphatic hydrocarbon polymers, and hydrogenation products of the polymers (1) to (4). Polymers preferably used in the invention include addition (co)polymers containing at least one kind of repeating units represented by the following formula (17), and addition (co)polymers further containing at least one kind of repeating units represented by the following formula (16) according to need in addition to at least one kind of repeating units represented by the following formula (17). In addition, open-circular (co)polymers containing at least one kind of repeating units represented by the following formula (18) can be used to advantage.

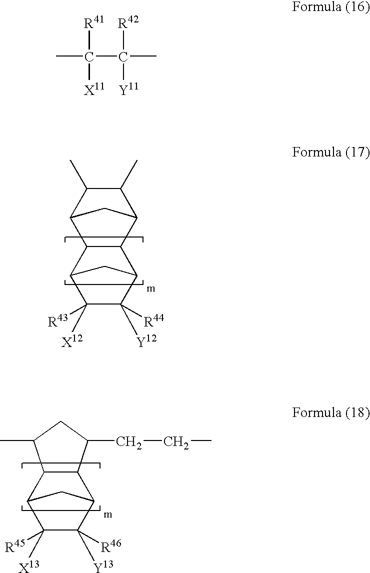

In the above formulae, m represents an integer of 0 to 4, R⁴¹ to R⁴⁶ each independently represents a hydrogen atom or a 1-10C hydrocarbon group. X¹¹ to X¹³ and Y¹¹ to Y¹³ are independent of each other and each of them represents a hydrogen atom, a 1-10C hydrocarbon group, a halogen atom, a 1-10C halogenated hydrocarbon group, —(CH₂)ₙCOOR⁵¹, —(CH₂)ₙOCOR⁵², —(CH₂)ₙNCO, —(CH₂)ₙNO₂, —(CH₂)ₙCN, —(CH2)ₙCONR⁵³R⁵⁴, —(CH₂)ₙNR⁵³R⁵⁴, —(CH₂)ₙ, —(CH₂)ₙW, or a combination of X¹¹ with Y¹¹, X¹² with Y¹² or X¹³ with Y¹³ represents (—CO)₂O or (—CO)₂NR⁵⁵. Herein, R⁵¹, R⁵², R⁵³, R⁵⁴ and R⁵⁵ each represent a hydrogen atom or a 1-20C hydrocarbon group, Z represents a hydrocarbon group or a halogenated hydrocarbon group, W represents —SiR⁵⁶ₚD₃₋ₚ, R⁵⁶ represents a 1-10C hydrocarbon group, D represents a halogen atom, —OCOR⁵⁶ or —OR⁵⁶, p represents an integer of 0 to 3, and n represents an integer of 0 to 10.

By introduction of functional groups having great polarizability into substituents represented by part or all of X¹¹ to X¹³ and Y¹¹ to Y¹³, retardation (Rth) in the thickness direction of an optical film can be made great, and developability of in-plane retardation (Re) can be enhanced. Films with great Re developability can have great Re values by stretching in the film-forming process.

Norbornene addition (co)polymers are disclosed, e.g., in JP-A-10-7732, JP-T-2002-504184 (the term “JP-T” as used herein means a published Japanese translation of a PCT patent application), U.S. Patent Application Laid-open 2004/229157 and WO 2004/070463. They can be prepared by addition polymerization of norbornene series polycyclic unsaturated compounds. Alternatively, if needed, they may be prepared by addition copolymerization of norbornene series polycyclic unsaturated compounds and ethylene, propylene or butene; a conjugated diene, such as butadiene or isoprene; a non-conjugated diene, such as ethylidenenorbornene; or a linear diene compound, such as acrylonitrile, acrylic acid, methacrylic acid, maleic anhydride, an acrylic acid ester, a methacrylic acid ester, maleimide, vinyl acetate or vinyl chloride. These norbornene addition (co)polymers are available under the trade name of APEL from Mitsui Chemicals, Inc., and products thereof come in gradations of glass transition temperature (Tg), such as APL8008T (Tg: 70° C.), APL6013T (Tg: 125° C.) and APL6015T (Tg: 135° C.). In addition, pellet-shaped products are marketed from Polyplastics Co., Ltd. under the trade names of TOPAS8007 (Tg: 80° C.), TOPAS6013 (Tg: 140° C.) and TOPAS6015 (Tg: 160° C.). Moreover, Appear 3000 (Tg: 330° C.) is available from Ferrania S.p.A.

As disclosed in JP-A-1-240517, JP-A-7-196736, JP-A-60-26024, JP-A-62-19801, JP-A-2003-1159767 and JP-A-2004-309979 each, hydrogenation products of norbornene polymers are obtained by hydrogenation after addition polymerization or ring-opening metathesis polymerization of polycyclic unsaturated compounds. In the norbornene polymers for use in the invention, each of R⁴⁵ arid R⁴⁶ is preferably a hydrogen atom or —CH₃, each of X¹³ and Y¹³ is preferably a hydrogen atom, —Cl, —COOCH₃ or —CH₂OCOCH₃, and the other substituents are chosen as appropriate. These norbornene resins are available from JSR Corporation under the trade names of Arton G and Arton F, and further from Zeon Corporation under the trade names of Zeonor 750R, Zeonor 1020R, Zeonor 1600, Zeonex 250 and Zeonex 280.

### (Additives)

To a cyclic olefin resin composition and film according to the invention can be added various additives (e.g., a deterioration (oxidation) inhibitor, a UV-ray protective agent, fine particles, a stripping accelerator, an infrared absorbent) with reference to their respective uses in each of preparation steps. Such additives may be in a state of solid or oily matter. In other words, they are not particularly restricted in their melting and boiling points. For instance, ultraviolet absorbents melting at below and above 20° C., respectively, may be mixed together, and in a manner similar thereto anti-deterioration agents may be mixed together. In addition, descriptions of infrared-absorbing dyes are found, e.g., in JP-A-2001-194522. As to the addition timing of such additives, they may be added at any stage in the preparation of a cyclic olefin resin solution (dope). Alternatively, an additional step of adding additives may be performed as the final step in the dope preparation. Moreover, each ingredient has no particular limitation on its addition amount so long as its individual function can be achieved. When the cyclic olefin resin film is formed into a multilayer structure, kinds and amounts of additives added may vary from layer to layer.

### (Deterioration Inhibitor)

To a cyclic olefin resin solution and film according to the invention can be added known deterioration (oxidation) inhibitors, such as phenol series antioxidants or hydroquinone series antioxidants. Furthermore, it is preferable to add phosphorous antioxidants. These antioxidants are preferably added in an amount of 0.05 to 5.0 parts by mass per 100 parts by mass of cyclic olefin resin.

### (Ultraviolet Absorbent)

From the viewpoint of preventing a polarizing plate or liquid crystal from deteriorating, ultraviolet absorbents are preferably used in a cyclic olefin resin composition and film according to the invention. Compounds suitably used as ultraviolet absorbents are those having high absorptive capacity of ultraviolet rays with wavelengths of 370 nm or shorter and, from the viewpoint of ensuring good performance in liquid crystal display, showing slight absorption of visible light with wavelengths of 400 nm or longer. Examples of a ultraviolet absorbent preferably used in the invention include hindered phenol compounds, hydroxybenzophenone compounds, benzotriazole compounds, salicylate compounds, benzophenone compounds, cyanoacrylate compounds and nickel complex compounds. Examples of the hindered phenol compounds include 2,6-di-tert-butyl-p-cresol, pentaerythrityl-tetrakis[3-(3,5-di-tert-butyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene and tris(3,5-di-tert-butyl-4-hydroxybenzyl)isocyanurate. Examples of the benzotriazole compounds include 2-(2′-hydroxy-5′-methylphenyl)benzotriazole, 2,2′-methylenebis[4-(1,1,3,3-tetramethylbutyl)-6-(2H-benzotriazole-2-yl)phenol], 2,4-bis(n-octylthio)-6-(4-hydroxy-3,5-di-tert-butylanilino)-1,3,5-triazine, triethyleneglycol-bis[3-(3-tert-butyl-5-methyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, 2(2′-hydroxy-3′,5′-di-tert-butylphenyl)-5-chlorobenzotriazole, (2(2′-hydroxy-3′,5′-di-tert-amylphenyl)-5-chlorobenzotriazole, 2,6-di-tert-butyl-p-cresol and pentaerythrityl-tetrakis[3-(3,5-di-tert-butyl-4-hydroxyphenyl)propionate]. The amount of these UV-ray protective agents added to the cyclic olefin resin is preferably from 1 to 100,000 ppm by mass, far preferably from 10 to 1,000 ppm by mass.

### (Particulate Matting Agent)

For the purpose of preventing the present cyclic olefin resin film from suffering scratches and deterioration in transportability, it is favorable that a matting agent made up of organic and/or inorganic fine particles is incorporated into the film, and thereby the film is rendered matte.

For avoiding the cyclic olefin resin film from having too rough a surface, holding down film's haze and retaining film's transparency, it is suitable to choose the average particle diameter and content of a matting agent used in the film from the following ranges, respectively.

The term “the average particle diameter of a matting agent” as used herein refers to the average size of a matting agent present inside the film or on the film surface, and this particle diameter can be determined, whether the matting agent is an aggregate or not, by taking scanning electron micrographs and transmission electron micrographs of the film surface and section, measuring diameters of 100 particle images chosen from the micrographs taken, and calculating the average of these measured diameters.

The matting agent for use in the invention is a fine inorganic compound or a particulate polymer having an average particle diameter of preferably 0.1 to 3.0 μm, far preferably 0.15 to 2.0 μm, further preferably 0.2 to 1.0 μm.

When a matting agent used is made up of cohesive fine particles, the value described as the average particle diameter of the matting agent in the invention refers to the average size of aggregates (average secondary particle diameter), which can be controlled as the particle size in a dispersion by use of a dispersion formula described hereinafter so long as film formation is carried out using a solution casting method; while, when a matting agent used is non-cohesive fine particles, the average particle diameter refers to the average of measured values of primary particle sizes.

When a matting agent used in the invention is made up of cohesive fine particles, it is appropriate that the matting agent have an average primary particle size of 0.05 to 0.5 μm, preferably 0.08 to 0.3 μm, far preferably 0.1 to 0.25 μm.

Particulate polymers are preferable because the desired refractive index can be attained by making a proper selection of polymer species. In addition, particulate polymers are highly compatible with cyclic olefin resins. Therefore, particulate polymers used in film formation make it possible to hold down the haze, refraction and scattering of the film formed. Thus, the size grades selectable in the case of using a particulate polymer as a matting agent are higher than those in the case of using a fine inorganic compound as a matting agent, and permit enhancement of matting effect.

The content of a matting agent is preferably from 0.03 to 1.0 mass %, far preferably from 0.05 to 0.6 mass %, further preferably from 0.08 to 0.4 mass %, irrespective of particle shape, e.g., spherical or amorphous, and whatever its material may be, namely a fine inorganic compound or a particulate polymer.

In the invention, the suitable haze range of the cyclic olefin resin film containing a matting agent is 4.0% or below, preferably 2.0% or below, especially preferably 1.0% or below. The haze value can be determined according to JIS K-6714 and using a specimen having dimensions of 40 mm×80 nm and a haze meter, e.g., HGM-2DP made by Suga Test Instruments Co., Ltd. in 25° C. and 60% RH surroundings.

In the invention, the static friction coefficient of the cyclic olefin resin film containing a matting agent is preferably 0.8 or below, especially preferably 0.5 or below.

The static friction coefficient value of the cyclic olefin resin film can be determined as follows. Two test specimens with different sizes, a small specimen measuring 7.5 cm by 10 cm and a large specimen measuring 10 cm by 20 cm, are prepared, the large specimen is loaded on the stage mounted in Tensilon (a tension tester), the small specimen is put on the large specimen, a load of 200 g is further imposed on the small specimen, the small specimen is pulled with Tensilon, a load (f) at which the small specimen begins to slip is measured, and the static friction coefficient μ is calculated from the formula μ=f/200.

The composition of a matting agent used has no particular restriction, and two or more of matting agents may be used as a mixture. Examples of an inorganic compound used as a matting agent in the invention include fine powders of inorganic substances, such as barium sulfate, manganese colloid, titanium dioxide, strontium barium sulfate and silicon dioxide. As additional examples, mention may be made of silicon dioxide as synthetic silica obtained by a wet method or gelation of silicic acid and titanium dioxide (of not only rutile type but also anatase type) produced from titanium slug and sulfuric acid. In another way, a matting agent can be obtained by grinding an inorganic substance having relatively large particle diameters, e.g., 20 μm or above, into smaller particles, and then classifying the particles (by vibratory filtration or wind classification). Inorganic compounds as matting agents usable in the invention may further include inorganic compounds whose particle surfaces are modified with methyl groups and hydroxyl groups.

Examples of a macromolecular compound (a particulate polymer) include poly(tetrafluoroethylene), cellulose acetate, polystyrene, polymethyl methacrylate, polypropyl methacrylate, polymethyl acrylate, polyethylene carbonate and starch. Herein, pulverized and classified materials of those polymers are also included. Additionally, it is possible to use macromolecular compounds synthesized by suspension polymerization, and macromolecular compounds or inorganic compounds formed into spherical particles by a spray dry method or a dispersion method.

Moreover, matting agents may be those obtained by forming macromolecular compounds as polymers of one or more kinds of monomeric compounds as recited below into particles by use of various techniques. Examples of monomeric compounds as constituents of macromolecular compounds include acrylic acid esters, methacrylic acid esters, itaconic acid diesters, crotonic acid esters, maleic acid diesters and phthalic acid diesters. Examples of ester residues of these esters include methyl, ethyl, propyl, isopropyl, butyl, hexyl, 2-ethylhexyl, 2-chloroethyl, cycnoethyl, 2-acetoxyethyl, dimethylaminoethyl, benzyl, cyclohexyl, furfuryl, phenyl, 2-hydroxyethyl, 2-ethoxyethyl, glycidyl and ω-methoxypolyethylene glycol (number of moles of addition unit: 9).

Examples of vinyl esters include vinyl acetate, vinyl propionate, vinyl butyrate, vinyl caproate, vinyl chloroacetate, vinyl methoxyacetate, vinyl phenylacetate, vinyl benzoate and vinyl salicylate. Examples of olefins include dicyclopentadiene, ethylene, propylene, 1-butene, 1-pentene, vinyl chloride, vinylidene chloride, isoprene, chloroprene, butadiene and 2,3-dimethylbutadiene.

Examples of styrenes include styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, trifluoromethylstyrene and methyl vinylbenzoate.

Examples of acrylamides include acrylamide, methylacrylamide, ethylacrylamide, propylacrylamide, butylacrylamide, tert-butylacrylamide, phenylacrylamide and dimethylacrylamide; examples of methacrylamides include methacrylamide, methylmethacrylamide, ethylmethacrylamide, propylmethacrylamide and tert-butylmethacrylamide; examples of allyl compounds include allyl acetate, allyl caproate, allyl laurate and allyl benzoate; examples of vinyl ethers include methyl vinyl ether, butyl vinyl ether, hexyl vinyl ether, methoxyethyl vinyl ether and dimethylaminoethyl vinyl ether; examples of vinyl ketones include methyl vinyl ketone, phenyl vinyl ketone and methoxyethyl vinyl ketone; examples of vinylheterocyclic compounds include vinylpyridine, N-vinylimidazole, N-vinyloxazolidone, N-vinyltriazole and N-vinylpyrrolidone; examples of unsaturated nitriles include acrylonitrile and methacrylonitrile; and examples of multifunctional monomers include divinylbenzene, methylenebisacrylamide and ethylene glycol dimethacrylate.

Examples of other monomeric compounds include acrylic acid, methacrylic acid, itaconic acid, maleic acid, monoalkyl itaconates (e.g., monoethyl itaconate); monoalkyl maleates (e.g., monomethyl maleate); styrenesulfonic acid, vinylbenzylsullfonic acid, acryloyloxyalkylsulfonic acids (e.g., acryloyloxymethylsulfonic acid); methacryloyloxyalkylsulfonic acids (e.g., methacryoyloxyethylsulfonic acid); acrylamidoalkylsulfonic acids (e.g., 2-acrylamido-2-methylethanesulfonic acid); methacrylamidoalkylsulfonic acids (e.g., 2-methacrylamido-2-methylethanesullfonic acid); and acryloyloxyalkylphosphates (e.g., acryloyloxyethylphosphate). These acids may be used in the form of alkali metal (e.g., Na, K) or ammonium salts. As still other monomeric compounds, the cross-linkable monomers disclosed in U.S. Pat. Nos. 3,459,790, 3,438,708, 3,554,987, 4,215,195 and 4,247,673, and JP-A-57-205735 can be used favorably. Examples of such cross-linkable monomers include N-(2-acetoacetoxyethyl)acrylamide and N-(2-(2-acetoacetoxyethoxy)ethyl)acrylamide.

These monomeric compounds each may be polymerized individually, and particles of the thus formed homopolymer may be used. Alternatively, two or more of those monomeric compounds may be polymerized in combination, and particles of the thus formed copolymer may be used. Of those monomeric compounds, acrylic acid esters, methacrylic acid esters, vinyl esters, styrenes and olefins are used to advantage. In addition, particles having fluorine or silicon atoms as disclosed in JP-A-62-14647, JP-A-62-17744 and JP-A-62-17743 may be used.

Examples of a composition of particles used favorably include polystyrene, polymethyl (meth)acrylate, polyethyl acrylate, methyl methacrylate-methacrylic acid (95/5 by mole) copolymer, styrene-styrene sulfonate (95/5 by mole) copolymer, polyacrylonitrile, methyl methacrylate-ethyl acrylate-methacrylic acid (50/40/10 by mole) copolymer, and silica.

Besides the above particles, the particles having reactive (notably gelatin) groups as disclosed in JP-A-64-77052 and European Patent No. 307855 can also be used. Furthermore, it is also possible to introduce alkali-soluble or acid-soluble groups in plenty into particles.

As to the method for incorporating a matting agent into the film, there is no particular restriction. For instance, a method of forming film by casting a solution containing a polymer and a matting agent and a method of applying a matting agent dispersion to the film formed can be adopted. Of these methods, the method of forming film by casting a solution containing a polymer and a matting agent is preferable because of its const advantage. The polymer used herein may be a cyclic olefin resin itself or another polymer.

In the method of forming film by casting a solution containing a polymer and a matting agent, the matting agent may be dispersed at the time of preparation of a polymer solution, or a dispersion of the matting agent may be added to a polymer solution just before casting of the polymer solution. When the matting agent is dispersed into the polymer solution, a small amount of surfactant or polymer may be added as a dispersion aid. Besides adopting the above methods, a method of coating a matting agent layer after film formation may be adopted. In this case, it is preferable to use a binder for forming the matting agent layer. The binder used for the layer containing a matting agent is not limited to particular one, but it may be a lipophilic binder or a hydrophilic binder. As the lipophilic binder, known resins including thermoplastic resins, thermosetting resins, radiation cure resins, reactive resins and mixtures of these resins are usable. Tg values of such resins are preferably from 80° C. to 400° C., far preferably from 120° C. to 350° C. And mass average molecular weights of those resins are preferably from 1×10⁴ to 1.00×10⁶, far preferably from 1×10⁴ to 5.0×10⁵.

Examples of the thermoplastic resins include vinyl copolymers, such as vinyl chloride-vinyl acetate copolymer, copolymer of vinyl chloride, vinyl acetate and vinyl alcohol, maleic acid and/or acrylic acid, vinyl chloride-vinylidene chloride copolymer, vinyl chloride-acrylonitrile copolymer and ethylene-vinyl acetate copolymer; cellulose derivatives, such as nitrocellulose, cellulose acetate propionate and cellulose acetate butyrate resin; cyclic olefin resins; acrylic resins; polyvinyl acetal resin and polyvinyl butyral resin; polyesterpolyurethane resin, polyetherpolyurethane resin and polycarbonatepolyurethane resin; polyester resins; polyether resins; polyamide resins; amino resins; rubber resins, such as styrene-butadiene resin and butadiene-acrylonitrile resin; silicone resins; and fluorocarbon resins.

When a matting agent is incorporated into a cyclic olefin resin film by applying a coat of matting agent, coating methods hitherto known, such as methods of using die coaters (e.g., an extrusion coater, a slide coater, roll coaters (including a forward-rotating roll coater, a backward-rotating roll coater and a gravure coater), a rod coater and a blade coater, can be favorably adopted. In order to cause neither deformation in a substrate supporting such a coating layer nor degradation in coating solution, it is appropriate that the application of a coat of matting agent be performed at temperatures ranging from 10° C. to 100° C., preferably from 20° C. to 80° C. The application speed, though determined appropriately in accordance with the viscosity and application temperature of a coating solution used, is preferably from 10 m/min to 100 m/min, far preferably from 20 m/min to 80 m/min.

The coating layer containing a matting agent can be formed by preparing a solution containing the matting agent dissolved in an appropriate organic solvent, applying a coat of the solution to a cyclic olefin resin film, and then drying the coat. Alternatively, the matting agent can be added in the form of a dispersion to a coating solution. Examples of a solvent suitably used therein include water, alcohol (e.g., methanol, ethanol, isopropanol), ketone (e.g., acetone, methyl ethyl ketone, cyclohexanone), ester (e.g., methyl, ethyl, propyl and butyl esters of acetic acid, formic acid, oxalic acid, maleic acid or succinic acid), aromatic hydrocarbon (e.g., benzene, toluene, xylene) and amide (e.g., dimethylformamide, dimethylacetamide, n-methylpyrrolidone).

In the case of applying the coating solution, it is also possible that the matting agent and a binder having film formability are used together. Examples of a polymer usable as such a binder include hydrophilic binders, such as known thermoplastic resin, thermosetting resin, radiation cure resin, reactive resin, mixtures of two or more of these resins, and gelatin.

In both the method of forming film by casting a solution containing a matting agent and a polymer as recited above and the method of applying a coat of matting agent dispersion to the film formed, the average particle diameter of a particulate matting agent present in and/or on the cyclic olefin resin film formed can be controlled by altering hitherto known conditions for preparing the dispersion, including the average primary particle diameter of particulate matting agent when the matting agent used is a cohesive matting agent, the amount of the particulate matting agent added, the species and amount of a solvent used for the dispersion, the dispersion method adopted, the type and size of a dispersing machine used, the dispersion time, the per-unit-hour energy the dispersing machine gives to the dispersion, the mixing method adopted, the species and amount of a binder used, the order in which additions are performed, and the amount of the dispersion incorporated.

Even in the case of using a non-cohesive matting agent, it is preferable to prevent unexpected aggregation by controlling the dispersion conditions as recited above as in the case of using a cohesive matting agent.

It is appropriate that the matting agent used in the invention be dispersed so as to adjust an average size r (μm)of the fine particles contained in the film to the range of 0.1 to 3.0 μm, preferably 0.15 to 2.0 μm, far preferably 0.2 to 1.0 μm, by use of the aforementioned dispersion formula.

### (Stripping Promoter)

As additives which can lessen stripping resistance of a cyclic olefin resin film, many of highly effective ones can be found in surfactants. Suitable examples of an effective stripping agent include surfactants of phosphoric acid ester type, surfactants of carboxylic acid or carboxylate type, surfactants of sulfonic acid or sulfonate type, and surfactants of sulfuric acid ester type. In addition, fluorine-containing surfactants obtained by substitution of fluorine atoms for part of hydrogen atoms bonded to a hydrocarbon chain in each of the surfactants recited above are also effective.

The amount of a stripping agent added is preferably from 0.05 to 5 mass %, far preferably from 0.1 to 2 mass %, especially preferably from 0.1 to 0.5 mass %, on 100 parts by mass of cyclic olefin resin.

### (Formation of Cyclic Olefin Resin Film)

As methods for film formation, there are known the hot-melt method for film formation and the method of forming film from solution. Both of these methods are applicable to formation of the present cyclic olefin resin film. The method of forming film from solution is described first.

### (Organic Solvent)

Organic solvents for dissolving cyclic olefin resins according to the invention in performing film formation from solution are described below. In the invention, usable organic solvents have no particular restrictions so long as they can dissolve cyclic olefin resins and the resulting solutions can form films by casting, and the films formed can achieve their purposes. Organic solvents used in the invention are preferably chosen from chlorine-containing solvents, such as dichloromethane and chloroform, 3-12C open-chain or cyclic hydrocarbons, 6-12C aromatic hydrocarbons, or 3-12C esters, ketones or ethers. These esters, ketones and ethers may have cyclic structures. Examples of 3-12C open-chain hydrocarbons include hexane, octane, isooctane and decane. Examples of 3-12C cyclic hydrocarbons include cyclopentane, cyclohexane, decaline and derivatives thereof. Examples of 6-12C aromatic hydrocarbons include benzene, toluene and xylene. Examples of 3-12C esters include ethyl formate, propyl formate, pentyl formate, methyl acetate, ethyl acetate and pentyl acetate. Examples of 3-12C ketones include acetone, methyl ethyl ketone, diethyl ketone, diisobutyl ketone, cyclopentanone, cyclohexanone and methylcyclohexanone. Examples of 3-12C ethers include diisopropyl ether, dimethoxymethane, diethoxyethane, 1,4-dioxane, 1,3-dioxolane, tetrahydrofuran, anisole and phenetole. Examples of an organic solvent having two or more kinds of functional groups include 2-ethoxyethyl acetate, 2-methoxyethanol and 2-butoxyethanol. The suitable boiling points of organic solvents used are from 35° C. to 200° C. In the invention, two or more kinds of solvents may be used as a mixture for the purpose of adjusting physical properties of the resulting solution, such as drying characteristics and viscosity, and besides, it is possible to add a poor solvent as far as the resulting solvent mixture can dissolve a cyclic olefin resin.

A poor solvent suitable for use can be chosen as appropriate according to the species of a polymer used. When chlorine-containing organic solvents are used as good solvents, alcohol compounds can be used suitably as poor solvents. Such alcohol compounds may have either straight-chain structures, or branched-chain structures, or cyclic structures, and preferably contain saturated aliphatic hydrocarbons. The hydroxyl group of alcohol may be any of primary, secondary and tertiary. In addition, fluorine-containing alcohol can be used as alcoholic solvent. Examples of such alcohol include 2-fluoroethanol, 2,2,2-trifluoroethanol and 2,2,3,3-tetrafluoro-1-propanol. Of these poor solvents, monohydric alcohol compounds can be used to particular advantage because of their stripping resistance lessening effects. Although particularly favorable alcohol compounds vary according to good solvents chosen, alcohol compounds having boiling points of 120° C. or below are preferred, 1-6C monohydric alcohol compounds are preferred by far, and 1-4C alcohol compounds can be used to particular advantage. The mixed solvent especially preferred in preparation of a cyclic olefin resin solution is a combination of dichloromethane as a main solvent and at least one alcohol compound chosen from methanol, ethanol, propanol, isopropanol or butanol as a poor solvent.

### (Dope Preparation)

As methods usable for preparing a cyclic olefin resin solution (also referred to as a dope) relating to the invention, there are the method in which dissolution is performed by stirring at room temperature, the cold dissolution method in which a polymer is made to swell with stirring at room temperature, cooled down to a temperature of −20° C. to −100° C., and then dissolved by heating to a temperature of 20° C. to 100° C., the high-temperature dissolution method in which dissolution is performed in an airtight vessel at a temperature higher than the boiling point of a major solvent, and the method of performing dissolution under the temperature and pressure raised up to the critical point of a solvent used. The room-temperature dissolution method is preferably applied to polymers with high solubility, while the heating dissolution in an airtight vessel is preferably performed in the case of polymers with poor solubility. On the other hand, when polymers to be dissolved have not-so-poor solubility, dissolving operations can be made easier by choosing the lowest possible temperature for their dissolution.

The viscosity of a cyclic olefin resin solution relating to the invention is preferably from 1 to 500 Pas, far preferably from 5 to 200 Pas, at 25° C. The viscosity measurement is made as follows. A 1 mL of sample solution is prepared, and the viscosity thereof is measured by the use of a rheometer (CLS 500, made by TA Instruments) equipped with a 4-cm-dia/2° steel cone (made by TA Instruments). The sample solution is heated in advance till the temperature thereof reaches a measurement starting temperature and is held constant, and then the measurement is started up.

The cyclic olefin resin solutions are characterized in that dopes are obtained in high concentrations by appropriate selection of solvents to be used, and without resort to concentration it is possible to prepare cyclic olefin resin solutions of high concentrations and excellent stability. In order to enhance ease of dissolution, cyclic olefin resins may be dissolved in low concentrations first, and then the resulting solutions are concentrated according to methods for concentration. Although there is no particular restriction as to method for concentration, the concentration can be performed using, for instance, the method in which a low concentration of solution is introduced into a space between a cylinder and a rotation trajectory of the perimeter of blades mounted in the cylinder and rotating in the peripheral direction of the cylinder, and the solvent thereof is evaporated as a temperature difference is given between the solution and the space, thereby preparing a high concentration of solution (as disclosed, e.g., in JP-A-4-259511), or the method in which a heated solution of a low concentration is blown into a vessel from a nozzle, the solvent therein is flash-evaporated while the solution travels from the nozzle to the inner wall of the vessel and, at the same time, the solvent vapor is purged from the vessel and a high concentration of solution is drawn from the bottom of the vessel (as disclosed, e.g., in U.S. Pat. Nos. 2,541,012, 2,858,229, 4,414,341 or 4,504,355).

Prior to casting, it is preferable that the solution is filtered with an appropriate filter material, such as gauze or flannel to eliminate extraneous matter, including undissolved matter, dirt and impurities. For filtration of cyclic olefin resin solutions, it is advantageous to use a filter with an absolute filtration accuracy of 0.1 to 100 μm, preferably 0.5 to 25 μm. The thickness of a filter used is preferably from 0.1 to 10 mm, far preferably from 0.2 to 2 mm. Herein, it is appropriate that the filtration be performed under a pressure of 1.6 MPa or below, preferably 1.3 MPa or below, far preferably 1.0 MPa or below, particularly preferably 0.6 MPa or below. Suitable examples of a filter material used herein include hitherto known materials, such as glass fiber, cellulose fiber, filter paper, fluorocarbon resins including tetrafluoroethylene resin. In addition to these materials, ceramics and metals can be used to advantage.

Cyclic olefin resin solutions just before film formation may have any viscosity so long as casting can be performed to form films, and they are generally prepared so as to have viscosities in the range of 5 to 1,000 Pas, preferably 15 to 500 Pas, far preferably 30 to 200 Pas. Additionally, the temperature of viscosity measurement has no particular limits, except that it is a temperature at the time of casting, but it is preferably from −5 to 70° C., far preferably from −5 to 35° C.

### (Film Formation From Solution)

Film formation methods using a cyclic olefin resin solution are described below. As a method and apparatus suitable for forming the present cyclic olefin resin film, the same solution-casting film formation method and apparatus as used currently for formation of cellulose triacetate film can be employed. The solution-casting film formation methods preferably used herein are described below, but they should not be construed as being limited to the following.

A dope (a cyclic olefin resin solution) prepared in a dissolving machine (boiler) is once stored in a storage pot in order to eliminate foams in the dope, and thereby the dope preparation is finished. The dope is fed from a dope port into a pressure die through a pressure metering gear pump ensuring a quantitative feed of high accuracy by its number of revolutions, and cast evenly onto a metal support in a casting section which endlessly runs from a mouthpiece (slit) of the pressure die. At the strip-off point where the metal support makes a nearly one circuit, half-dried dope film (referred to as web, too) is stripped off the metal support. The web obtained is dried as it is conveyed with a tenter in a condition that the width of the web is kept by both web edges being pinched with clips, and then the web is conveyed with a group of rolls installed in a drier and thereby the drying thereof is completed. The completely dried web is wound in a desired length with a winder. The combination of a tenter and a group of rolls in a drier varies depending on its intended use. In the solution-casting film formation method applied to functional protective films for electronic displays, coating apparatus for surface processing of film, such as formation of a subbing layer, an antistatic layer, an antihalation layer and a protective film, is added in many cases besides the solution-casting film formation apparatus. Production processes each are briefly described below, but the scope of the invention is not limited to these processes.

In making a cyclic olefin resin film by a solvent cast method, it is preferable that the cyclic olefin resin solution (dope) prepared is initially cast onto an endless metal support, such as a metal drum, or a metal support (band or belt), and then the solvent is made to evaporate, thereby forming a film. As to the dope before casting, it is preferable that the dope concentration is adjusted to the range of 10 to 35 mass % based on the cyclic olefin resin. The surface of the drum or band used preferably has a mirror-smooth finish. And the dope is preferably cast onto a drum or band having a surface temperature of 30° C. or below. As to the metal support temperature, the range of −10° C. to 20° C. is especially suitable.

Moreover, the techniques of cellulose acylate film formation as disclosed in JP-A-2000-301555, JP-A-2000-301558, JP-A-7-032391, JP-A-3-193316, JP-A-5-086212, JP-A-62-037113, JP-A-2-276607, JP-A-55-014201, JP-A-2-111511 and JP-A-2-208650 can be applied to the invention.

For improvements in productivity and surface conditions, it is appropriate in the invention that the speed of film formation by casting be adjusted to 20 m/min or above, preferably 25 n/min or above, especially preferably 30 m/min or above.

### (Co-Casting)

Onto a smooth band or drum as a metal support, a cyclic olefin resin solution may be cast as a single-layer solution, or a plurality of cyclic olefin resin solutions may be cast in a multilayer form.

When a plurality of cyclic olefin resin solutions are cast, film may be formed as the solutions are cast respectively from a plurality of casting ports provided at intervals along the traveling direction of the metal support and stacked on top of each other in layers (co-casting by sequential stacking). To this case, the methods disclosed, e.g., in JP-A-61-158414, JP-A-1-122419 and JP-A-11-198285 are applicable.

In addition, cyclic olefin resin solutions may be formed into a film by casting from two casting ports (co-casting by simultaneous stacking).

Another casting method may be adopted in which a flow of high-viscosity cyclic olefin resin solution is wrapped up in a low-viscosity cyclic olefin resin solution, and both the high- and low-viscosity cyclic olefin resin solutions are extruded at the same time. In such a method, it is a preferred aspect that the content of alcohol as a poor solvent in the outer solution is made higher than that in the inner solution. Alternatively, film making may be performed by using two casting ports, forming a film on a metal support by the use of a solution from the first casting port and stripping the film off the support, and carrying out the second casting on the metal support-contact side of the film.

Cyclic olefin resin solutions for casting use may be the same or different from one another, and there is no particular restrictions thereon. For imparting functions to a plurality of cyclic olefin resin layers, it is adequate to extrude cyclic olefin resin solutions appropriate to the functions from their respective casting ports. Additionally, cyclic olefin resin solutions can be cast simultaneously with solutions for other functional layers (e.g., an adhesive layer, a dye layer, an antistatic layer, an antihalation layer, a matting agent layer, a UV absorbing layer, a polarization layer).

In the case of co-casting, the inner thickness and the outer thickness have no particular limitations, but it is appropriate that the outer thickness constitute 1 to 50%, preferably 2 to 30%, of the total film thickness. When three or more layers are co-cast, the term “outer thickness” as used herein is defined as the sum total of the thickness of the layer having been in contact with a metal support and the thickness of the layer having been in contact with the air. In the co-casting, cyclic olefin resin solutions having concentrations different in each additive, such as a plasticizer, a ultraviolet absorbent or a matting agent, can also be co-cast, thereby forming a cyclic olefin resin film having a multilayer structure. For instance, it is possible to make a cyclic olefin resin film having a skin layer/core layer/skin layer structure. Herein, a matting agent, for example, can be added in a greater amount to the skin layers, or added only to the skin layers. On the other hand, a plasticizer and an ultraviolet absorbent can be added in greater amounts to the core layer than to the skin layers, or they may be added only to the core layer. Furthermore, the plasticizers added to the core layer and the skin layer may be different in type, and the ultraviolet absorbents added thereto may also be different in type. For instance, it is also possible to incorporate a low-volatility deterioration inhibitor and/or a ultraviolet absorbent into the skin layers, and add a highly plastic plasticizer or a highly efficient ultraviolet absorbent to the core layer. In addition, it is a preferred aspect that a stripping accelerator is incorporated into only the skin layer on the metal support side. For gelling the solution by cooling the metal support in a cooled drum method, it is also favorable that alcohol as a poor solvent is added in a greater amount to the skin layer. The skin layer and the core layer may have different Tg values, and it is preferable that the Tg of the core layer is lower than that of the skin layer. In addition, the viscosity of a cyclic olefin resin-containing solution at casting-time may differ between the skin layer and the core layer, and it is preferable that the viscosity of the skin layer is lower than that of the core layer. However, it is also acceptable that the viscosity of the core layer is lower than that of the skin layer.

To formation of a cyclic olefin resin film by stratified casting, both the method of co-casting by simultaneous stacking and the method of co-casting by sequential stacking may be applied. In general, however, the cyclic olefin resin film formation in accordance with the method of co-casting by simultaneous stacking is preferred by far in points of easy retention of planarity, simplicity of process and high productivity.

### (Casting)

Examples of a solution casting method include the method of extruding a prepared dope evenly onto a metal support from a pressure die, the method of using a doctor blade in which the thickness of a dope once cast onto a metal support is adjusted with the blade, and a method of using a reverse roll coater in which thickness adjustment is made with a roll rotating reversely. Of these methods, the method of using a pressure die is preferable. As the pressure die, there are a coat hanger type and a T-die type, and both types can be used favorably. Besides the methods cited above, various other known methods for film formation by casting cellulose triacetate solutions can be carried out, and the same effects as described in their corresponding documents can be achieved by setting conditions with consideration given to differences in, e.g., boiling points of solvents used. As an endlessly-traveling metal support used in making the present cyclic olefin resin film, a drum whose surface is mirror-finished by chromium plating or a stainless belt (which may be referred to as “band”) whose surface is mirror-finished by surface polishing can be used to advantage. As to the pressure die used in making the present cyclic olefin resin film, only one or more than one pressure die may be placed above the metal support. The suitable number of pressure dies placed is one or two. When two or more pressure dies are placed, the dope may be allocated in different proportions to the respective dies, and fed to the pressure dies from a plurality of high-precision metering gear pumps in their respective proportions. The temperature of cyclic olefin resin solutions used for casting is preferably from −10° C. to 55° C., far preferably from 25° C. to 50° C. Herein, the temperature may be the same throughout the process, or different from one point to another in the process. In the case of differing in temperature, it is adequate for the purpose that the dope just before casting has the desired temperature.

### (Drying)

Examples of a general method for drying a dope on a metal support in making a cyclic olefin resin film include a method of giving a hot air to the front side of the metal support (a drum or a belt), namely exposing the surface of web on a metal support to a hot air; a method of giving a hot air to the back of a drum or a belt; and a liquid heat transfer method in which a temperature-controlled liquid is brought into contact with the back of a belt or a drum, which is the side opposite to the dope-cast side of the drum or the belt, and heats the drum or the belt through heat transfer and thereby controls the surface temperature. Of these methods, the back liquid heat transfer method is preferred. The metal support surface temperature before casting may be set at any value as far as it is below the boiling points of all solvents used for the dope. However, for the purposes of accelerating the drying and making the dope lose its flowability on the metal support, the surface temperature is preferably adjusted to a temperature lower by 1 to 10 degrees than the lowest of boiling points of all solvents used. Incidentally, the case of cooling a cast dope and stripping it off without drying is free from such a restriction.

### (Stripping)

When a half-dry film is stripped off a metal support, it sometimes occurs as long as the film has great stripping resistance (stripping load) that the film is irregularly drawn in the direction of film formation and develops optically anisotropic unevenness. In the case of an especially great stripping load, alternating drawn and undrawn areas appear in tiers in the direction of film formation to result in uneven distribution of retardation. When such a film is loaded in a liquid crystal display device, unevenness develops in the form of striations or bands. For prevention of such a problem, it is appropriate that the stripping load be controlled to 0.25N or below per cm of film stripping width. For lessening the stripping load, the method of adding a stripping agent or the method of making the selection of an appropriate solvent composition can be adopted.

The residual volatile component concentration preferred at the time of stripping is from 5 to 60 mass %, and the preferred by far is from 10 to 50 mass %, especially from 20 to 40 mass %. The stripping carried out in a condition of high volatile component content is advantageous because a saving of drying speed can be made to result in increased productivity. In the case of a high volatile component content, however, the film formed has low strength and elasticity, so it yields to the stripping force and comes to be broken or stretched. In addition, the film after stripping is poor in self-holding power, so it tends to become deformed, wrinkled and cracked. Moreover, the high volatile component content becomes a cause of bringing about uneven distribution in retardation.

### (Stretching Treatment)

In the invention, it is preferable that the cyclic olefin resin film undergoes stretching treatment immediately after stripping in a state of still containing residual solvents in sufficient quantity. The stretching is generally carried out for the purposes of (1) obtaining wrinkle-free and deformation-free film having excellent planarity and uniform in-plane retardation, and (2) increasing the in-plane retardation of film.

When stretching is carried out in film making according to the invention, the suitable residual volatile component concentration in the half-dry film at the start of stretching is from 15 to 60 mass %, preferably from 20 to 50 mass %, especially preferably from 25 to 40 mass %. The elongation by stretching is preferably from 0.5 to 300%, far preferably from 1 to 200%, further preferably from 1 to 100%. However, in the case of the cyclic olefin resin film, its potential for developing optical anisotropy by stretching is high, so the practical elongation by stretching is preferably from 1 to 30%, far preferably from 3 to 25%, especially preferably from 5 to 20%. The residual solvent quantity of 15 mass % or above is favorable in the sense that not only a possibility for giving uniform stretch to film's in-plane direction becomes high because the film formed is not rigid but flexible, but also dispersion of in-plane retardation distribution is reduced because relaxation in alignment of cyclic olefin molecules proceeds in the film formed. On the other hand, the residual solvent quantity of 60 mass % or below is favorable in the sense that the film formed has high strength and elasticity, so it resists unintentional break and stretch and the distribution of its in-plane retardation is hard to disperse. Tinder these conditions, the film formed has sufficient self-holding power and resists being deformed, wrinkled and cracked, so it has an advantage of usefulness as optical film.

The stretching of film may be uniaxial stretching in only a vertical or lateral direction with respect to the transport direction of film, or it may be simultaneous or sequential biaxial stretching. However, in points of developability and uniform control of optical characteristics, simultaneous or sequential biaxial stretching is preferable. As to the birefringence of retardation film for use in a VA-mode liquid crystal cell and a OCB-mode liquid crystal cell, the refractive index in the width direction is preferably greater than the refractive index in the length direction. Therefore, it is preferable that the film formed is stretched to a greater extent in the width (lateral) direction.

When stretching is carried out in making the cyclic olefin resin film according to the invention, it is preferable that the film after stretching is brought into a relaxed state and thereby the stretched film is made to shrink.

In the relaxation step, it is preferable that the thermoplastic resin film stretched, e.g., in the lateral direction is made to shrink by being held at a specified temperature for a specified time. The relaxation rate is preferably within 20%, far preferably within 15%, especially preferably within 10%. When the relaxation rate is too high, the film in transport sags, and thereby the running quality deteriorates to result in not only aggravation of handling but also a wide range of optical characteristic variation attributed to variability of transport tension. When the holding temperature is too low, molecular orientation in the stretching step is frozen and it becomes difficult to make the retardation value uniform. Therefore, it is advantageous for the film to be held at a temperature of 100° C. or above, preferably 120° C. or above. And the holding time is preferably from 10 to 300 seconds, far preferably from 30 to 180 seconds. When the holding time is too short, stress relaxation effect is too small to make the retardation value uniform; while, when the holding time is too long, retardation value variation in the film's thickness direction is increased.

### (Afterdrying)

The cyclic olefin resin film after stretching is further dried till the content of residual volatile component is reduced to 2% or below, and then wound into a roll. Before winding of the film, it is preferable to give knurling to both sides of the film. The knurling width is from 3 to 50 mm, preferably from 5 to 30 mm, and the height is from 1 to 50 μm, preferably from 2 to 20 μm, far preferably from 3 to 10 μm. The knurling may be given by one-way or both-way embossing.

The thickness of the finish (after-dry) cyclic olefin resin film according to the invention, though depends on the end use purpose, is generally in a range of 20 to 500 μm, preferably in a range of 30 to 150 μm. When it is used for liquid crystal display devices in particular, the film preferably has a thickness of 40 to 110 μm.

The film thickness can be adjusted to the desired value by controlling the solids concentration in a dope, the slit space in a die cap, the extrusion pressure from a die and the speed of a metal support. The width of the thus made cyclic olefin resin film is preferably from 0.5 to 3 m, far preferably from 0.6 to 2.5 m, further preferably from 0.8 to 2.2 m. The length of the film wound into a roll is preferably from 100 to 10,000 m, far preferably from 500 to 7,000 m, further preferably from 1,000 to 6,000 m. On the occasion of the winding of the film, it is preferable that knurling is given to at least one edge of the film, and the knurling width is preferably from 3 to 50 mm, far preferably from 5 to 30 mm, and the knurling height is preferably from 0.5 to 500 μm, far preferably from 1 to 200 μm. The knurling may be performed by one-way or both-way embossing. The variation in Re values throughout the film's width is preferably ±5 nm, far preferably ±3 nm and the variation in Rth values is preferably ±10 nm, far preferably ±5 nm. Moreover, both the variation in Re values and the variation in Rth values in the length direction are preferably within the variation ranges in the width direction, respectively.

### (Thickness of Cyclic Olefin Resin Film)

The thickness of the finish (after-dry) cyclic olefin resin film according to the invention, though depends on the end use purpose, is generally in a range of 5 to 500 μm, preferably in a range of 30 to 150 μm. When the film is used for liquid crystal display devices in particular, the thickness thereof is preferably from 40 to 110 μm.

The film thickness is adjusted to be the desired value and to have a thickness distribution suiting the invention by controlling the solids concentration in a dope, the slit space in a die cap, the extrusion pressure from a die and the speed of a metal support. The width of the thus made cyclic olefin resin film is preferably from 0.5 to 3 m, far preferably from 0.6 to 2.5 m, further preferably from 0.8 to 2.2 m. The length of the film wound into a roll is preferably from 100 to 10,000 m, far preferably from 500 to 7,000 m, further preferably from 1,000 to 6,000 m. The variation in Re values throughout the film's width is preferably ±5 nm, far preferably ±3 nm and the variation in Rth values is preferably ±10 nm, far preferably ±5 nm. Moreover, both the variation in Re values and the variation in Rth values in the length direction are preferably within the variation ranges in the width direction, respectively.

### (Optical Characteristics of Cyclic Olefin Resin Film)

Optical characteristics suitable for the present cyclic olefin resin film vary with uses to which the film is put. When the present film is used as a polarizing plate protective film, the in-plane retardation (Re) thereof is preferably 5 nm or below, far preferably 3 nm or below. The retardation in the thickness direction (Rth) of the present film is preferably 50 nm or below, far preferably 35 nm or below, especially preferably 10 nm or below.

When the present cyclic olefin resin film is used as an optically-compensatory film (retardation film), the ranges of Re and Rth vary with types of retardation films. Although there are a wide variety of needs for those values, it is appropriate that Re be from 0 to 100 nm and Rth be from 40 nm to 400 nm. For TN-mode use, Re is preferably from 0 to 20 nm and Rth is preferably from 40 nm to 80 nm. For VA-mode use, Re is preferably from 20 nm to 80 nm and Rth is preferably from 80 nm to 400 nm. The especially favorable Re and Rth in VA-mode are in the ranges of 30 nm to 75 nm and 120 nm to 250 nm, respectively. More favorable aspects the film can take on the points of color shift and viewing angle dependence of contrast at the time of black display are that Re is from 50 nm to 75 nm and Rth is from 180 nm to 250 nm when compensation in a VA-mode is made by one retardation film, while Re is from 30 nm to 50 nm and Rth is from 80 nm to 140 nm when compensation is made by two retardation films.

### (Retardations Re and Rth of Cyclic Olefin Resin Film)

The present cyclic olefin resin film can acquire desired optical characteristics via appropriate controls of the polymer structure used, the species and amounts of additives used and process conditions, such as stretch ratio and a content of residual volatile component at the time of stripping. For instance, it is also possible to adjust the retardation in the thickness direction (Rth) to a wide range of 180 to 300 nm by controlling the content of residual volatile component at the time of stripping within the range of 40 to 85 mass %. In general, the more residual volatile component at the time of stripping, the smaller Rth becomes; while the less residual volatile component at the time of stripping, the greater Rth becomes. For instance, Rth can be lowered with ease through relaxation of plane orientation by shortening a drying time on a metal support and increasing the content of residual volatile component at the time of stripping, and it is possible to develop various magnitudes of retardations appropriate to a wide variety of uses by control of process conditions.

### (Polarizing Plate)

A polarizing plate according to the invention is described below.

A feature of the present polarizing plate is that, in a polarizing plate including a polarizer and two protective films disposed on both sides of the polarizer, at least one of the two protective films is the cyclic olefin resin film of the invention. In general, a polarizing plate has a polarizer and two transparent protective films disposed on both sides of the polarizer. As both or one of the protective films, the present cyclic olefin resin film is used. The other protective film may be an ordinarily used cellulose acetate film. Examples of the polarizer include an iodine polarizer, a dye polarizer using a dichroic dye, and a polyene polarizer. The iodine polarizer and the dye polarizer are generally produced using polyvinyl alcohol films. When the present cyclic olefin resin film is used as a protective film of the polarizing plate, the film is subjected to surface treatment as described hereinafter, and then the treated surface of the film and a polarizer are bounded together with the aid of an adhesive. Examples of the adhesive used therein include adhesives of polyvinyl alcohol type, such as polyvinyl alcohol or polyvinyl butyral adhesive, and vinyl latex, such as butyl acrylate, and gelatin. The polarizing plate is comprised of a polarizer and protective films for protection of the both sides of the polarizer, and further has a protect film on one side and a separate film on the other side in a laminated state. The protect film and the separate film are used for the purpose of protecting the polarizing plate at shipment time and production inspection time. Herein, the protect film is laminated for protecting the surface of the polarizing plate, so it is arranged opposite to the side on which the polarizing plate is bonded to a liquid crystal plate. On the other hand, the separate film is used for covering an adhesive layer to which a liquid crystal plate is to be bonded, so it is used on the side where the polarizing plate is bonded to the liquid crystal plate.

As the way of bonding the present cyclic olefin resin film to a polarizer, it is suitable to bond them together so that the slow axis of the present cyclic olefin resin film accords with the transmission axis of the polarizer. In evaluating the thus made polarizing plate under the condition of a crossed Nicol arrangement, it has been found that the polarizing plate in a crossed Nicol arrangement deteriorated in polarization degree performance and caused light leaks when the accuracy with which the slow axis of the present cyclic olefin resin film and the absorption axis (the axis orthogonal to the transmission axis) of the polarizer crossed each other at right angles was 1° or above. Under such a condition, the combination of the polarizing plate and a liquid crystal cell cannot deliver a satisfactory black level and contrast. Therefore, it is appropriate that the disparity between orientations of a primary refractive index nx in the present cyclic olefin resin film and the transmission axis of the polarizing plate be within 1°, preferably within 0.5°.

For measurements of single-plate transmittance TT, parallel transmittance PT and cross transmittance CT, a spectrophotometer, such as UV3100PC (made by Shimadzu Corporation), can be used. These measurements are made in the range of 380 nm to 780 nm, and each of single-plate, parallel and cross transmittance values can be determined as the average of 10 measurement values.

### (Surface Treatment of Cyclic Olefin Resin Film)

For improvement in adhesion of a protective film to a polarizer, it is appropriate in the invention that the cyclic olefin resin film for protective film use be subjected to surface treatment. For the surface treatment, any method may be utilized as far as it can produce improvement in adhesion. Examples of a suitable method for surface treatment include glow discharge treatment, UV irradiation treatment, corona treatment and flame treatment. The term “glow discharge treatment” as used herein refers to the low-temperature plasma occurring under the condition of low-pressure gas. In the invention, plasma treatment under atmospheric pressure is also used to advantage. Detailed descriptions of glow discharge treatment can be found in U.S. Pat. Nos. 3,462,335, 3,761,299 and 4,072,769, and G.B. Patent No. 891469. In addition, the method disclosed in JP-T-59-556430 can be adopted wherein the gas composition of discharge atmosphere is only gas species evolved from a polyester support into a container by the discharge treatment the support itself receives after the start of discharge. Furthermore, the method disclosed in JP-B-60-16614 is also applicable wherein vacuum glow discharge treatment is carried out under conditions that the film surface temperature is adjusted to the range of 80° C. to 180° C.

The degree of vacuum during the glow discharge treatment is preferably from 0.5 to 3,000 Pa, far preferably from 2 to 300 Pa. And the suitable voltage is in the range of 500 to 5,000 V, preferably 500 to 3,000 V. The discharge frequency used is from direct current to several thousand MHz, preferably from 50 Hz to 20 MHz, far preferably from 1 KHz to 1 MHz. The suitable discharge treatment intensity is from 0.01 KV A min/m² to 5 KV A min/m², preferably from 0.15 KV A min/m² to 1 KV A min/m².

The use of a UV irradiation method is also suitable for surface treatment in the invention. For example, the surface treatment can be performed using the treatment methods disclosed in JP-B-43-2603, JP-B-43-2604 arid JP-B-45-3828. The mercury-vapor lamp suitably used in the surface treatment is a high-pressure mercury-vapor lamp made of a silica tube and emitting UV rays with wavelengths ranging from 180 nm to 380 nm. When a rise in surface temperature of the protective film to the neighborhood of 150° C. causes no problem in point of substrate performance, it is possible to use as a light source a high-pressure mercury-vapor lamp having a dominant wavelength of 365 nm. When low-temperature treatment is required, on the other hand, a low-pressure mercury-vapor lamp having a dominant wavelength of 254 nm is used to advantage. In addition, it is also possible to use an ozone-less high-pressure or low-pressure mercury-vapor lamp. The larger the light quantity for treatment, the more the adhesion of the thermoplastic saturated alicyclic structure-containing polymer resin film to a polarizer is improved. With increase in light quantity, however, there arise problems that the irradiated film is colored and becomes brittle. Accordingly, the suitable quantity of irradiation light is from 20 to 10,000 mJ/cm², preferably from 50 to 2,000 mJ/cm². In the case of a low-pressure mercury-vapor lamp having a dominant wavelength of 254 nm, the suitable quantity of irradiation light is from 100 to 10,000 mJ/cm², preferably from 300 to 1,500 mJ/cm².

It is also preferable that corona discharge treatment is carried out as the surface treatment in the invention. The corona discharge treatment can be performed according to the treatment methods disclosed, e.g., in JP-B-39-12838, JP-A-47-19824, JP-A-48-28067 and JP-A-52-42114. Examples of a corona discharge treatment device usable herein include a Pillar-made solid state corona treatment device, a LEPEL-type surface treatment machine and a VETAPHON-type treatment machine. The treatment can be carried out at ordinary pressure in the air. The discharge frequency during the treatment is from 5 to 40 KV, preferably from 10 to 30 KV, and the wave form is preferably a form of alternating-current sine wave. The gap clearance between an electrode and a dielectric roll is from 0.1 to 10 mm, preferably from 1.0 to 2.0 mm. The discharge treatment is performed at a location above the dielectric support roller placed in the discharge zone, and the treatment quantity is from 0.3 to 0.4 KV A min/m², preferably from 0.34 to 0.38 KV A min/m².

It is also preferable that flame treatment is carried out as the surface treatment in the invention. Although the gas used may be any of a natural gas, a liquefied propane gas and a city gas, the mixing proportion between such a gas and air is important. This is because the effect of surface treatment with flame is thought to be produced by an active oxygen-containing plasma, and the point is in how high the plasma activity (temperature) as an important property of flame and the oxygen content are. The dominant factor of this point is a gas/oxygen ratio and, when reaction occurs between right amounts of gas and oxygen, the energy density becomes the highest and the plasma activity is enhanced. The suitable natural gas/air mixing ratio is from 1/6 to 1/10 by volume, preferably from 1/7 to 1/9 by volume. In the case of mixing liquefied propane gas with air, the suitable mixing ratio is from 1/14 to 1/22 by volume, preferably from 1/16 to 1/19. In the case of mixing a city gas with air, the suitable mixing ratio is from 1/2 to 1/8 by volume, preferably from 1/3 to 1/7 by volume. And the suitable quantity of flame treatment is from 1 to 50 Kcal/m², preferably from 3 to 20 Kcal/m². Furthermore, it is appropriate that the distance between the tip of inner flame of a burner and the film be adjusted to the range of 3 to 7 cm, preferably 4 to 6 cm. As to a nozzle shape of the burner, a ribbon-type nozzle of Flynn Burner Corporation (U.S.A.), a multi-orifice nozzle of Weiss (U.S.A.), a ribbon-type nozzle of Aerogen (U.K.), a staggered multi-orifice nozzle of Kasuga Denki Co., Ltd (Japan), or a staggered multi-orifice nozzle of Koike Sanso Kogyo Co., Ltd. (Japan) is used to advantage. A backup roll that supports film in the flame treatment is a hollow roll, and it is appropriate that the treatment be performed at a temperature kept invariably in the range of 20 to 50° C. as cooling water is passed through the hollow.

The suitable ranges of degrees to which surface treatment is given vary among surface treatment types and species of cyclic olefin resins, but it is appropriate that the surface treatment be performed until the treated surface of protective film comes to have a pure-water contact angle of less than 50 degrees, preferably at least 25 degrees and less than 45 degrees. When the pure-water contact angle of the protective film surface is in the foregoing range, satisfactory bond strength can be attained between the protective film and a polarization film.

### (Adhesive)

When a polarizer made with polyvinyl alcohol and the surface-treated cyclic olefin resin film as a protective film are bonded together, an adhesive containing a water-soluble polymer is preferably used.

Examples of a water-soluble polymer suitably used in such an adhesive include homo- or copolymers having as their structural units ethylenic unsaturated monomers, such as N-vinylpyrrolidone, acrylic acid, methacrylic acid, maleic acid, β-hydroxyethyl acrylate, β-hydroxyethyl methacrylate, vinyl alcohol, methyl vinyl ether, vinyl acetate, acrylamide, methacrylamide, diacetoneacrylamide and vinylimidazole, and further include polyoxyethylene, polyoxypropylene, poly-2-methyloxazoline, methyl cellulose, hydroxyethyl cellulose, hydroxypropyl cellulose and gelatin. Of these polymers, PVA and gelatin are preferred over the others.

When PVA is used as the adhesive in the invention, it is preferable that a cross-linking agent is further used in combination. Examples of a cross-linking agent used in combination with a PVA adhesive include boric acid, polyvalent aldehyde, multifunctional isocyanate compounds and multifunctional epoxy compounds. Of these compounds, boric acid is used to particular advantage in the invention.

When such a cross-linking agent is used in combination with a water-soluble polymer, the suitable addition amount thereof is from at least 0.1 mass % to smaller than 40 mass %, preferably at least 0.5 mass % to smaller than 30 mass %, based on the water-soluble polymer in the adhesive. And it is preferable that the adhesive is applied to at least either the protective film surface or the polarizer surface to form an adhesive layer, thereby bonding the protective film and the polarizer via the adhesive layer.

### (Antireflective Layer)

It is preferable that the transparent protective film of a polarizing plate, which is disposed on the side opposite to a liquid crystal cell, is provided with a functional film, such as an antireflective layer. In the invention, it is especially advantageous to provide an antireflective layer having at least a light scattering layer and a low refractive index layer or an antireflective layer having a medium refractive index layer, high refractive index layer and a low refractive index layer on the transparent protective film in a state that those constituent layers are laminated on the film in the order mentioned.

As to the light-scattering layer, it is preferable that matting particles are dispersed therein. The light-scattering layer may combine an antiglare property with a hard coating property, and may be composed of a plurality of layers, e.g., 2 to 4 layers.

Where optical characteristics are concerned, it is appropriate that the antireflective layer be adjusted to have a specular reflectivity of 2.5% or below, a transmittance of 90% or above and a 60° glossiness of 70% or below. By these adjustments, the antireflective layer can reduce reflection of outside light and improve viewability. The specular reflectivity in particular is adjusted to preferably 1% or below, especially preferably 0.5% or below. For achievement of prevention of glare and reduction of blurring of characters on a high-definition LCD panel, it is advantageous for the antireflective layer to have optical characteristics that the haze is from 20% to 50%, the internal haze/total haze ratio is from 0.3 to 1, the decrease in haze value from a state of coming to have a light-scattering layer to a state after formation of a low refractive index layer is within 15%, the definition of transmission images at a comb width of 0.5 mm is from 20% to 50%, and the transmittance ratio of vertically transmitted light to light transmitted in a direction with a 2-degree slant from the vertical direction is from 1.5 to 5.0.

In the low refractive index layer, it is preferable that a fluorine-containing polymer is contained as binder with a low refractive index. The fluorine-containing polymer suitable as such a binder is a fluorine-containing polymer that has a kinetic friction coefficient of 0.03 to 0.20, a water contact angle of 90 to 120 degrees and a pure water slip-down angle of 70 degrees or below and can be cross-linked when heated or irradiated with ionizing radiation. When the antireflective film is loaded in an image display device and thereto labels and memos are stuck, the peel of the stuck labels and memos becomes conveniently easier the lower resistance the low refractive index layer offers to peeling of commercial adhesive tape. The peel resistance herein is preferably 500 gf or below, far preferably 300 gf or below, especially preferably 100 gf or below. Furthermore, the higher the surface hardness measured by a microhardness tester, the more the low refractive index layer resists scratches. Specifically, the surface hardness is preferably 0.3 GPa or above, far preferably 0.5 GPa or above.

### (Layers Other Than Antireflective Layer)

A hard coating layer, a forward-scattering layer, a primer layer, an antistatic layer, a subbing layer and a protective layer may further be provided.

### (Liquid Crystal Display Device)

Then, liquid crystal display devices according to the invention are described.

Each of liquid crystal display devices according to the invention is characterized by having either at least one of the present cyclic olefin resins films, or at least one of polarizing plates according to the invention, or both.

The present cyclic olefin resin films, retardation films including these resin films and polarizing plates utilizing these resin films can be used in diverse display modes of liquid crystal cells or liquid crystal display devices. The wide variety of display modes proposed hitherto are TN (Twisted Nematic), IPS (In-Plane Switching), ECB (Electrically Controlled Birefringence), FLC (Ferroelectric Liquid Crystal), AFLC (Anti-ferroelectric Liquid Crystal), OCB (Optically Compensatory Bend), STN (Supper Twisted Nematic), VA (Vertically Aligned) and HAN (Hybrid Aligned Nematic) modes. Of these modes, IPS mode, OCB mode and VA mode are used to greater advantage.

In an IPS-mode liquid crystal cell, rod-shape liquid crystalline molecules are aligned substantially parallel to a substrate. These liquid crystalline molecules give planar responses to the application of an electric field parallel to the substrate surface. When no electric field is applied, the IPS-mode becomes a state of black display, the transmission axes of a pair of vertically stacked polarizing plates are at right angles to each other. The methods of using optically compensatory films for reducing light leaks in slanting directions at the time of black display to result in viewing-angle improvement are disclosed in JP-A-10-54982, JP-A-11-202323, JP-A-9-292522, JP-A-11-133408, JP-A-11-305217 and JP-A-10-307291.

OCB-mode liquid crystal cells used in liquid crystal display devices are liquid crystal cells of a bend alignment mode in which rod-shape liquid crystalline molecules in the upper part of each liquid crystal cell and those in the lower part are forced to align (symmetrically) in substantially opposite directions, and they are disclosed in U.S. Pat. Nos. 4,583,825 and 5,410,422. Since the rod-shape liquid crystal molecules are symmetrically aligned in an upper part and a lower part of the liquid crystal cell, the liquid crystal cell in a bend alignment mode has an optically self-compensation function. Therefore, this liquid crystal mode is referred to as an OCB (Optically Compensatory Bend) liquid crystal mode. The liquid crystal display device of the bend alignment mode has an advantage of high response speed.

In a VA-mode liquid crystal cell, rod-shaped liquid crystalline molecules are aligned in a substantially vertical direction when no voltage is applied.

Examples of a VA-mode liquid crystal cell include (1) a strict sense of VA-mode liquid crystal cell in which rod-shaped liquid crystalline molecules are aligned in a substantially vertical direction when no voltage is applied thereto, but they are forced to align in a substantially horizontal direction by application of a voltage thereto (as disclosed in JP-A-2-176625), (2) a multidomain VA-mode (MVA-mode) liquid crystal cell which ensures viewing angle extension (as described in SID 97 Digest of Tech. Papers (preprints) 28, p. 845(1997)), (3) an n-ASM-mode liquid crystal cell in which rod-shaped liquid crystalline molecules are aligned in a substantially vertical direction when no voltage is applied thereto, but they are brought into a twisted multidomain alignment by application of a voltage thereto (as described in preprints of Nippon Ekisho Toronkai (Symposium on Liquid Crystal), pp. 58-59 (1998)), and (4) a SURVAIVAL-mode liquid crystal cell (announced at LCD International 98).

A VA-mode liquid crystal display device includes a liquid crystal cell as recited above and two polarizing plates disposed on both sides of the liquid crystal cell. The liquid crystal cell holds a liquid crystal between two electrode substrates. In one aspect of the transmission liquid crystal display device according to the invention, one sheet of the present cyclic olefin resin film is sandwiched in between the liquid crystal cell and one of the polarizing plates, or two sheets of the present cyclic olefin resin film are disposed individually between the liquid crystal cell and each of the two polarizing plates.

In another aspect of the transmission liquid crystal display device according to the invention, a retardation film including the present cyclic olefin resin film is used in a polarizing plate as a transparent protective film disposed between the liquid crystal cell and the polarizer. The retardation film may be used in one polarizing plate alone as a transparent protective film (disposed between the liquid crystal cell and one polarizer), or as two sheets of transparent protective film included in two polarizing plates, respectively (which are each disposed between the liquid crystal cell and each polarizing plate). When the retardation film is used in one polarizing plate alone, its use as a protective film provided on the liquid crystal cell side of a polarizing plate disposed on the backlight side of the liquid crystal cell is especially suitable. When the retardation film and the liquid crystal cell are bonded together, it is advantageous for the present cyclic olefin resin film to lie on the VA-cell side. Another protective film may be a usual cellulose acylate film. The thickness of such a film is preferably from 40 to 80 μm, and commercially available films include KC4UX2M (thickness: 40 μm, a product of Konica Opto Co., Ltd.), KC5UX (thickness: 60 μm, a product of Konica Opto Co., Ltd.) and TD80 (thickness: 80 μm, a product of Fuji Photo Film Co., Ltd.), but not limited to these products.

In an OCB-mode liquid crystal display device and a TN-mode liquid crystal display device, optical compensatory films are used for the purpose of widening viewing angles. The optically compensatory film used for an OCB cell is formed by providing on an optically uniaxial or biaxial film an optically anisotropic layer in which discotic liquid crystal molecules are brought into hybrid alignment and fixed thereto. The optically compensatory film used for a TN cell is formed by providing on a film having optical isotropy or an optical axis in the thickness direction an optically anisotropic layer in which discotic liquid crystal molecules are brought into hybrid alignment and fixed thereto. The present cyclic olefin resin film is useful as an optically compensatory film for the OCB cell and an optically compensatory film for the TN cell.

### EXAMPLES

The invention will now be illustrated in the concrete on the basis of the following examples, but these examples should not be construed as limiting the scope of the invention in any way.

### Example 1

The following ingredients were charged into a mixing tank, made into a solution by agitation, and then filtered through filter paper with an average pore size of 34 μm and a sintered metal filter with an average pore size of 10 μm, thereby preparing a dope for film formation.

| | |
|---|---|
| Appear 3000 (produced by Ferrania S.p.A.) | 100 parts by mass |
| Dichloromethane | 317 parts by mass |
| Methanol | 27.6 parts by mass |
| Compound D-7 (produced by Tokyo Chemical | 10.0 parts by mass |
| Industry Co., Ltd.) | |

The dope thus prepared was cast into a film with a band casting machine. When the residual solvent content in the film reached to about 30 mass %, the film was stripped away from the band, stretched in the width direction by use of a tenter till it had a stretch factor of 13%, relaxed at 140° C. for 60 seconds so that the stretch factor was reduced to 10%, and then dried. Thereafter, the way of transporting the film was changed to roll transport from the tenter transport, and film drying was further performed at temperatures ranging from 120° C. to 140° C. Thus, a 1440 mm-wide cyclic olefin resin film F-1 was made. The thickness of the film F-1 was found to be 80 μm.

### Example 2

A cyclic olefin resin film F-2 was made in the same manner as in Example 1, except that the composition described below was used as a dope for film formation. The thickness of the thus made film F-2 was found to be 80 μm.

| | |
|---|---|
| Appear 3000 (produced by Ferrania S.p.A.) | 100 parts by mass |
| Dichloromethane | 317 parts by mass |
| Methanol | 27.6 parts by mass |
| Compound E-1 (produced by Tokyo Chemical | 10.0 parts by mass |
| Industry Co., Ltd.) | |

### Example 3

A cyclic olefin resin film F-3 was made in the same manner as in Example 1, except that the composition described below was used as a dope for film formation. The thickness of the thus made film F-3 was found to be 80 μm.

| | |
|---|---|
| Appear 3000 (produced by Ferrania | 100 parts by mass |
| S.p.A.) | |
| Dichloromethane | 317 parts by mass |
| Methanol | 27.6 parts by mass |
| Triphenyl phosphate (TPP) | 10.0 parts by mass |

### Example 4

A cyclic olefin resin film F-4 was made in the same manner as in Example 1, except that the composition described below was used as a dope for film formation. The thickness of the thus made film F-4 was found to be 80 μm.

| | |
|---|---|
| Appear 3000 (produced by Ferrania | 100 parts by mass |
| S.p.A.) | |
| Dichloromethane | 317 parts by mass |
| Methanol | 27.6 parts by mass |
| PL-1 | 10.0 parts by mass |

### Example 5

A cyclic olefin resin film F-5 was made in the same manner as in Example 1, except that the composition described below was used as a dope for film formation. The thickness of the thus made film F-5 was found to be 80 μm.

| | |
|---|---|
| Appear 3000 (produced by Ferrania | 100 parts by mass |
| S.p.A.) | |
| Dichloromethane | 317 parts by mass |
| Methanol | 27.6 parts by mass |
| C-426 | 10.0 parts by mass |

### Comparative Example 1

A cyclic olefin resin film F-11 was made in the same manner as in Example 1, except that the composition described below was used as a dope for film formation. The thickness of the thus made film F-11 was found to be 80 μm.

| | |
|---|---|
| Appear 3000 (produced by Ferrania | 100 parts by mass |
| S.p.A.) | |
| Dichloromethane | 326 parts by mass |
| Methanol | 28.4 parts by mass |

### Comparative Example 2

A cyclic olefin resin film F-12 was made in the same manner as in Comparative Example 1, except that the film was dried by exposure to hot air as it was held by the tenter so as not to be widened in the width direction. The thickness of the thus made film F-12 was found to be 80 μm.

### [Measurements of Re and Rth]

Re and Rth values of each film were measured with an automatic birefringence-measuring instrument (KOBRA 21ADH, made by Oji Scientific Instruments). As the assumed values of average refractive indices, cataloged values were adopted.

### [Evaluation of Variations in Direction of Slow Axis of Film]

Angles which slow-axis directions in each film formed with the stretch direction of the film were determined with an automatic birefringence-measuring instrument (KOBRA 21ADH, made by Oji Scientific Instruments). Slow-axis direction measurements of each cyclic olefin resin film having a width of 1440 mm were taken at 10 points evenly spaced 15 cm apart in the width direction, and the average direction was determined. In addition, the standard deviation of angles which the slow-axis directions measured at the 10 points formed with the average slow-axis direction was calculated. Films satisfying the requirements that a discrepancy between the average slow-axis direction and the stretch direction was within ±2.0° and the standard deviation thereof was 0.8 or below were rated as good, and those failing to satisfy those requirements were rated as bad.

### (Measurement of Elasticity Modulus)

A cyclic olefin resin film sample measuring 10 mm×150 mm was subjected to moisture control for 2 hours under conditions of 25° C. and 60% RH, and then stretched using a tensile tester (Strograph R-2, made by Toyo Seiki Seisaku-sho, Ltd.) at settings that the distance between chucks was 100 mm, the temperature was 25° C. and the stretching speed was 10 mm/min.

TABLE 1

| | | | | | Amount | | | | Variation | |
|---|---|---|---|---|---|---|---|---|---|---|
| | | | Cyclic | | added | | | | in | Elasticity |
| | | Thickness | olefin | | [wt %/weight | Stretch | Rth | Re | slow | modulus |
| | Film | [μm] | resin | Additive | of polymer] | factor | [nm] | [nm] | axis | [Mpa] |
| Example | F-1 | 80 | Appear3000 | D-7 | 10 | 10 | 210 | 51 | good | 2000 |
| | F-2 | 80 | Appear3000 | E-1 | 10 | 10 | 214 | 55 | good | 1960 |
| | F-3 | 80 | Appear3000 | TPP | 10 | 10 | 224 | 57 | good | 2010 |
| | F-4 | 80 | Appear3000 | PL-1 | 10 | 10 | 208 | 50 | good | 2030 |
| | F-5 | 80 | Appear3000 | C-426 | 10 | 10 | 226 | 59 | good | 1920 |
| Comparative | F-11 | 80 | Appear3000 | — | 0 | 10 | 271 | 66 | bad | 1750 |
| Example | F-12 | 80 | Appear3000 | — | 0 | 0 | 271 | 21 | bad | 1710 |

From the results shown in Table 1, it can be seen that, in controlling the optical characteristics, the addition of a compound according to the invention can ensure a higher degree of freedom than traditional stretch operations allow, so optical characteristics appropriate for retardation film used in liquid crystal display devices can be achieved with freedom.

From the results shown in Table 1, it can further be seen that Re and/or Rth can be reduced by addition of a compound according to the invention, so the freedom of stretch factor setting for the intended optical characteristics is enhanced. As a result, the condition under which the film is stretched uniformly in in-plane directions can be chosen for the present cyclic olefin resin film, so the angles which the slow axes of the film obtained forms with the stretch direction and the standard deviation thereof become small. Thus, the present cyclic olefin resin films prove to be suitable as optical films.

Furthermore, the results shown in Table 1 indicate that the elasticity modulus of cyclic olefin resin film is raised by addition of a compound according to the invention.

### Example 6

The following ingredients were charged into a mixing tank, made into a solution by agitation, and then filtered through filter paper with an average pore size of 34 μm and a sintered metal filter with an average pore size of 10 μm, thereby preparing a dope for film formation.

| | |
|---|---|
| Appear 3000 (produced by Ferrania S.p.A.) | 100 parts by mass |
| Dichloromethane | 299 parts by mass |
| Methanol | 26.0 parts by mass |
| Compound D-7 (produced by Tokyo Chemical | 30.0 parts by mass |
| Industry Co., Ltd.) | |

The dope thus prepared was cast into a film with a band casting machine. When the residual solvent content in the film reached to about 25 mass %, the film was stripped away from the band, stretched in the width direction by use of a tenter till it had a stretch factor of 8%, relaxed at 140° C. for 60 seconds so that the stretch factor was reduced to 5%, and then dried. Thereafter, the way of transporting the film was changed to roll transport from the tenter transport, and film drying was further performed at temperatures ranging from 120° C. to 140° C. Thus, a 1440 mm-wide cyclic olefin resin film F-6 was made. The thickness of the film F-6 was found to be 80 μm.

### Comparative Example 3

A cyclic olefin resin film F-13 was made in the same manner as in Example 6, except that the composition described below was used as a dope for film formation. The thickness of the thus made film F-13 was found to be 80 μm.

| | |
|---|---|
| Appear 3000 (produced by Ferrania | 100 parts by mass |
| S.p.A.) | |
| Dichloromethane | 326 parts by mass |
| Methanol | 28.4 parts by mass |

### Example 7

The following ingredients were charged into a mixing tank, made into a solution by agitation, and then filtered through filter paper with an average pore size of 34 μm and a sintered metal filter with an average pore size of 10 μm, thereby preparing a dope for film formation.

| | |
|---|---|
| Appear 3000 (produced by Ferrania S.p.A.) | 100 parts by mass |
| Dichloromethane | 308 parts by mass |
| Methanol | 26.8 parts by mass |
| Compound D-7 (produced by Tokyo Chemical | 20.0 parts by mass |
| Industry Co., Ltd.) | |

The dope thus prepared was cast into a film with a band casting machine. When the residual solvent content in the film reached to about 20 mass %, the film was stripped away from the band, stretched in the width direction by use of a tenter till it had a stretch factor of 16%, relaxed at 140° C. for 60 seconds so that the stretch factor was reduced to 13%, and then dried. Thereafter, the way of transporting the film was changed to roll transport from the tenter transport, and film drying was further performed at temperatures ranging from 120° C. to 140° C. Thus, a 1440 mm-wide cyclic olefin resin film F-7 was made. The thickness of the film F-7 was found to be 45 μm.

### Comparative Example 4

A cyclic olefin resin film F-14 was made in the same manner as in Example 7, except that the composition described below was used as a dope for film formation. The thickness of the thus made film F-14 was found to be 45 μm.

| | |
|---|---|
| Appear 3000 (produced by Ferrania | 100 parts by mass |
| S.p.A.) | |
| Dichloromethane | 326 parts by mass |
| Methanol | 28.4 parts by mass |

TABLE 2

| | | | | | Amount | | | |
|---|---|---|---|---|---|---|---|---|
| | | | | | added | | | |
| | | Film | Cyclic | | [wt %/ | | | |
| | | thickness | olefin | | Polymer | Stretch | Rth | |
| | Film | [μm] | resin | Additive | weight] | factor | [nm] | Re [nm] |
| Example | F-6 | 80 | Appear | D-7 | 30 | 5 | 70 | 20 |
| | | | 3000 | | | | | |
| | F-7 | 45 | Appear | D-7 | 20 | 13 | 36 | 86 |
| | | | 3000 | | | | | |
| Compar. | F-13 | 80 | Appear | — | 0 | 5 | 270 | 31 |
| Example | | | 3000 | | | | | |
| | F-14 | 45 | Appear | — | 0 | 13 | 151 | 46 |
| | | | 3000 | | | | | |

From the results shown in Table 2, it can be seen that optical characteristic control with the greatest freedom we have ever had can be achieved by combining the addition of a compound according to the invention, the control of film thickness and the development of optical characteristics by stretching.

### Example 8

### <Making of Polarizing Plate>

Iodine was adsorbed to a stretched polyvinyl alcohol film to make a polarizer.

The cyclic olefin resin film (F-1) made in Example 1 was subjected to glow discharge treatment (by applying a high-frequency voltage of 4200V, the frequency of which was 3,000 Hz, between electrodes placed vertically for 20 seconds), and then stuck to one side of the polarizer in the manner mentioned below with the aid of an adhesive of polyvinyl alcohol type. In addition, a commercially available cellulose triacylate film (FUJITAC TD80UF, a product of Fuji Photo Film Co., Ltd.) was subjected to saponification treatment, and stuck to the other side of the polarizer by use of an adhesive of polyvinyl alcohol type, and then dried at 70° C. for 10 minutes or more, thereby preparing a polarizing plate A.

Therein, the cyclic olefin resin film (F-1) was disposed so that the slow axis thereof was paralleled by the transmission axis of the polarization film. On the other hand, the commercial cellulose triacylate film was disposed so that the slow axis thereof lay at right angles to the transmission axis of the polarization film.

### <Making of VA-Mode Liquid Crystal Cell>

A liquid crystal cell was made as follows. Two substrates were stacked so that the gap between them was kept at 3.6 μm, and a liquid crystal material having negative permittivity anisotropy (MLC6608, produced by Merck & Co.) was infused in between the substrates and sealed therein to form a liquid crystal layer. The retardation of the liquid crystal layer (the product of the liquid crystal layer's thickness (d μm) and refractive-index anisotropy (Δn), or Δn d) was adjusted to 300 nm. Additionally, the liquid crystal material was oriented so as to have vertical molecular alignment. On the upper side of this liquid crystal cell of vertical alignment type (viewer side), a commercially available superhigh contrast polarizing plate (HLC2-5618, made by Sanritz Corporation) was laminated with the aid of an adhesive. On the lower side of the liquid crystal cell (backlight side), the polarizing plate A prepared in this example was laminated with the aid of an adhesive. Herein, these two polarizing plates were placed in the crossed Nicol arrangement so that the transmission axis of the upper-side polarizing plate was oriented in a vertical direction and that of the lower-side polarizing plate in a lateral direction.

As a result of viewing the liquid crystal display device produced herein, it was ascertained that neutral black-state display was achieved in both frontal direction and viewing-angle direction. In addition, the viewing angles in 8 steps from the black-state display (L1) to the white-state display (L8) (the range in which the contrast ratio is 10 or more and there is no tone reversal in the black side) were measured with an instrument (EZ-Contrast 160D, made by ELDIM), and it was found that the display device had satisfactory viewing angles of 80 degrees or above on both sides.

The invention allows accurate control of Re and Rth each, and can provide a cyclic olefin resin film that has highly uniform optical characteristics in film's in-plane direction and excellent hygroscopicity and moisture permeability, causes slight changes in optical characteristics by variations in temperature and humidity, excels in resistance to pucker/wrinkle occurrence during the making of long-length rolls of film and reduces the occurrence of unintended optical unevenness. In accordance with the invention, optical unevenness occurring specifically in film's plane as the film is stretched can be noticeably improved.

The entire disclosure of each and every foreign patent application from which the benefit of foreign priority has been claimed in the present application is incorporated herein by reference, as if fully set forth.

What is claimed is:

1. A cyclic olefin resin film, which comprises:
a cyclic olefin resin; and
at least one organic compound capable of reducing Rth(λ) in an amount of 0.01 to 30 mass % based on a solid content of the cyclic olefin resin,
wherein Rth(λ) is expressed in nm and represents a value of a retardation in a direction of film thickness at a wavelength of λ nm.

2. A cyclic olefin resin film, which comprises:
a cyclic olefin resin; and
at least one organic compound capable of reducing both Rth(λ) and Re(λ) in an amount of 0.01 to 30 mass % based on a solid content of the cyclic olefin resin,
wherein Rth(λ) is expressed in nm and represents a value of a retardation in a direction of film thickness at a wavelength of λ nm; and
Re(λ) is expressed in nm and represents a value of an in-plane retardation at a wavelength of λ nm.

3. The cyclic olefin resin film according to claim 1, which comprises at least one compound represented by formula (1) as the organic compound capable of reducing Rth(λ) in an amount of 0.01 to 30 mass % based on a solid content of the cyclic olefin resin: 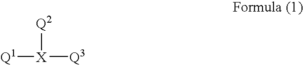
wherein Q¹, Q² and Q³ each independently represents a 5- or 6-membered ring; and
X represents B, C—R, N, P or P═O, in which R represents a hydrogen atom or a substituent.

4. The cyclic olefin resin film according to claim 3,
wherein the compound represented by formula (1) is a compound represented by formula (2): 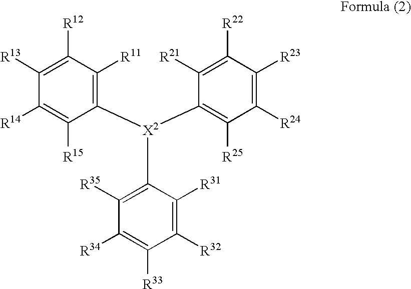
wherein X² represents B, C—R or N, in which R represents a hydrogen atom or a substituent; and
R¹¹, R¹², R¹³, R¹⁴, R¹⁵, R²¹, R²², R²³, R²⁴, R²⁵, R³¹, R³², R³³, R³⁴ and R³⁵ each independently represents a hydrogen atom or a substituent, and one group selected from the group consisting of R¹¹, R¹², R¹³, R¹⁴ and R¹⁵ and one group selected from the group consisting of R²¹, R²², R²³, R²⁴ and R²⁵ may be bound together via a single bond or a divalent linkage group.

5. The cyclic olefin resin film according to claim 1, which comprises at least one compound represented by formula (3) in an amount of 0.01 to 20 mass % based on a solid content of the cyclic olefin resin: 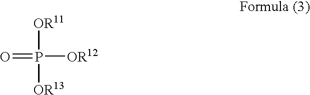
wherein R¹¹, R¹² and R¹³ each independently represents a 1-20C aliphatic group or a 5- or 6-membered hydrocarbon or heterocyclic ring, in which the ring may be a monocyclic ring or form a fused ring together with another ring.

6. The cyclic olefin resin film according to claim 1, which comprises at least one compound represented by formula (4) in an amount of 0.01 to 20 mass % based on a solid content of the cyclic olefin resin: 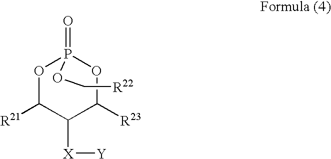
wherein R²¹, R²² and R²³ each independently represents a hydrogen atom or an alkyl group;
X represents a divalent linkage group formed of one or more groups selected from the group consisting of a single bond, —O—, —CO—, —NR²⁴—, an alkylene group and an arylene group, in which R²⁴ represents a hydrogen atom, an alkyl group, an aryl group or an aralkyl groups; and
Y represents a hydrogen atom, an alkyl group, an aryl group or an aralkyl group.

7. The cyclic olefin resin film according to claim 1, which comprises at least one compound represented by any of formulae (5) to (15) in an amount of 0.01 to 20 mass % based on a solid content of the cyclic olefin resin: 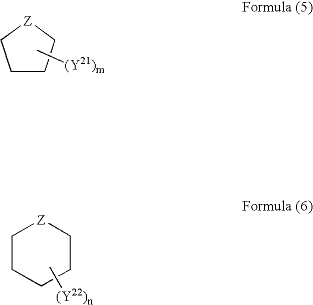
wherein Z represents a carbon atom, an oxygen atom, a sulfur atom or —NR²⁵—, in which R²⁵ represents a hydrogen atom or an alkyl group;
Y²¹ and Y²² each independently represents a 1-20C ester, alkoxycarbonyl, amido or carbamoyl group;
m represents an integer of 1 to 5; and
n represents an integer of 1 to 6: 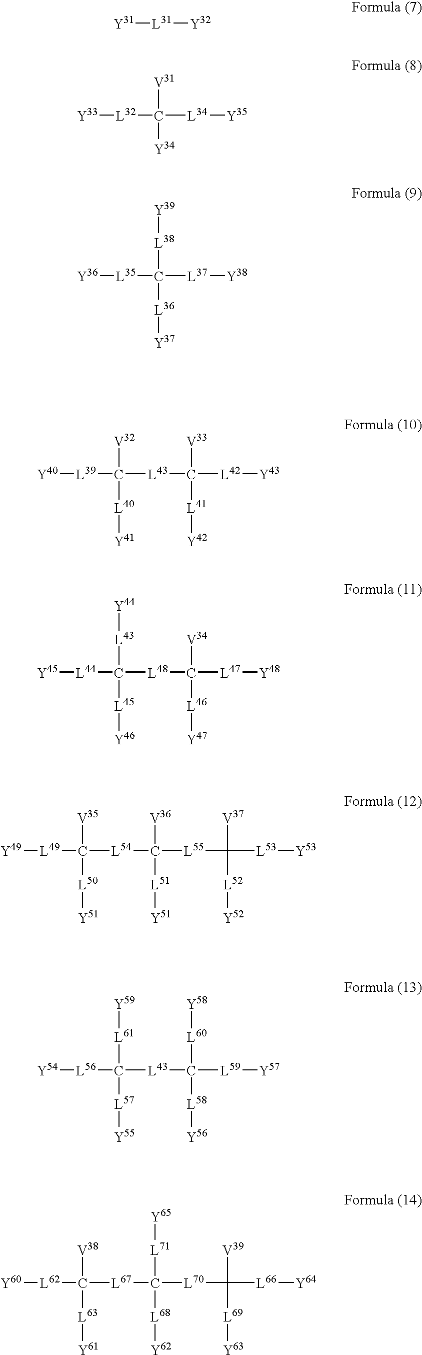 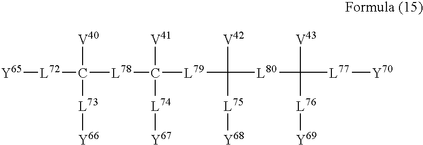
wherein Y³¹ to Y⁷⁰ each independently represents a 1-20C ester group, a 1-20C alkoxycarbonyl group, a 1-20C amido group, a 1-20C carbamoyl group or a hydroxyl group;
V³¹ to V⁴³ each independently represents a hydrogen atom or a 1-20C aliphatic group; and
L³¹ to L⁸⁰ each independently represents a divalent saturated linkage group containing 0 to 40 atoms, inclusive of 0 to 20 carbon atoms, in which when the number of atoms contained in a linkage group represented by any of L³¹ to L⁸⁰ is 0, groups on both sides of the linkage group forms a single bond by binding directly.

8. The cyclic olefin resin film according to claim 1,
wherein the cyclic olefin resin comprises at least one cyclic olefin resin selected from the group consisting of [A-1], [A-2] and [A-3],
wherein [A-1] stands for an addition copolymer comprising at least one kind of a repeating unit represented by formula (16) and at least one kind of a repeating unit represented by formula (17),
[A-2] stands for an addition homo- or copolymer comprising at least one kind of a repeating unit represented by formula (17), and
[A-3] stands for an open-circular homo- or copolymer comprising at least one kind of a repeating unit represented by formula (18): 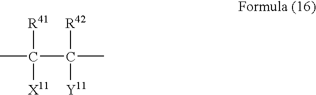
wherein R⁴¹ and R⁴² each independently represents a hydrogen atom or a 1-10C hydrocarbon group; and
X¹¹ and Y¹¹ each independently represents a hydrogen atom, a 1-10C hydrocarbon group, a halogen atom, a 1-10C halogenated hydrocarbon group, —(CH₂)ₙCOOR⁵¹, —(CH₂)ₙOCOR⁵², —(CH₂)ₙNCO, —(CH₂)ₙNO₂, —(CH₂)ₙCN, —(CH2)ₙCONR⁵³R⁵⁴, —(CH₂)ₙNR⁵³R⁵⁴, —(CH₂)ₙOZ or —(CH₂)ₙW, or a combination of X¹¹ and Y¹¹ represents (—CO)₂O or (—CO)₂NR⁵⁵, in which R⁵¹, R⁵², R⁵³, R⁵⁴ and R⁵⁵ each independently represents a hydrogen atom or a 1-20C hydrocarbon group; Z represents a hydrocarbon group or a halogenated hydrocarbon group; W represents —SiR⁵⁶ₚD₃₋ₚ, in which R⁵⁶ represents a 1-10C hydrocarbon group, D represents a halogen atom, —OCOR⁵⁶ or —OR⁵⁶, and p represents an integer of 0 to 3; and n represents an integer of 0 to 10: 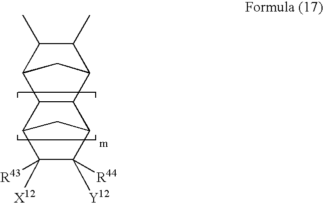
wherein m represents an integer of 0 to 4;
R⁴³ and R⁴⁴ each independently represents a hydrogen atom or a 1-10C hydrocarbon group;
X¹² and Y¹² each independently represents a hydrogen atom, a 1-10C hydrocarbon group, a halogen atom, a 1-10C halogenated hydrocarbon group, —(CH₂)ₙCOOR⁵¹, —(CH₂)ₙOCOR⁵², —(CH₂)ₙNCO, —(CH₂)ₙNO₂, —(CH₂)ₙCN, —(CH2)ₙCONR⁵³R⁵⁴, —(CH₂)ₙNR⁵³R⁵⁴, —(CH₂)ₙOZ or —(CH₂)ₙW, or a combination of X¹² and Y¹² represents (—CO)₂O or (—CO)₂NR⁵⁵, in which R⁵¹, R⁵², R⁵³, R⁵⁴ and R⁵⁵ each independently represents a hydrogen atom or a 1-20C hydrocarbon group; Z represents a hydrocarbon group or a halogenated hydrocarbon group; W represents —SiR⁵⁶ₚD₃₋ₚ, in which R⁵⁶ represents a 1-10C hydrocarbon group, D represents a halogen atom, —OCOR⁵⁶ or —OR⁵⁶, and p represents an integer of 0 to 3; and n represents an integer of 0 to 10; and 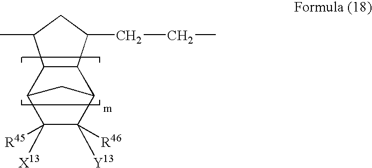
wherein m represents an integer of 0 to 4;
R⁴⁵ and R⁴⁶ each independently represents a hydrogen atom or a 1-10C hydrocarbon group;
X¹³ and Y¹³ each independently represents a hydrogen atom, a 1-10C hydrocarbon group, a halogen atom, a 1-10C halogenated hydrocarbon group, —(CH₂)ₙCOOR⁵¹, —(CH₂)ₙOCOR⁵², —(CH₂)ₙNCO, —(CH₂)ₙNO₂, —(CH₂)ₙCN, —(CH2)ₙCONR⁵³R⁵⁴, —(CH₂)ₙNR⁵³R⁵⁴, —(CH₂)ₙOZ or —(CH₂)ₙW, or a combination of X¹³ and Y¹³ represents (—CO)₂O or (—CO)₂NR⁵⁵, in which R⁵¹, R⁵², R⁵³, R⁵⁴ and R⁵⁵ each independently represents a hydrogen atom or a 1-20C hydrocarbon group; Z represents a hydrocarbon group or a halogenated hydrocarbon group; W represents —SiR⁵⁶ₚD₃₋ₚ, in which R⁵⁶ represents a 1-10C hydrocarbon group, D represents a halogen atom, —OCOR⁵⁶ or —OR⁵⁶, and p represents an integer of 0 to 3; and n represents an integer of 0 to 10.

9. The cyclic olefin resin film according to claim 1, which has in-plane slow axes whose directions average within ±2.0 degrees with respect to a width direction of the film and have a standard deviation within 0.8.

10. A polarizing plate, which comprises:
a polarizer; and
two protective films disposed on both sides of the polarizer,
wherein at least one of the two protective films is the cyclic olefin resin film according to claim 1.

11. A liquid crystal display device, which comprises the cyclic olefin resin film according to claim 1.

12. A liquid crystal display device, which comprises:
a liquid crystal cell; and
a pair of polarizing plates disposed on both sides of the liquid crystal cell,
wherein the pair of polarizing plates comprises the polarizing plate according to claim 10, and the liquid crystal display device is of IPS-mode, OCB-mode, TN-mode or VA-mode.

13. A VA-mode liquid crystal display device, which comprises the polarizing plate according to claim 10 on a side of backlight.

14. The cyclic olefin resin film according to claim 2, which comprises at least one compound represented by formula (1) as the organic compound capable of reducing both Rth(λ) and Re(λ) in an amount of 0.01 to 30 mass % based on a solid content of the cyclic olefin resin: 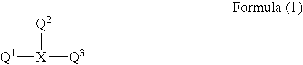
wherein Q¹, Q² and Q³ each independently represents a 5- or 6-membered ring; and
X represents B, C—R, N, P or P═O, in which R represents a hydrogen atom or a substituent.

15. The cyclic olefin resin film according to claim 14,
wherein the compound represented by formula (1) is a compound represented by formula (2): 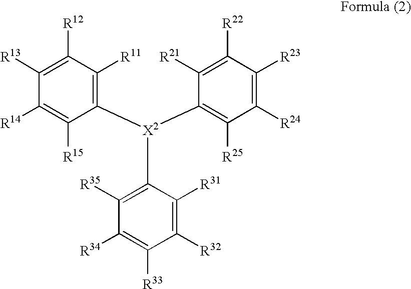
wherein X² represents B, C—R or N, in which R represents a hydrogen atom or a substituent; and
R¹¹, R¹², R¹³, R¹⁴, R¹⁵, R²¹, R²², R²³, R²⁴, R²⁵, R³¹, R³², R³³, R³⁴ and R³⁵ each independently represents a hydrogen atom or a substituent, and one group selected from the group consisting of R¹¹, R¹², R¹³, R¹⁴ and R¹⁵ and one group selected from the group consisting of R²¹, R²², R²³, R²⁴ and R²⁵ may be bound together via a single bond or a divalent linkage group.

16. The cyclic olefin resin film according to claim 2, which comprises at least one compound represented by formula (3) in an amount of 0.01 to 20 mass % based on a solid content of the cyclic olefin resin: 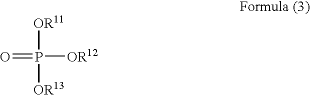
wherein R¹¹, R¹² and R¹³ each independently represents a 1-20C aliphatic group or a 5- or 6-membered hydrocarbon or heterocyclic ring, in which the ring may be a monocyclic ring or form a fused ring together with another ring.

17. The cyclic olefin resin film according to claim 2, which comprises at least one compound represented by formula (4) in an amount of 0.01 to 20 mass % based on a solid content of the cyclic olefin resin: 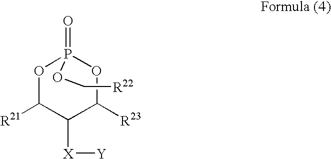
wherein R²¹, R²² and R²³ each independently represents a hydrogen atom or an alkyl group;
X represents a divalent linkage group formed of one or more groups selected from the group consisting of a single bond, —O—, —CO—, —NR²⁴—, an alkylene group and an arylene group, in which R²⁴ represents a hydrogen atom, an alkyl group, an aryl group or an aralkyl groups; and
Y represents a hydrogen atom, an alkyl group, an aryl group or an aralkyl group.

18. The cyclic olefin resin film according to claim 2, which comprises at least one compound represented by any of formulae (5) to (15) in an amount of 0.01 to 20 mass % based on a solid content of the cyclic olefin resin: 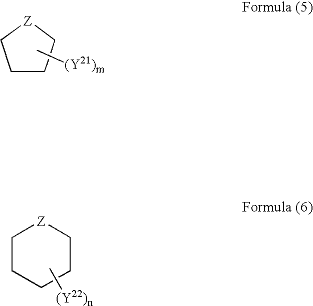
wherein Z represents a carbon atom, an oxygen atom, a sulfur atom or —NR²⁵—, in which R²⁵ represents a hydrogen atom or an alkyl group;
Y²¹ and Y²² each independently represents a 1-20C ester, alkoxycarbonyl, amido or carbamoyl group;
m represents an integer of 1 to 5; and
n represents an integer of 1 to 6: 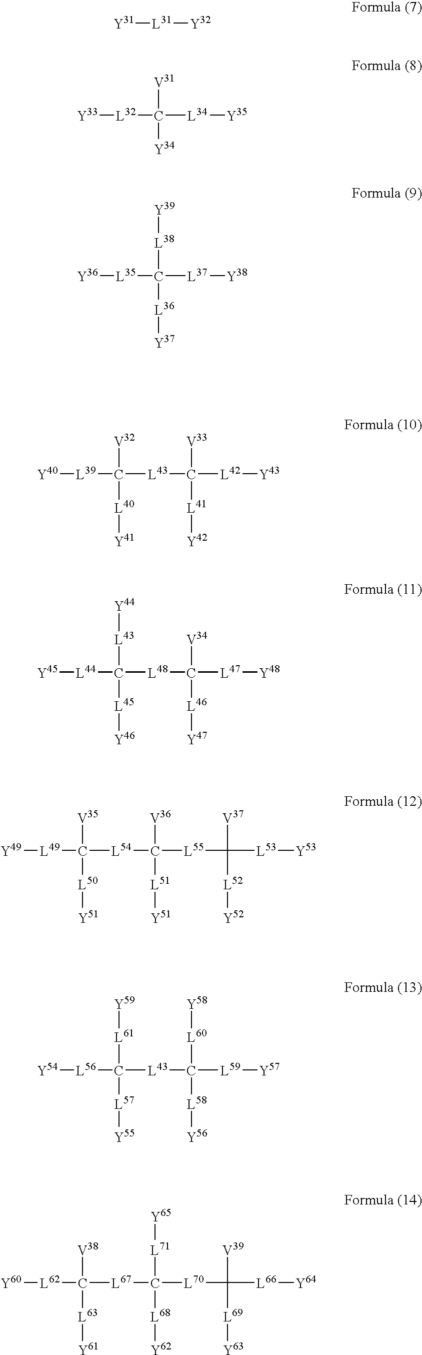 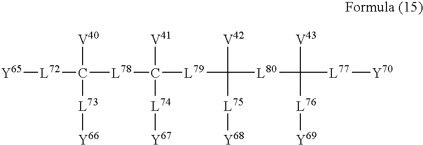
wherein Y³¹ to Y⁷⁰ each independently represents a 1-20C ester group, a 1-20C alkoxycarbonyl group, a 1-20C amido group, a 1-20C carbamoyl group or a hydroxyl group;
V³¹ to V⁴³ each independently represents a hydrogen atom or a 1-20C aliphatic group; and
L³¹ to L⁸⁰ each independently represents a divalent saturated linkage group containing 0 to 40 atoms, inclusive of 0 to 20 carbon atoms, in which when the number of atoms contained in a linkage group represented by any of L³¹ to L⁸⁰ is 0, groups on both sides of the linkage group forms a single bond by binding directly.

19. The cyclic olefin resin film according to claim 2,
wherein the cyclic olefin resin comprises at least one cyclic olefin resin selected from the group consisting of [A-1], [A-2] and [A-3],
wherein [A-1] stands for an addition copolymer comprising at least one kind of a repeating unit represented by formula (16) and at least one kind of a repeating unit represented by formula (17),
[A-2] stands for an addition homo- or copolymer comprising at least one kind of a repeating unit represented by formula (17), and
[A-3] stands for an open-circular homo- or copolymer comprising at least one kind of a repeating unit represented by formula (18): 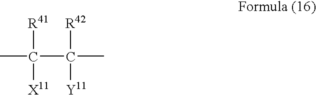
wherein R⁴¹ and R⁴² each independently represents a hydrogen atom or a 1-10C hydrocarbon group; and
X¹¹ and Y¹¹ each independently represents a hydrogen atom, a 1-10C hydrocarbon group, a halogen atom, a 1-10C halogenated hydrocarbon group, —(CH₂)ₙCOOR⁵¹, —(CH₂)ₙOCOR⁵², —(CH₂)ₙNCO, —(CH₂)ₙNO₂, —(CH₂)ₙCN, —(CH2)ₙCONR⁵³R⁵⁴, —(CH₂)ₙNR⁵³R⁵⁴, —(CH₂)ₙOZ or —(CH₂)ₙW, or a combination of X¹¹ and Y¹¹ represents (—CO)₂O or (—CO)₂NR⁵⁵, in which R⁵¹, R⁵², R⁵³, R⁵⁴ and R⁵⁵ each independently represents a hydrogen atom or a 1-20C hydrocarbon group; Z represents a hydrocarbon group or a halogenated hydrocarbon group; W represents —SiR⁵⁶ₚD₃₋ₚ, in which R⁵⁶ represents a 1-10C hydrocarbon group, D represents a halogen atom, —OCOR⁵⁶ or —OR⁵⁶, and p represents an integer of 0 to 3; and n represents an integer of 0 to 10: 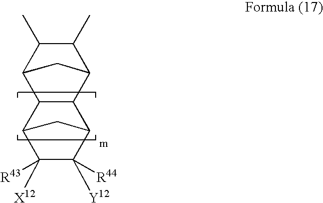
wherein m represents an integer of 0 to 4;
R⁴³ and R⁴⁴ each independently represents a hydrogen atom or a 1-10C hydrocarbon group;
X¹² and Y¹² each independently represents a hydrogen atom, a 1-10C hydrocarbon group, a halogen atom, a 1-10C halogenated hydrocarbon group, —(CH₂)ₙCOOR⁵¹ , —(CH₂)ₙOCOR⁵², —(CH₂)ₙNCO, —(CH₂)ₙNO₂, —(CH₂)ₙCN, —(CH2)ₙCONR⁵³R⁵⁴, —(CH₂)ₙNR⁵³R⁵⁴, —(CH₂)ₙOZ or —(CH₂)ₙW, or a combination of X¹² and Y¹² represents (—CO)₂O or (—CO)₂NR⁵⁵, in which R⁵¹, R⁵², R⁵³, R⁵⁴ and R⁵⁵ each independently represents a hydrogen atom or a 1-20C hydrocarbon group; Z represents a hydrocarbon group or a halogenated hydrocarbon group; W represents —SiR⁵⁶ₚD₃₋ₚ, in which R⁵⁶ represents a 1-10C hydrocarbon group, D represents a halogen atom, —OCOR⁵⁶ or —OR⁵⁶, and p represents an integer of 0 to 3; and n represents an integer of 0 to 10; and 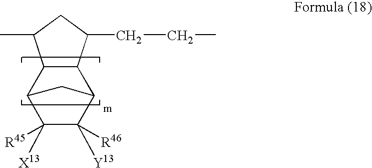
wherein m represents an integer of 0 to 4;
R⁴⁵ and R⁴⁶ each independently represents a hydrogen atom or a 1-10C hydrocarbon group;
X¹³ and Y¹³ each independently represents a hydrogen atom, a 1-10C hydrocarbon group, a halogen atom, a 1-10C halogenated hydrocarbon group, —(CH₂)ₙCOOR⁵¹, —(CH₂)ₙOCOR⁵², —(CH₂)ₙNCO, —(CH₂)ₙNO₂, —(CH₂)ₙCN, —(CH2)ₙCONR⁵³R⁵⁴, —(CH₂)ₙNR⁵³R⁵⁴, —(CH₂)ₙOZ or —(CH₂)ₙW, or a combination of X¹³ and Y¹³ represents (—CO)₂O or (—CO)₂NR⁵⁵, in which R⁵¹, R⁵², R⁵³, R⁵⁴ and R⁵⁵ each independently represents a hydrogen atom or a 1-20C hydrocarbon group; Z represents a hydrocarbon group or a halogenated hydrocarbon group; W represents —SiR⁵⁶ₚD₃₋ₚ, in which R⁵⁶ represents a 1-10C hydrocarbon group, D represents a halogen atom, —OCOR⁵⁶ or —OR⁵⁶, and p represents an integer of 0 to 3; and n represents an integer of 0 to 10.

20. The cyclic olefin resin film according to claim 2, which has in-plane slow axes whose directions average within ±2.0 degrees with respect to a width direction of the film and have a standard deviation within 0.8.
